(19) United States
(12) Patent Application Publication
(10) Pub. No.: US 2025/0351828 A1
(43) Pub. Date: Nov. 20, 2025

(54) AZOLE FUNGICIDE COMPOSITION

(71) Applicant: Adama Makhteshim Ltd., Beer Sheva (IL)

(72) Inventors: Diana Poliak, Beer Sheva (IL); Arunagirinathan Manickam Adhimoolam, Chennai, Tamil Nadu (IN); Krishna vasu Juthiga V V, Secunderabad, Telangana (IN); Ivan Gorlovetsky, Beer Sheva (IL); Yadagani Venkateswararao, Hyderabad, Telangana (IN); Shachaf Dotan, Ness Ziona (IL)

(73) Assignee: Adama Makhteshim Ltd., Beer Sheva (IL)

(21) Appl. No.: 18/870,379

(22) PCT Filed: Jun. 2, 2023
(86) PCT No.: PCT/IB2023/055704

§ 371 Date: Nov. 27, 2024

(30) Foreign Application Priority Data
Jun. 2, 2022 (IN) 202211031597
Dec. 23, 2022 (IN) 202211074863

(51) Int. Cl. A01N 43/653; A01P 3/00

(52) U.S. Cl. CPC A01N 43/653; A01P 3/00

(57) ABSTRACT

The present invention provides a combination comprising (1) an amount of azole fungicide and (2) an amount of additive (I) selected from the group consisting of selected from group consisting of thiourea-based compounds, sodium thiosulfate, alkyl amine, thioamide-based compounds and any combination thereof, which may be in the form of a tank mixture or composition. The present invention also provides methods of using of the combinations and compositions disclosed herein and processes of preparing the compositions disclosed herein.

Throughout this application various publications are referenced. The disclosures of these documents in their entireties are hereby incorporated by reference into this application in order to more fully describe the state of the art to which this invention pertains.

### TECHNICAL FIELD

The present invention provides a combination comprising (1) an amount of azole fungicide and (2) an amount of additive (I) selected from the group consisting of thiourea-based compounds, sodium thiosulfate, alkyl amine, thioamide-based compounds and any combination thereof, which may be in the form of a mixture, including tank mix, or a ready-mix composition. The present invention also provides methods of use of the combination and compositions disclosed herein and processes of preparing the compositions disclosed herein.

### BACKGROUND

Azole fungicides such as prothioconazole and epoxiconazole, are known as effective fungicide for controlling broad range of pathogens. However, negative effect, (phytotoxicity) associated with application of azole fungicide in susceptible crop is known and the severity is depended on environment conditions and/or composition.

This negative effect affects the azole fungicide's application in different aspects such as rate of application, timing of application and repetitions. In addition, formulating the azole fungicide in presence of different pesticide also found challenging. There is a need to find a way for improving the use of azole fungicide including use in presence of other pesticide.

Copper-based fungicides are well-known but uses of copper-based fungicides are limited due to phytotoxicity to plant and toxicity to user.

The solubility of copper ions in water depends on the source of the copper ions. Copper-based fungicides such as cupric acetate, cupric chloride and cupric chlorate, cupric formate, cupric hexafluorosilicate, cupric nitrate, cupric chromate, copper and sulfate pentahydrate are highly soluble in water. Others such as copper hydroxide, copper oxychloride sulfate (COCS), copper oxychloride and tribasic copper sulfate (cupric sulfate, tricupric hydroxide, hemihydrate), which are also known as “fixed” coppers, are relatively less soluble in water. The solubility in water affects the amount of the copper-based fungicide that may be applied and its level of toxicity.

The copper particles adhere to the leaf surface and act as ion reservoirs, continuously releasing Cu2+ ions and forming a protective layer which prevent infection. Copper fungicides formulations vary in efficiency of Cu2+ ion release which is dependent upon the copper source. Moreover, the concentration of copper ions on the leaves depends on the equilibrium established with the complexed and soluble forms of copper (Menkissoglu and Lindow 1991).

It is known that copper is toxic when the dissolved form penetrates plant tissue. In general, the use of spray additives such as foliar nutrients, and any surfactants with penetrating characteristics should be avoided when applying copper-based fungicides.

Suspension concentrate (SC) compositions containing copper sulphate pentahydrate and tannate complex of picro ammonium formate were disclosed in U.S. Pat. Nos. 4,544,666 and 4,673,687. These compositions contain picric acid which has many disadvantages. Picric acid is also known as an explosive compound that should be handled very carefully.

Polyelectrolytes are known in the agricultural field as slow release imparting agents. WO 2008/002623 describes the use of ion exchanging polymers to provide slow release of a charged pesticide. Furthermore, WO 2013/133705 and WO 2013/133706 describe the use of a neutral, insoluble polyelectrolyte complex, generated by mixing solutions of a polycation and a polyanion. PCT/IB2020/055089 discloses use of polycation for increasing biological effect of mancozeb. US 2002/010099 discloses combinations of crop protection agents with anionic polymers.

There is a need to develop a new composition with improved properties.

### SUMMARY OF THE INVENTION

The present invention provides a combination comprising (1) an amount of azole fungicide and (2) an amount of additive (I). In some embodiments, the combination comprises (1) an amount of azole fungicide and (2) an amount of additive (I) selected from the group consisting of thiourea-based compounds, sodium thiosulfate, alkyl amine, thioamide-based compounds and any combination thereof.

The present invention provides the use of additive (I) selected from the group consisting of thiourea-based compounds, sodium thiosulfate, alkyl amine, thioamide-based compounds and any combination thereof for reducing phytotoxicity associated with application of azole fungicide.

The present invention provides use of an additive (I) selected from group consisting of thiourea-based compounds, sodium thiosulfate, alkyl amine, thioamide-based compounds and any combination thereof for increasing the plant health of plant when is treated with an azole fungicide, wherein the plant health of a plant which is treated with the azole fungicide in presence of additive (I) is increased compared to the plant health of the plant which is treated with the same amount of the same azole fungicide in absence of the additive (I).

The present invention provides use of an additive (I) selected from group consisting of thiourea-based compounds, sodium thiosulfate, alkyl amine, thioamide-based compounds and any combination thereof for reducing or eliminating the phytotoxicity associated with application of an azole fungicide, wherein the phytotoxic effects on a plant which is treated with the azole fungicide in presence of additive (I) is lower as compared to the phytotoxic effect on the plant which is treated with the same amount of the same azole fungicide in absence of the additive (I).

The present invention provides use of an additive (I) selected from group consisting of thiourea-based compounds, sodium thiosulfate, alkyl amine, thioamide-based compounds and any combination thereof for reducing or eliminating the phytotoxicity of an azole fungicide, wherein the rate and/or extent of phytotoxic effects when the azole fungicide is applied in presence of an additive (I) is reduced as compared to the rate and/or extent of phytotoxic effects when the azole fungicide is applied in absence of an additive (I).

The present invention provides a process for producing a composition comprising (1) an azole fungicide, and (2) additive (I) selected from the group consisting of thiourea-based compounds, sodium thiosulfate, alkyl amine, thioamide-based compounds and any combination thereof, the process comprising the following steps: (a) preparing an aqueous composition of the azole fungicide and (b) adding the additive (I) to the aqueous composition to obtain the composition comprising the azole fungicide and the additive (I).

The present invention also provides a composition produced using the process described herein.

The present invention also provides a method of treating a plant or a locus thereof, against a pathogen, comprising contacting the plant, a part of the plant, or the locus with any one of the combination or composition described herein.

The present invention provides a method for controlling fungal disease caused by unwanted pathogen comprising applying an effective amount of any one of the herein described combinations and/or compositions and/or diluted compositions to a plant, a locus thereof, propagation material thereof, or an area infested with the unwanted pathogen so as to thereby control the fungal disease.

The present invention provides a method for increasing the rate of application of an azole fungicide to a plant or plant part and/or increasing the frequency of application of an azole fungicide to a plant or plant part without causing increased phytotoxicity to the plant, wherein the method comprises applying the azole fungicide to the plant or plant part in combination with an additive (I) selected from the group consisting of thiourea-based compounds, sodium thiosulfate, alkyl amine, thioamide-based compounds and any combination thereof.

The present invention provides a method of improving pest control using an azole fungicide without increased phytotoxicity, wherein the method comprises applying the combinations or compositions the invention where pest control is desired.

The present invention provides a method of reducing and/or eliminating phytotoxicity to a plant or plant part caused by an azole fungicide applied to the plant or plant part, wherein the method comprises applying the azole fungicide in combination with an additive (I) selected from the group consisting of thiourea-based compounds, sodium thiosulfate, alkyl amine, thioamide-based compounds, and any combination thereof.

The present invention provides a method of improving a plant's tolerance to an amount of an azole fungicide comprising applying the amount of the azole fungicide in combination with an additive (I) selected from the group consisting of thiourea-based compounds, sodium thiosulfate, alkyl amine, thioamide-based compounds, and any combination thereof.

The present invention provides a method of treating a plant or a locus heavily infected by fungal disease or susceptible to heavy infection of fungal disease comprising applying to the plant, plant part, or the locus an amount of azole fungicide in combination with an additive (I) selected from the group consisting of thiourea-based compounds, sodium thiosulfate, alkyl amine, thioamide-based compounds, and any combination thereof.

### BRIEF DESCRIPTION OF THE DRAWINGS

FIG. 1 shows the effect of thiourea on the phytotoxicity of prothioconazole SC composition [thiourea combined as tank mix; (+) with thiourea; (−) without thiourea]

FIG. 2 shows the effect of thiourea on the phytotoxicity of suspoemulsion composition comprises copper oxychloride, prothioconazole and picoxystrobin. [thiourea is present in the ready-mix composition; (+) with thiourea; (−) without thiourea]

FIG. 3 compares the effect of thiourea on the phytotoxicity of suspoemulsion and suspension concentrate compositions comprising copper oxychloride, prothioconazole and picoxystrobin.

FIG. 4a-b shows the phytotoxicity of SE compositions 49T (without thiourea) and 47T and 50T (with thiourea).

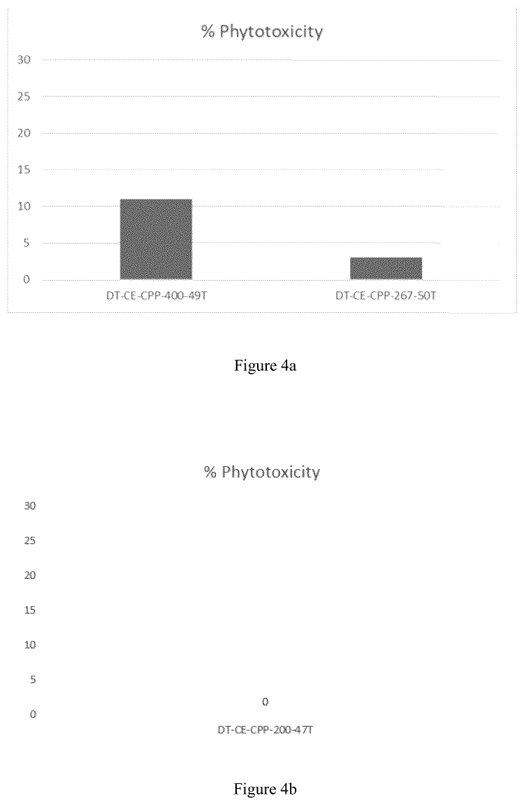

FIG. 5 shows the dose-response curves of the four new copper-fungicide prototype formulations, DT-CE-C4-345-08T ( [symbol] ), DT-CE-C4-345-09T ( [symbol] ), DT-CE-C4-345-10T ( [symbol] ), DT-CE-C4-345-11T ( [symbol] )+0.05% Tween 80 and copper oxychloride (Difere)+0.05% Tween 80 ( [symbol] ) towards Phakopsora pachyrhizi strain THAI1 obtained from the AUDPC.

FIG. 6 shows the in-planta evaluations of the four new copper-fungicide prototype formulations, DT-CE-C4-345-08T ( [symbol] ), DT-CE-C4-345-09T ( [symbol] ), DT-CE-C4-345-10T ( [symbol] ), and DT-CE-C4-345-11T ( [symbol] ), Kocide Opti ( [symbol] ), and Kocide 2000 ( [symbol] )) towards Potato Late Blight caused by Phytophthora infestans. Dose Effect curves (Efficacy calculated via DSI value; %) representation at 7 dpi of Potato whole plant treated preventatively 24 h before inoculation with P. infestans. A minimum of 12 leaves are considered for each condition. The EC₅₀ for each copper-based product are assessed.

FIG. 7 shows the improved rainfastness of DT-CE-C4-345-08T and DT-CE-C4-345-10T in soybean compared to other copper formulations.

FIG. 8 shows No phytotoxicity of DT-CE-C4-345-08T and DT-CE-C4-345-10T towards Soybeans (Glycine max Abelina).

### DETAILED DESCRIPTION OF THE INVENTION

### 4.1 Definitions

Unless defined otherwise, all technical and scientific terms used herein have the meaning commonly understood by persons of ordinary skill in the art to which this subject matter pertains.

The term “a” or “an”, as used herein, includes the singular and the plural, unless specifically stated otherwise. Therefore, the terms “a,” “an,” or “at least one” can be used interchangeably in this application.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “30-45%” includes 30%, 30.1%, 30.2%, etc. up to 45%.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach, and vegetables.

The term “part of a plant”, as is used herein, indicates a part of a plant including, but not limited to, pollen, ovule, leaf, root, flower, fruit, stem, bulb, corn, branch, and seed. As used herein, the term “combination” means an assemblage of combination components for application either by simultaneous or contemporaneous application.

As used herein, the term “simultaneous” when used in connection with application of components means that the components are applied in an admixture, for example, a tank mix. For simultaneous application, the combination may be the admixture or separate containers each containing combination components that are combined prior to application.

The admixture or individual components may be in any physical form, e.g. blend, solution, suspension, dispersion, emulsion, alloy, or the like.

As used herein, the term “contemporaneous” when used in connection with application of the components means that an individual component of the combination is applied separately from another component at the same time or at times sufficiently close together that the desired effect of the combination achieved.

As used herein, the term “ready mix” means a composition that may be applied to plants directly after dilution. The composition comprises the combination's components.

As used herein, the term “composition” includes at least one of the combinations or mixtures of the present invention with agriculturally acceptable carrier.

In some embodiments, the terms “composition” and “formulation” may be used interchangeably.

The term “polyelectrolyte”, as is used herein, refers to a molecule consisting of a plurality of functional, charged groups that are linked to a polymer backbone. In the context of this application, the term “polycation” is interchangeable with the term “positively charged polyelectrolyte”, while the term “polyanion” is interchangeable with the term “negatively charged polyelectrolyte”. The terms polycation and polyanion refer to positively charged and negatively charged polymer molecules, respectively, under neutral or acidic conditions, i.e. at pH 3-8.

The term “polyelectrolyte complex”, as is used herein, refers to a structure, a complex of oppositely charge polyelectrolytes (a polyanion and a polycation) that is formed by interaction of at least one polycation with at least one polyanion. The complex is strong, but reversible electrostatic links, thus avoiding the use of covalent cross-linkers. Polyelectrolyte complexes are described, for example, in WO 2013/133705 and WO 2013/133706, the contents of each of which are hereby incorporated by reference.

The term “macromolecular complex”, as is used herein, refers to structure that is formed by non-covalent interaction of a copper-based fungicide with a polyelectrolyte, such as at least one polyanion or at least one polyelectrolyte complex. In such macromolecular complex, the non-covalent interactions are preferably electrostatic interactions. The macromolecular complex thus avoids the use of covalent cross-linkers and result in a matric like physical structure.

The term “electrostatic interaction” as is used herein, refers to electric force between any two charged molecules and/or dipole molecules. The term “electrostatic interactions” includes ionic interactions, hydrogen bonds, and van der Waals forces such as dipole-dipole interactions.

The term “part of a plant”, as is used herein, indicates a part of a plant including, but not limited to, pollen, ovule, leaf, root, flower, fruit, stem, bulb, corn, branch, and seed.

The term “polyion” refers to a molecule consisting of a plurality of charged groups that are linked to a common backbone. In the context of this application, the term “polycation” is interchangeable with the term “positively charged polyelectrolyte” and the term “polyanion” is interchangeable with the term “negatively charged polyelectrolyte”.

The term “suspension concentrate”, as used herein, refers to a suspension of solid particles in a liquid intended for dilution with water prior to use. In some embodiments, suspension concentrate refers to an aqueous suspension concentrate.

The term “dispersion concentrate”, as used herein, refers to a dispersion of solid particles in a liquid intended for dilution with water prior to use.

The term “water dispersible granules”, as used herein, refers to a formulation in granule form which is dispersible in water forming a dispersion such as a suspension or solution.

The term “wettable powder”, as used herein, refers to a powder formulation intended to be mixed with water or another liquid prior to use.

The term “water slurriable powder”, as used herein, refers to a powder formulation that is made into a slurry in water prior to use.

### Azole Fungicide and Additive (I)

Combining additive (I) with azole fungicide reduces the phytotoxicity associated with application of azole fungicide.

### Combinations

The present invention provides a combination comprising (1) an amount of azole fungicide, and (2) an amount of additive (I).

The present invention provides a combination comprising (1) an amount of azole fungicide, and (2) an amount of additive (I) selected from the group consisting of thiourea-based compounds, sodium thiosulfate, alkyl amine, thioamide-based compounds, and any combination thereof.

The present invention provides a combination comprising (1) an amount of azole fungicide, (2) an amount of additive (I) selected from the group consisting of thiourea-based compounds, sodium thiosulfate, alkyl amine, thioamide-based compounds, and any combination thereof, and (3) water.

The present invention provides a combination comprising (1) an amount of azole fungicide, and (2) an amount of additive (I) selected from the group consisting of thiourea-based compounds, sodium thiosulfate, alkyl amine, thioamide-based compounds, and any combination thereof, wherein the combination is free of copper-based fungicide.

The present invention provides a combination comprising (1) an amount of azole fungicide, (2) an amount of additive (I) selected from the group consisting of thiourea-based compounds, sodium thiosulfate, alkyl amine, thioamide-based compounds, and any combination thereof, and (3) water, wherein the combination is free of copper-based fungicide.

In some embodiments, the combination comprises (1) an amount of prothioconazole and (2) an amount of thiourea.

In some embodiments, the additive (I) is thiourea.

In some embodiments, the additive (I) is selected from group consisting of thiourea-based compound, hexamethylene tetra amine, sodium thiosulfate, ethylene diamine and any combination thereof.

In some embodiments, the additive (I) is a mixture of two compounds selected from the group consisting of thiourea-based compound, sodium thiosulfate, alkyl amine and thioamide-based compound.

In some embodiments, the additive (I) is a mixture of two compounds selected from the group consisting of thiourea-based compound, hexamethylene tetra amine, sodium thiosulfate and ethylene diamine.

In some embodiments, the additive (I) is thiourea-based compound.

In some embodiments, the thiourea-based compound is thiourea.

In some embodiments, thiourea refers to the compound with the formula SC (NH₂)₂ and the structure H₂N—C(═S)—NH₂ (a.k.a. thiourea material, CAS number: 62-56-6).

Thiourea-based compound refers to a compound having the structure represented by the formula:

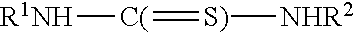

wherein,
(i) R¹, R², are both H;
(ii) R¹ is H and R² is alkyl or alkenyl or alkynyl or aryl or heterocyclic;
(iii) R¹, R² are each, independently, alkyl, alkenyl or alkynyl;
(iv) R¹, R² are each, independently, aryl, or heterocyclic;
(v) R¹ is alkyl or alkenyl or alkynyl and R² is aryl or heterocyclic, or
(vi) R¹ and R² can be taken together with the nitrogen atoms to which they are attached to form a ring containing 2 to 4 atoms of carbon and optionally one additional atom of nitrogen, sulfur or oxygen, said ring may be saturated or unsaturated and optionally substituted with 1 to 4 substituents selected from the group consisting of C₁-C₂ alkyl, halogen, CN, NO₂ and C₁-C₂ alkoxy.

In some embodiments, alkyl, which may be optionally substituted, denotes a linear or branched or cyclic hydrocarbon group comprising n carbon atoms.

In some embodiments, alkyl denotes a linear or branched or cyclic hydrocarbon group comprising 1-16 carbon atoms, or 1-8 carbon atoms.

In some embodiments, alkenyl, which may be optionally substituted, denotes a linear or branched or cyclic hydrocarbon group comprising n carbon atoms and at least one double bond.

In some embodiments, alkynyl which may be optionally substituted, denotes a linear or branched hydrocarbon group comprising n carbon atoms and at least one triple bond.

In some embodiments, alkenyl and alkynyl comprise 2-8 carbon atoms.

In some embodiments, aryl, which may be optionally substituted, denotes to carbocyclic aromatic radicals having from 6 to 14 carbon atoms.

In some embodiments, heterocyclic, which may be optionally substituted, denotes saturated, partially saturated, or fully unsaturated cyclic radical, which contains 3 to 6 ring atoms, of which 1 to 4 are from the group consisting of oxygen, nitrogen and sulfur.

In some embodiments, the thiourea-based compound is butyl thiourea, methyl propyl thiourea, phenylthiourea, ethylphenylthiourea, or diphenylthiourea.

In some embodiments, the thiourea-based compound is cyclic thiourea.

In some embodiments, additive (I) is not a fungicidally active ingredient.

In some embodiments, additive (I) is selected from thiourea-based compound which are not pesticidally active.

In some embodiments, the selected additive (I) is a thioamide-based compound.

In some embodiments, the thioamide-based compound may include but is not limited to thioacetamide, thiobenzamide, furan thioamide, pyridine thioamide and polythioamide.

In some embodiments, the thioamide-based compound is selected from the group consisting of thioacetamide, thiobenzamide, furan thioamide, pyridine thioamide and polythioamide.

In some embodiments, the additive (I) is sodium thiosulfate.

In some embodiments, the additive (I) is alkylamine. In some embodiments, the additive (I) comprises one or more alkylamines.

In some embodiments, the alkylamine comprises one or more mono amines.

In some embodiments, the alkylamine is mono amine.

In some embodiments, the alkylamine is a diamine.

In some embodiments, the alkylamine is a polyamine.

In some embodiments, the polyamine is hexamethylene tetra amine.

In some embodiments, the diamine is ethylene diamine.

In some embodiments, the alkylamine is represented by the structure A;

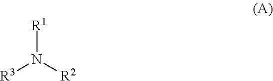

wherein:
(i) R¹ is hydrogen, alkyl, aryl, alkenyl, alkynyl or heterocyclic; R² is hydrogen, alkyl, aryl, alkenyl, alkynyl or heterocyclic; and R³ is hydrogen, alkyl, aryl, alkenyl, alkynyl or heterocyclic; and
(ii) at least one of R¹, R², and R³ is alkyl, aryl, alkenyl, alkynyl or heterocyclic.

In some embodiments, alkyl, which may be optionally substituted, denotes a linear or branched or cyclic hydrocarbon group comprising n carbon atoms.

In some embodiments, alkenyl, which may be optionally substituted, denotes a linear or branched or cyclic hydrocarbon group comprising n carbon atoms and at least one double bond.

In some embodiments, alkynyl which may be optionally substituted, denotes a linear or branched, hydrocarbon group comprising n carbon atoms and at least one triple bond.

In some embodiments, aryl, which may be optionally substituted, denotes to carbocyclic aromatic radicals having from 6 to 14 carbon atoms.

In some embodiments, heterocyclic, which may be optionally substituted, denotes saturated, partially saturated, or fully unsaturated cyclic radical, which contains 3 to 6 ring atoms, of which 1 to 4 are from the group consisting of oxygen, nitrogen and sulfur.

In some embodiments, substituted means that the group (R¹, R² and/or R³) may or may not be further substituted by one or more groups such as Cn alkyl, aryl, halogen, hydroxyl, thio, amino, cyano, oxo, nitro, acyl, amido, C₁₋₆ alkoxy, C₁₋₆ alkenyloxy, aryloxy, acyloxy, C₁₋₆ alkylamino, arylamino, C₁₋₆ alkylthio, arylthio, alkylsulfonyl, arylsulfonyl, alkylsulfinyl, arylsulfinyl, C₁₋₈ alkylamido, and carboxyl.

In some embodiments, two or more of, R¹, R², R³ are the same.

In some embodiments, each of R¹, R², R³ are different.

In some embodiments where one or more of R¹, R², R³ is alkyl, one or more alkyl is linear.

In some embodiments, the alkyl is cyclic.

In some embodiments, the alkyl is an alkyl fatty chain.

In some embodiments, R¹, R² and R³ are methyl.

In some embodiments, R¹, R² and R³ are ethyl.

In some embodiments, R¹ and R² are H and R³ is C₁₂ alkyl.

In some embodiments, R¹ and R² are H and R³ is C₁₈ alkenyl.

In some embodiments, the selected additive (I) is an alkyl amine.

In some embodiments, the alkyl amine is oleyl amine.

In some embodiments, the alkylamine is dodecyl amine.

In some embodiments, the alkylamine is benzyl amine.

In some embodiments, the additive (I) is hexamethylene tetra amine.

In some embodiments, the additive (I) is sodium thiosulfate.

In some embodiments, the additive (I) is ethylene diamine.

In some embodiments, the alkylamine is butylamine.

In some embodiments, the alkylamine is diethyl amine.

In some embodiments, the alkylamine is triethylamine.

In some embodiments, the additive (I) comprises thiourea.

In some embodiments, the additive (I) comprises thioamide-based compound.

In some embodiments, the additive (I) comprises sodium thiosulfate.

In some embodiments, the additive (I) comprises alkylamine

In some embodiments, the additive (I) comprises ethylene diamine.

In some embodiments, the alkylamine comprises butylamine.

In some embodiments, the alkylamine comprises diethyl amine.

In some embodiments, the alkylamine comprises triethylamine.

In some embodiments, the additive (I) is a mixture of two compounds selected from the group consisting of thiourea-based compounds, sodium thiosulfate, alkyl amine, and thioamide-based compounds, and the weight ratio between them is from 10:1 to 1:10.

In some embodiments, the additive (I) is a mixture of thiourea and sodium thiosulfate.

In some embodiments, the weight ratio between the thiourea and sodium thiosulfate is from 10:1 to 1:10.

In some embodiments, the additive (I) is a mixture of hexamethylene tetra amine and thiourea.

In some embodiments, the weight ratio between the thiourea and hexamethylene tetra amine is from 10:1 to 1:10.

In some embodiments, the additive (I) is a mixture of hexamethylene tetra amine and sodium thiosulfate.

In some embodiments, the weight ratio between the hexamethylene tetra amine and sodium thiosulfate is from 10:1 to 1:10

In some embodiments, the additive (I) is a mixture of sodium thiosulfate and ethylene diamine.

In some embodiments the weight ratio between the sodium thiosulfate and ethylene diamine is from 10:1 to 1:10.

In some embodiments, the additive (I) is a mixture of thiourea and ethylene diamine.

In some embodiments, the weight ratio between the thiourea and ethylene diamine is from 10:1 to 1:10.

In some embodiments, the azole fungicide is prothioconazole.

In some embodiments, the azole fungicide is prothioconazole and the additive (I) is thiourea.

In some embodiments, the present invention provides a combination comprising (1) prothioconazole, (2) additive (I) selected from the group consisting of thiourea-based compound, sodium thiosulfate, alkyl amine, thioamide-based compound, and any combination thereof, and (3) water.

In some embodiments, the additive (I) is thiourea.

In some embodiments, the combination is devoid of copper-based fungicide. In some embodiments, when the combination is a composition, the combination is devoid of copper-based fungicide. In some embodiments, when the combination is a ready-mix composition, the combination is devoid of copper-based fungicide. In some embodiments, when the combination is a water-diluted composition, the combination is devoid of copper-based fungicide.

In some embodiments, the combination is a composition.

In some embodiments, the combination is a composition.

In some embodiments, the combination is a ready-mix composition.

In some embodiments, the combination is a tank mix.

In some embodiments, the combination is a water diluted composition.

In some embodiments, the combination is formulated together as ready-mix composition.

In some embodiments, the composition is water-based composition.

In some embodiments, the water-based composition is suspension concentrate.

In some embodiments, the water-based composition is a suspoemulsion.

In some embodiments, the composition is non-aqueous based composition.

In some embodiments, the non-aqueous based composition is emulsifiable concentrate composition.

In some embodiments, the non-aqueous based composition is oil dispersion.

In some embodiments, the composition is a solid composition.

In some embodiments, the composition is devoid of copper-based fungicide.

In some embodiments, the combination is formulated as two compositions.

In some embodiments, when the azole fungicide and additive (I) are formulated as ready mix composition, the weight ratio between the azole fungicide and the additive (I) is between about 0.2:1 to 600:1. In some embodiments, when the azole fungicide and additive (I) are formulated as ready mix composition, the weight ratio between the azole fungicide and the additive (I) is between about 10:1 to 20:1. In some embodiments, when the azole fungicide and additive (I) are formulated as ready mix composition, the weight ratio between the azole fungicide and the additive (I) is 17:1. In some embodiments, when the azole fungicide and additive (I) are formulated as ready mix composition, the weight ratio between the azole fungicide and the additive (I) is 11.7:1

In some embodiments, when the prothioconazole and thiourea are formulated as ready mix composition, the weight ratio between the prothioconazole and the thiourea is between about 0.2:1 to 600:1. In some embodiments, when the prothioconazole and thiourea are formulated as ready-mix composition, the weight ratio between the prothioconazole and the thiourea is between about 10:1 to 20:1. In some embodiments, when the prothioconazole and thiourea are formulated as ready mix composition, the weight ratio between the prothioconazole and the thiourea is 17:1. In some embodiments, when the prothioconazole and thiourea are formulated as ready mix composition, the weight ratio between the prothioconazole and the thiourea is 11.7:1.

In some embodiments, when the azole fungicide and additive (I) are combined as a tank-mix, the weight ratio between the azole fungicide and the additive (I) is between about 1:60 to 60:1. In some embodiments, when the azole fungicide and additive (I) are combined as a tank-mix, the weight ratio between the azole fungicide and the additive (I) is 7.1:1.

In some embodiments, when the prothioconazole and thiourea are combined as a tank-mix, the weight ratio between the prothioconazole and the thiourea is between about 1:60 to 60:1. In some embodiments, when the prothioconazole and thiourea are combined as a tank-mix, the weight ratio between the prothioconazole and the thiourea is 7.1:1.

In some embodiments, the combination comprises (1) a composition comprising azole fungicide and (2) thiourea.

A composition which is part of the combination is in the form of a suspension concentrate (SC), suspoemulsion (SE), emulsion (EW), a water dispersible granule (WG), a wettable powder (WP), a dispersion concentrate (DC), a dry powder seed treatment (DS), a water slurriable powder (WS), or a flowable seed treatment (FS). A preferred composition is a suspoemulsion (SE) and suspension concentrate (SC).

In some embodiments, the combination further comprises additional pesticide such as fungicide.

In some embodiments, the combination further comprises additional fungicide.

In some embodiments, the combination comprises more than one azole fungicide.

In some embodiments, the combination comprises additional fungicide different from the azole fungicide.

In some embodiments, the additional fungicide is selected from strobilurin fungicides, benzamide fungicide, morpholines, QiI fungicide, SDHI and any combination thereof.

In some embodiments, the combination comprises more than one additional fungicide different from the azole fungicide.

In some embodiments, the additional fungicide is fluazinam.

In some embodiments, the additional fungicide is folpet.

In some embodiments, the additional fungicide is captan.

In some embodiments, the additional fungicide is flumetylsulforim. (5-fluoro-4-imino-3-methyl-1-tosyl-3,4-dihydropyrimidin-2 (1H)-one).

### Compositions

The present invention provides a composition comprising (1) an amount of azole fungicide, (2) an amount of at least one additive (I), and (3) an agricultural acceptable carrier.

The present invention provides a composition comprising (1) an amount of azole fungicide, (2) an amount of additive (I) selected from the group consisting of thiourea-based compounds, sodium thiosulfate, alkyl amine, thioamide-based compounds, and any combination thereof, and (3) an agricultural acceptable carrier.

The present invention provides a composition comprising (1) an amount of azole fungicide, (2) an amount of at least one additive (I), and (3) an agricultural acceptable carrier, wherein the composition is devoid of copper-based fungicide.

The present invention provides a composition comprising (1) an amount of azole fungicide, (2) an amount of additive (I) selected from the group consisting of thiourea-based compounds, sodium thiosulfate, alkyl amine, thioamide-based compounds, and any combination thereof, and (3) an agricultural acceptable carrier, for reducing or eliminating the phytotoxicity associated with application of an azole fungicide.

The present invention provides a composition comprising (1) an amount of azole fungicide, (2) an amount of additive (I) selected from the group consisting of thiourea-based compounds, sodium thiosulfate, alkyl amine, thioamide-based compounds, and any combination thereof, and (3) an agricultural acceptable carrier, for reducing or eliminating the phytotoxicity associated with application of an azole fungicide, wherein the composition is devoid of copper-based fungicide.

In some embodiments, the additive (I) is selected from the group consisting of thiourea, sodium thiosulfate, alkyl amine and any combination thereof. In some embodiments, the additive (I) is thiourea.

In some embodiments, the azole phytotoxicity is reduced by at least 5%, at least 10%, or at least 20% compared to a composition not comprising additive (I).

In some embodiments, the composition is liquid.

In some embodiments, the composition is water-based composition.

In some embodiments, the water-based composition is suspension concentrate.

In some embodiments, the water-based composition is a suspoemulsion.

In some embodiments, the composition is non-aqueous based composition.

In some embodiments, the non-aqueous based composition is emulsifiable concentrate composition.

In some embodiments, the non-aqueous based composition is oil dispersion.

In some embodiments, the composition is a solid composition.

In some embodiments, the azole fungicide is in its solid form in the composition.

In some embodiments, the azole fungicide is suspended in the agricultural acceptable carrier.

In some embodiments, the azole fungicide is dissolved in agricultural acceptable carrier.

In some embodiments, the agricultural acceptable carrier is water.

In some embodiments, the agricultural acceptable carrier is an organic carrier.

In some embodiments, the organic carrier is an oil.

In some embodiments, the organic carrier is a water immiscible carrier.

In some embodiments, the weight ratio between the azole fungicide and the additive (I) in the composition is between about 0.2:1 to 600:1. In some embodiments, the weight ratio between the azole fungicide and the additive (I) in the composition is between about 10:1 to 20:1. In some embodiments, the weight ratio between the azole fungicide and the additive (I) in the composition is 17:1. In some embodiments, the weight ratio between the azole fungicide and the additive (I) in the composition is 11.7:1.

In some embodiments, the azole fungicide is prothioconazole.

In some embodiments, the additive (I) is thiourea.

In some embodiments, the azole fungicide is prothioconazole and the additive (I) is thiourea.

In some embodiments, the composition comprises (1) azole fungicide, (2) additive (I) selected from the group consisting of thiourea-based compounds, sodium thiosulfate, alkyl amine, thioamide-based compounds, and any combination thereof, and (3) copper-based fungicide.

In some embodiments, the composition comprises (1) azole fungicide, (2) additive (I) selected from the group consisting of thiourea-based compounds, sodium thiosulfate, alkyl amine, thioamide-based compounds, and any combination thereof, (3) strobilurin fungicide, and (4) copper-based fungicide.

In some embodiments, the composition comprises (1) azole fungicide, (2) additive (I) selected from the group consisting of thiourea-based compounds, sodium thiosulfate, alkyl amine, thioamide-based compounds, and any combination thereof, (3) copper-based fungicide, and (4) water.

In some embodiments, the composition comprises (1) azole fungicide, (2) additive (I) selected from the group consisting of thiourea-based compounds, sodium thiosulfate, alkyl amine, thioamide-based compounds, and any combination thereof, (3) copper-based fungicide, (4) strobilurin fungicide, and (5) water.

In some embodiments, the composition comprises (1) azole fungicide, (2) additive (I) selected from the group consisting of thiourea-based compounds, sodium thiosulfate, alkyl amine, thioamide-based compounds, and any combination thereof, and (3) water.

In some embodiments, the composition comprises (1) azole fungicide, (2) additive (I) selected from the group consisting of thiourea-based compounds, sodium thiosulfate, alkyl amine, thioamide-based compounds, and any combination thereof, and (3) water, wherein the composition is free of copper-based fungicide.

The present invention provides a composition comprising (1) azole fungicide in amount of about 1-50% weight by weight based on the total weight of the composition (2) at least one additive (I) in amount of 0.1-5% weight by weight based on the total weight of the composition.

The present invention provides a composition comprising (1) azole fungicide in amount of about 1-50% weight by weight based on the total weight of the composition, (2) additive (I) selected from group consisting of thiourea-based compounds, sodium thiosulfate, alkyl amine, thioamide-based compounds, and any combination thereof in amount of 0.1-5% weight by weight based on the total weight of the composition.

In some embodiments, the additive (I) is selected from the group consisting of thiourea, sodium thiosulfate, alkyl amine and any combination thereof. In some embodiments, the additive (I) thiourea.

In some embodiments, the composition comprises more than one azole fungicide.

In some embodiments, the composition comprises an additional fungicide different from the azole fungicide.

In some embodiments, the composition comprises more than one additional fungicides different from the azole fungicide.

In some embodiments, the additional fungicide is copper-based fungicide. In some embodiments, the additional fungicide is different from a copper-based fungicide.

In some embodiments, the composition is free of copper-based fungicide.

In some embodiments, the additional fungicide is selected from strobilurin fungicides, benzamide fungicide, morpholines, QiI fungicide, SDHI and any combination thereof.

In some embodiments, the additional fungicide is flumetylsulforim. (5-fluoro-4-imino-3-methyl-1-tosyl-3,4-dihydropyrimidin-2 (1H)-one).

In some embodiments, the additional fungicide is fluazinam

In some embodiments, the additional fungicide is folpet

In some embodiments, the additional fungicide is captan.

In some embodiments, the additional fungicide is a strobilurin fungicide.

In some embodiments, the additional fungicide is dithiocarbamate fungicide

In some embodiments, the dithiocarbamate fungicide is mancozeb.

In some embodiments, the composition comprises two additional fungicides different from the azole fungicide which are strobilurin and copper-based fungicide.

In some embodiments, the composition further comprises at least one agriculturally acceptable additive.

In some embodiments, the composition comprising (1) azole fungicide and (2) additive (I), wherein additive (I) is thiourea.

In some embodiments, the amount of the azole fungicide in the composition is between 0.1% to 70% by weight based on the total weight of the composition.

In some embodiments, when the azole fungicide is prothioconazole, the amount of the azole fungicide in the composition is between 0.1% to 70% by weight based on the total weight of the composition.

In some embodiments, the amount of the additive (I) in the composition is between 0.1% to 5% by weight based on the total weight of the composition.

In some embodiments, when the additive (I) is thiourea, the amount of the additive (I) in the composition is between 0.1% to 5% by weight based on the total weight of the composition.

In some embodiments, the phytotoxicity when the additive (I) is used, is lower in at least 5% compared when the additive (I) is not used.

In some embodiments, the composition comprises additional fungicide(s).

In some embodiments, the composition further comprises water-immiscible solvent.

In some embodiments, the invention provides a composition comprising any one of the combinations described herein and at least one acceptable additive.

In some embodiments, the agriculturally acceptable additive is an agriculturally acceptable carrier.

In some embodiments, the agriculturally acceptable carrier is water.

In some embodiments, the agriculturally acceptable carrier is organic (non-aqueous) carrier.

In some embodiments, the organic carrier is a water immiscible carrier.

In some embodiments, when the azole fungicide is in its solid form and suspended in the composition, the particle size distribution (d90) is 10 microns or less. In some embodiments, the composition comprises particles with a particle size distribution (d90) is 7 microns or less. In some embodiments, the composition comprises particles with a particle size distribution (d90) of 4 microns or less.

In some embodiments, concentration of the additive (I) in the composition is between 0.01% to 10% by weight based on the total weight of the composition. In some embodiments, concentration of the additive (I) in the composition is between 0.1% to 8% by weight based on the total weight of the composition. In some embodiments, concentration of the additive (I) in the composition is between 0.1% to 5% by weight based on the total weight of the composition.

In some embodiments, the concentration of the azole fungicide in the composition is between 1% to 95% by weight based on the total weight of the composition. In some embodiments, the concentration of the azole fungicide in the composition is between 1% to 15% by weight based on the total weight of the composition. In some embodiments, the concentration of the azole fungicide in the composition is between 2% to 8% by weight based on the total weight of the composition.

In some embodiments, the concentration of the additional fungicide in the composition is between 1% to 45% by weight based on the total weight of the composition. In some embodiments, the concentration of the additional fungicide in the composition is between 10% to 40% by weight based on the total weight of the composition. In some embodiments, the concentration of the additional fungicide in the composition is between 20% to 35% by weight based on the total weight of the composition

In some embodiments, the composition comprises additional fungicide which is copper-based fungicide.

In some embodiments, the concentration of the copper-based fungicide is between 30-40% by weight based on the total weight of the composition.

In some embodiments, the composition comprises additional fungicide which is different from copper-based fungicide.

In some embodiments, the composition is free of copper-based fungicide.

The addition of an additive affects the chemically and physically stability of the compositions. Said additives may, for example, improve the stability of the composition.

In some embodiments, the agriculturally acceptable additive is selected from agriculturally acceptable carriers, buffers, acidifiers, antifoaming agents, anti-freeze agents, solvents, co-solvents, light agents, UV absorbers, radical scavengers and antioxidants, adhesives, neutralizers, thickeners, binders, sequestrates, biocides, drift retardants, surfactants, dispersants, pigments, wetting agents, safeners, and preservatives. Said additives include, but are not limited to, surfactants, pigments, wetting agents, as well as safeners, or such preservatives as bacteriostats or bactericides.

In some embodiments, the agriculturally acceptable additive is an agriculturally acceptable carrier. In some embodiments, the composition comprises at least one agriculturally acceptable carrier.

The addition of small amounts of one or more agriculturally acceptable additives may affect parameters such as stability, efficacy and/or rainfastness of a composition according to the invention. The addition of small amounts of one or more agriculturally acceptable carriers preferably increases stability, efficacy and/or rainfastness of a composition according to the invention.

In some embodiments, the agriculturally acceptable carrier is water.

In some embodiments, the composition comprises 30-80% by weight of water. In some embodiments, the composition comprises 40-70% by weight of water. In some embodiments, the composition comprises 40-80% by weight of water. In some embodiments, the composition comprises 50-70% by weight of water. In some embodiments, the composition comprises 50-55% by weight of water. In some embodiments, the composition comprises about 52% by weight of water. In some embodiments, the composition comprises about 53% by weight of water. In some embodiments, the composition comprises about 54% by weight of water. In some embodiments, the composition comprises about 55% by weight of water.

In some embodiments, the composition further comprises a polyelectrolyte as described in PCT/IB2021/061258, the entire content of which is hereby incorporated by reference into this application.

In some embodiments, the composition is suspension concentrate.

In some embodiments, the composition is suspension concentrate, where the composition comprises the azole fungicide in its solid form.

In some embodiments, the azole is in dissolved form.

In some embodiments, the composition is water-based composition.

In some embodiments, the water-based composition is suspension concentrate.

In some embodiments, the water-based composition is a suspoemulsion.

In some embodiments, the composition is non-aqueous based composition.

In some embodiments, the non-aqueous based composition is emulsifiable concentrate composition.

In some embodiments, the non-aqueous based composition is oil dispersion.

In some embodiments, the composition is a solid composition.

In some embodiments, when the composition comprising additional pesticide, the composition is suspoemulsion, where the composition comprising at least two carriers (1) water and (2) water-immiscible carrier.

In some embodiments, the azole fungicide is dissolved in the water-immiscible carrier. In some embodiments, the additional fungicide is selected from strobilurin fungicides, benzamide fungicide, morpholines, QiI fungicide, SDHI and any combination thereof.

In some embodiments, the additional fungicide is flumetylsulforim. (5-fluoro-4-imino-3-methyl-1-tosyl-3,4-dihydropyrimidin-2 (1H)-one).

In some embodiments, the additional fungicide is fluazinam

In some embodiments, the additional fungicide is folpet

In some embodiments, the additional fungicide is captan.

In some embodiments, the additional fungicide is suspended in the water or dissolved in the water-immiscible carrier.

In some embodiments, the additional fungicides are suspended in the water and/or dissolved in the water-immiscible carrier.

In some embodiments, when the composition comprises two or more additional fungicides, at least one additional fungicide is dissolved in the water immiscible carrier and at least one additional fungicide is suspended in water.

In some embodiments, when the composition comprises two or more additional fungicides, at least two additional fungicides are dissolved in the water immiscible carrier.

In another embodiment, the composition comprises: (1) prothioconazole, (2) thiourea and (3), wherein the prothioconazole is dissolved in water-immiscible carrier.

In another embodiment, the composition comprises: (1) prothioconazole, (2) thiourea and (3), wherein the prothioconazole is suspended in the water.

In some embodiments, water immiscible carrier may include but is not limited to aromatic hydrocarbons (e.g. toluene, o-, m-, p-xylene, ethylbenzene, isopropylbenzene, tert-butylbenzene, naphthalenes, mono- or polyalkyl-substituted naphthalenes), paraffins (e.g. octane, nonane, decane, undecane, dodecane, tridecane, tetradecane, pentadecane, hexadecane, hepta-decane, octa-decane, nona-decane, eicosane, heneicosane, docosane, tricosane, tetracosane, pentacosane, and branched chain isomers thereof), petroleum, ketones (e.g. acetophenone, cyclohexanone), vegetable oil (e.g. olive oil, kapok oil, castor oil, papaya oil, camellia oil, palm oil, sesame oil, corn oil, rice bran oil, peanut oil, cotton seed oil, soybean oil, rapeseed oil, linseed oil, tung oil, sunflower oil, safflower oil, tall oil), alkyl ester of vegetable oils, (e.g. rapeseed oil methyl ester or rapeseed oil ethyl ester, rapeseed oil propyl esters, rapeseed oil butyl esters, tall oil fatty acids esters etc.), diesel, mineral oil, fatty acid amides (e.g. C₁-C₃ amines, alkylamines or alkanolamines with C₆-C₁₈ carboxylic acids), Dimethylamide of fatty acid, N,N-dimethyl alkylamide (N.N-dimethyl decanamide, N,N-dimethyl octanamide, N, N-dimethyl dodecanamide, N,N-dialkyl alkanamide), N-alkyl alkanamide, fatty acids, tall oil fatty acids, alkyl esters of fatty acids (e.g. C₁-C₄ monohydric alcohol esters of C to C₂₂ fatty acids such as methyl oleate, ethyl oleate), modified vegetable oils and combinations thereof.

In a preferred embodiment, the water immiscible carrier may include but is not limited to aromatic hydrocarbons, fatty acid amides, alkyl ester of vegetable oils and vegetable oils.

In some embodiments, water immiscible carrier is acetophenone.

In some embodiments, water immiscible carrier is fatty acid amides.

In some embodiments, water immiscible carrier is N,N-Dimethyldecanamide.

In an embodiment, the amount of the water immiscible carrier may be about 0.1-20 wt. %, about 1-15 wt. %, or about 0.1-10 wt. %, or about 1-5% based on the total weight of the composition. In a specific embodiment, the non-aqueous liquid carrier may be present in a concentration of about 3% by weight based upon the total weight of the composition.

In some embodiments, the composition further comprises adjuvant.

In some embodiments, the adjuvant in the liquid carrier may include but is not limited to vegetable oils, alkyl esters of vegetable oils such as for example, soy methyl ester, soy ethyl ester, rapeseed oil methyl ester or rapeseed oil ethyl ester, alkoxylated sorbitan esters such as for example sorbitan monolaurate alkoxylates such as for example polyoxyethylene (16) sorbitan monolaurate (Tween™ 24), polyoxyethylene (20) sorbitan monolaurate (Tween™ 20; Alkamuls® PSML-20), polyoxyethylene (4) sorbitan monolaurate (Tween™ 21), polyoxyethylene (8) sorbitan monolaurate (Tween™ 22), polyoxyethylene (12) sorbitan monolaurate (Tween™ 23), sorbitan monolaurate (Alkamuls® S/20, Glycomul® LK, Glycomul® LC, Span® 20), polyoxyethylene (20) sorbitan monostearate alkoxylates such as for example polyoxyethylene (20) sorbitan monostearate (Tween™ 60), polyoxyethylene (4) sorbitan monostearate (Tween™ 61), sorbitan monostearate (Alkamuls® S/90, Glycomul® S, Span® 60), sorbitan monooleate alkoxylates such as for example polyoxyethylene (20) sorbitan monooleate (Tween™ 80, Emulgin® SMO 20, T-Maz® 80, Agnique® SMO 20U), polyoxyethylene (5) sorbitan monooleate (Tween™ 81), sorbitan monooleate (Alkamuls® S/80, Span® 80), and combinations thereof.

In some embodiments, the adjuvant is Synergen SOC.

In some embodiments, the agriculturally acceptable additive refers to surfactant.

In some embodiments, the surfactant is a wetting agent, dispersant, or a combination thereof.

In some embodiments, the composition comprises at least two surfactants.

In some embodiments, the dispersant is polyelectrolyte block copolymer (as described in WO2017/098325, the entire content of which is hereby incorporated by reference into this application).

In some embodiments, the dispersing agent is a block polymer comprises 77% of sodium 2-acryloylamino-2-methylpropane-1-sulfonate (AMPS) monomers and 23% of the ethyl acrylate (EA) monomers.

In some embodiments, the dispersing agent is a water solution of 30% by weight solution of a block polymer comprising 77% of sodium 2-acryloylamino-2-methylpropane-1-sulfonate (AMPS) monomers and 23% of ethyl acrylate (EA) monomers, which may be prepared as described in Example 1 of WO2017/098325.

In some embodiments, the agriculturally acceptable additive is a dispersant. In some embodiments, the composition comprises at least one dispersant.

In some embodiments the composition comprising at least one anionic dispersant and at least one non-ionic surfactant.

A composition of the invention may also comprise two or more different dispersants. A dispersant is preferably present in an amount of between 0 to up to 10% (w/v), more preferred between 0.01 to up to 5% (w/v), more preferred between 0.02 to up to 2% (w/v),

In some embodiments, the dispersant is a modified acrylic polymer, non-modified acrylic acid, or any combination thereof.

In some embodiments, the modified acrylic polymer is modified styrene acrylic acid, polymethyl methacrylate-polyethylene glycol graft copolymer or any combination thereof. In some embodiments, modified acrylic polymer is modified styrene acrylic polymer. In some embodiments, the modified styrene acrylic polymer is Atlox Metasperse 500L, Atlox Metsaperse 550S (sold by Croda). In some embodiments, the modified acrylic polymer is polymethyl methacrylate-polyethylene glycol graft copolymer.

In some embodiments, the concentration of the dispersant in the composition is 0.01-15% by weight based on the total weight of the composition.

In some embodiments, the concentration of the dispersant in the composition is 0.01-12% by weight based on the total weight of the composition. In some embodiments, the concentration of the dispersant in the composition is 1-12% by weight based on the total weight of the composition. In some embodiments, the concentration of the dispersant in the composition is 0.01-10% by weight based on the total weight of the composition. In some embodiments, the concentration of the dispersant in the composition is 1-5% by weight based on the total weight of the composition. In some embodiments, the concentration of the dispersant in the composition is 5-10% by weight based on the total weight of the composition. In some embodiments, the concentration of the dispersant is about 2% by weight based on the total weight of the composition. In some embodiments, the concentration of the dispersant is about 5% by weight based on the total weight of the composition. In some embodiments, the concentration of the dispersant is about 6% by weight based on the total weight of the composition. In some embodiments, the concentration of the dispersant is about 7% by weight based on the total weight of the composition. In some embodiments, the concentration of the dispersant is about 8% by weight based on the total weight of the composition. In some embodiments, the concentration of the dispersant is about 9% by weight based on the total weight of the composition. In some embodiments, the concentration of the dispersant is about 10% by weight based on the total weight of the composition.

A composition according to the invention may further comprise at least one pH adjuster or buffering agent such as organic or inorganic bases and/or organic or inorganic acids.

In some embodiments, the composition comprises one or more additives such as biocide (preservative) defoaming agents, thickeners, and drift retardants.

Wetting agent can be selected from di-octylsulphosuccinate, polyoxyethylene/polypropylene oxide, ethoxylated tristyrylphenol, ethoxylated tristyrylphenol sulphate, ethoxylated tristyrylphenol phosphate, ethoxylated propoxylated tristyryl phenol, and. A composition of the invention may also comprise two or more different wetting agents. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the concentration of the wetting agent in the composition is 1-10% by weight based on the total weight of the composition. In some embodiments, the concentration of the wetting agent in the composition is 0-5% by weight based on the total weight of the composition. In some embodiments, the concentration of the wetting agent in the composition is 1-5% by weight based on the total weight of the composition. In some embodiments, the concentration of the wetting agent in the composition is 1-3% by weight based on the total weight of the composition. In some embodiments, the concentration of the wetting agent in the composition is about 2% by weight based on the total weight of the composition.

In some embodiments, the composition comprises at least one rheology modifier. In some embodiments, the agriculturally acceptable additive is a rheology modifier.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidized starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the thickener is xanthan gum.

In some embodiments, the rheology modifier is Agrhopol 23, Rhodopol® 23 (sold by Solvay). In some embodiments, the rheology modifier is xanthan gum.

In some embodiments, the antifoaming agent is SAG 1572.

In some embodiments, the concentration of the rheology modifier in the composition is 0.01-10% by weight based on the total weight of the composition. In some embodiments, the concentration of the rheology modifier in the composition is 5-10% by weight based on the total weight of the composition. In some embodiments, the concentration of the rheology modifier in the composition is about 6% by weight based on the total weight of the composition. In some embodiments, the concentration of the rheology modifier in the composition is about 8% by weight based on the total weight of the composition.

In some embodiments, the composition comprises at least one thickener and at least one biocide. In some embodiments, the amount of the thickener and the biocide in the composition is up to 1% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide. In some embodiments, the preservative is Acticide® MBS.

In some embodiments, the concentration of the preservative in the composition is 0.01-5% by weight based on the total weight of the composition. In some embodiments, the concentration of the preservative in the composition is 0.01-1% by weight based on the total weight of the composition. In some embodiments, the concentration of the preservative in the composition is about 0.1% by weight based on the total weight of the composition. In some embodiments, the concentration of the preservative in the composition is 0.083% by weight based on the total weight of the composition.

A composition according to the invention may comprise an additional bioactive ingredient, also termed additional agrochemical, such as a growth regulator, a bio-stimulant, a fungicide, an herbicide, an insecticide, an acaricide, a molluscicide, a miticide, a rodenticide; and/or a bactericide.

Various agrochemicals may be used as additional bioactive ingredient. Exemplary among such agrochemicals without limitation are crop protection agents, for example pesticides, safeners, plant growth regulators, repellents, bio-stimulants, and preservatives such as bacteriostats or bactericides.

In some embodiments, the composition comprises at least one additional bioactive ingredient, preferably an additional insecticide, fungicide and/or herbicide.

Additional agrochemicals that may be used with the combination and composition of the present invention are described below.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is an insecticide, a fungicide and/or an herbicide.

The present invention provides a diluted composition comprising any one of the compositions described herein and water.

The present invention provides a diluted composition comprising azole fungicide, additive (I) and water.

In some embodiments, the diluted composition comprises azole fungicide, thiourea and water.

In some embodiments, the azole fungicide is prothioconazole.

In some embodiments, the weight ratio between the azole fungicide and the additive (I) is between about 1:60 to 60:1. In some embodiments, the weight ratio between the azole fungicide and the additive (I) is 7.1:1.

In some embodiments, the weight ratio between the azole fungicide and the thiourea is between about 1:60 to 60:1. In some embodiments, the weight ratio between the azole fungicide and the thiourea is 7.1:1.

In some embodiments, the weight ratio between the prothioconazole and the thiourea is between about 1:60 to 60:1. In some embodiments, the weight ratio between the prothioconazole and the thiourea is 7.1:1.

In some embodiments, when the composition comprises picoxystrobin and prothioconazole, the composition is free of copper-based fungicide.

In some embodiments, when the composition comprises picoxystrobin and prothioconazole, the composition is free of Bordeaux mixture.

In some embodiments, when the composition comprises picoxystrobin and prothioconazole, the composition is free of copper-oxychloride.

In some embodiments, the composition is other than an SE composition comprising:
(i) 34.53% w/w of Bordeaux mixture,
(ii) 2.70% w/w of picoxystrobin,
(iii) 10% w/w of glycerol,
(iv) 2% w/w of Geropon® T-77,
(v) 1% w/w of Atlox Metasperse™ 500L,
(vi) 1% w/w of ATLAS G5002L,
(vii) 0.1% w/w of SAG 1572,
(viii) 0.02% w/w of Proxel GXL,
(ix) 3% w/w of prothioconazole,
(x) 3.5% w/w of Rhodiasolv® Adma 10,
(xi) 1% w/w of Soprophor BSU,
(xii) 0.2% w/w of Rhodopol AgrhO 23,
(xiii) 0.4% w/w of thiourea, and
(xiv) 40.95% w/w of water.

In some embodiments, the composition is other than an SE composition comprising:
(i) 34.29% w/w of Bordeaux mixture,
(ii) 2.78% w/w of picoxystrobin,
(iii) 5.00% w/w of propylene glycol,
(iv) 1.00% w/w of Metasperse 550 S,
(v) 2.80% w/w of Borresperse CA,
(vi) 2.00% w/w of Geropon T-77,
(vii) 2.00% w/w of Atlox 4894,
(viii) 0.10% w/w of SAG 1572,
(ix) 0.05% w/w of Proxel GXL,
(x) 41.66% w/w of DM water,
(xi) 0.35% w/w of thiourea,
(xii) 3.06% w/w of prothioconazole,
(xiii) 3.06% w/w of Armid DM 10,
(xiv) 1.50% w/w of Emulsogen TS 200,
(xv) 0.25% w/w of triethanolamine, and
(xvi) 0.095% w/w of Rhodopol 23.

In some embodiments, the composition is other than an SE composition comprising:
(i) 35.49% w/w of Bordeaux mixture,
(ii) 39.72% w/w of DM water,
(iii) 2.80% w/w of picoxystrobin,
(iv) 3.16% w/w of prothioconazole,
(v) 3.50% w/w of Rhodiasolv Adma 10,
(vi) 2% w/w of Geropon T-77,
(vii) 1% w/w of Soprophor BSU,
(viii) 1% w/w of Atlox Metasperse 500L,
(ix) 1.00% w/w of Atlas G5002L,
(x) 0.1% w/w of SAG 1572,
(xi) 10% w/w of glycerol,
(xii) 0.02% w/w of Proxel GXL,
(xiii) 0.2% w/w of Rhodopol 23, and
(xiv) 0.4% w/w of thiourea.

In some embodiments, the composition is other than an SE composition comprising:
(i) 35.49% w/w of Bordeaux mixture,
(ii) 2.80% w/w of Borresperse CA,
(iii) 37.62% w/w of DM water,
(iv) 2.80% w/w of picoxystrobin,
(v) 3.16% w/w of prothioconazole,
(vi) 3.50% w/w of Rhodiasolv Adma 10,
(vii) 1% w/w of Geropon T-77,
(viii) 1% w/w of Soprophor BSU,
(ix) 1% w/w of Atlox Metasperse 500L,
(x) 1.00% w/w of Atlas G5002L,
(xi) 0.1% w/w of SAG 1572,
(xii) 10% w/w of glycerol,
(xiii) 0.02% w/w of Proxel GXL,
(xiv) 0.1% w/w of Rhodopol 23, and
(xv) 0.4% w/w of thiourea.

In some embodiments, the composition is other than an SE composition comprising:
(i) 34.53% w/w of Bordeaux mixture,
(ii) 2.70% w/w of picoxystrobin,
(iii) 5.00% w/w of propylene glycol,
(iv) 2.00% w/w of Geropon T-77,
(v) 1.00% w/w of Borresperse CA,
(vi) 1.00% w/w of Atlox Metasperse 500L,
(vii) 3.00% w/w of Atlox 4894,
(viii) 0.10% w/w of SAG 1572,
(ix) 0.10% w/w of Proxel GXL,
(x) (a) 2% ethylene diamine, or (b) thiourea 0.32%, or (c) mixture of sodium thiosulphate and thiourea 1%+0.5%,
(xi) 3.00% w/w of prothioconazole,
(xii) 3.00% w/w of Rhodiasolv ADMA 10,
(xiii) 1.50% w/w of Emulsogen TS 200,
(xiv) 0.20% w/w of Agrhopol 23, and
(XV) water up to 100% w/w.

In some embodiments, the composition is other than an SE composition comprising:
(i) 22.89% w/w of copper oxychloride tech,
(ii) 3.67% w/w of picoxystrobin tech,
(iii) 4.14% w/w of prothioconazole,
(iv) 0.45% w/w of acetic acid,
(v) 13.22% w/w of acetophenone,
(vi) 0.2% w/w of AG-RH 23,
(vii) 1% w/w of Agnique BP 420,
(viii) 2.64% w/w of Agsolex 8,
(ix) 1.87% w/w of Borresperse CA,
(x) 0.2% w/w of chitosan,
(xi) 5% w/w of PolyAgro A,
(xii) 3% w/w of propylene glycol,
(xiii) 0.02% w/w of Proxel GXL,
(xiv) 0.2% w/w of SAG 1572,
(xv) 2.54% w/w of sodium acetate,
(xvi) 2.02% w/w of Soprophor TS/16,
(xvii) 0.66% w/w of Synergen SOC,
(xviii) 0.35% w/w of thiourea,
(xix) 0.3% w/w of Van Gel B, and
(xx) water up to 100% w/w.

In some embodiments, the composition is other than a composition comprising:
(i) 30.08% w/w of Bordeaux mixture tech,
(ii) 2.71% w/w of picoxystrobin tech,
(iii) 3.1% w/w of prothioconazole,
(iv) 0.2% w/w of AG-RH 23,
(v) 1% w/w of ATLAS G-5002L-LQ-(CQ),
(vi) 1% w/w of Atlox Metasperse 500L-LQ-RB,
(vii) 2% w/w of GEROPON T 77,
(viii) 10% w/w of glycerine,
(ix) 0.02% w/w of Proxel GXL,
(x) 3.5% w/w of RHODIASOLV ADMA 10,
(xi) 0.1% w/w of SAG 1572,
(xii) 1% w/w of Soprophor BSU,
(xiii) 0.4% w/w of thiourea,
(xiv) 2.8% w/w of Borresperse CA, and
(XV) soft water up to 100% w/w.

### Method and Uses

The present invention provides a method of treating a plant or a locus thereof, against a pathogen, comprising contacting the plant, a part of the plant, or the locus with any one of the combinations and/or compositions described herein.

In some embodiments, the pathogen is phytopathogenic fungi.

In some embodiments, treating comprises controlling diseases caused by the pathogen. In some embodiments, the method controls diseases caused by phytopathogenic fungi in plants or on propagation material thereof, and the method comprises contacting the plants, or propagation material thereof, with a composition according to the invention, including an aqueous diluted composition.

In some embodiments, treating comprises controlling diseases caused by phytopathogenic fungi in plants or on propagation material thereof,

In some embodiments, treating comprises preventing, reducing and/or eliminating the presence of the pathogen on the plant, part of the plant or locus. In some embodiments, the method prevents, reduces and/or eliminates the presence of a pathogen on a plant, part of the plant, or the locus and the method comprises contacting the plant, part of the plant or the locus, with an aqueous composition according to this invention. In some embodiments, the method prevents, reduces and/or eliminates the presence of a pathogen on a plant, part of the plant, or locus and the method comprises contacting the plant, part of the plant, or locus with any one of the combinations and/or compositions described herein.

In some embodiments, treating comprises protecting the plant, a part of the plant, or the locus against the pathogen. In some embodiments, the method protects the plant, part of the plant or the locus against the pathogen and comprises contacting the plant, part of the plant, or the locus with a diluted aqueous composition according to this invention. In some embodiments, the method protects the plant, part of the plant, or locus against the pathogen and comprises contacting the plant, part of the plant, or the locus with any one of the combinations and/or compositions described herein.

The present invention also provides a method for increasing the rate of application of an azole fungicide to a plant or plant part and/or increasing the frequency of application of an azole fungicide to a plant or plant part without causing increased phytotoxicity to the plant, wherein the method comprises applying the azole fungicide to the plant or plant part in combination with an additive (I) selected from the group consisting of thiourea-based compounds, sodium thiosulfate, alkyl amine, thioamide-based compounds and any combination thereof.

In some embodiments, the method improves pest control without causing increased phytotoxicity to the plant.

The present invention also provides a method of improving pest control using an azole fungicide without increased phytotoxicity, wherein the method comprises applying any one of any combination and/or composition described herein comprising the azole fungicide to a locus where pest control is desired.

In some embodiments, the locus is a plant. In some embodiments, the locus is soil.

The present invention also provides a method of reducing and/or eliminating phytotoxicity to a plant or plant part caused by an azole fungicide applied to the plant or plant part, wherein the method comprises applying the azole fungicide in combination with an additive (I) selected from the group consisting of thiourea-based compounds, sodium thiosulfate, alkyl amine, thioamide-based compounds, and any combination thereof.

In some embodiment, the phytotoxicity is leaf necrosis.

The present invention also provides a method of improving a plant's tolerance to an amount of an azole fungicide comprising applying the amount of the azole fungicide in combination with an additive (I) selected from the group consisting of thiourea-based compounds, sodium thiosulfate, alkyl amine, thioamide-based compounds, and any combination thereof.

The present invention also provides a method of treating a plant or a locus heavily infected by fungal disease or susceptible to heavy infection of fungal disease comprising applying to the plant, plant part, or the locus an amount of azole fungicide in combination with an additive (I) selected from the group consisting of thiourea-based compounds, sodium thiosulfate, alkyl amine, thioamide-based compounds, and any combination thereof.

In some embodiment, the azole fungicide and the additive (I) are applied simultaneously. In some embodiment, the azole fungicide and the additive (I) are applied contemporaneously.

In some embodiments, the method comprises applying any one of the combinations and compositions described herein.

The present invention provides a method for using a composition comprising azole fungicide, the method comprising applying the azole fungicide in conjunction with additive (I).

The present invention provides a method for using composition comprising azole fungicide, the method comprising applying the azole fungicide in conjunction with thiourea.

The present invention provides a method for using a composition comprising azole fungicide, the method comprising applying the azole fungicide in the presence of additive (I).

The present invention provides a method for using composition comprising azole fungicide, the method comprising applying the azole fungicide in the presence of thiourea.

In some embodiments, the additive (I) is formulated with the azole as ready-mix composition.

In some embodiments, the thiourea is formulated with the azole as ready-mix composition

In some embodiments, the thiourea and azole fungicide are applied simultaneously as tank mix

In some embodiments, the thiourea and azole fungicide are applied as contemporaneous applications.

The present invention provides the use of thiourea for reducing or eliminating the phytotoxicity associated with application of an azole fungicide in a susceptible crop.

The present invention provides the use of additive (I) selected from the group consisting of thiourea, sodium thiosulfate, alkyl amine and any combination thereof for providing improvements in the application of azole fungicide.

The present invention provides the use of an additive (I) selected from group consisting of thiourea, sodium thiosulfate, alkyl amine and any combination thereof for reducing phytotoxicity associated with application of an azole fungicide.

Thus, the present invention also provides the use of an additive (I) for increasing the plant health of plant when is treated with an azole fungicide, wherein the plant health of a plant which is treated with the azole fungicide in presence of additive (I) is increased compared to the plant health of the plant which is treated with the same amount of the same azole fungicide in absence of the additive (I).

Thus, the present invention also provides a use of an additive (I) for reducing or eliminating the phytotoxicity associated with application of an azole fungicide, wherein the phytotoxic effects on a plant which is treated with the azole fungicide in presence of additive (I) is lower as compared to the phytotoxic effect on the plant which is treated with the same amount of the same azole fungicide in absence of the additive (I).

Thus, the present invention also provides a use of an additive (I) for reducing or eliminating the phytotoxicity of an azole fungicide, wherein the rate and/or extent of phytotoxic effects when the azole fungicide is applied in presence of an additive (I) is reduced as compared to the rate and/or extent of phytotoxic effects when the azole fungicide is applied in absence of an additive (I).

The present invention also provides a method for controlling plant disease caused by pathogen comprising applying an effective amount of any one of the herein described combination and/or composition and/or diluted composition to a plant, a locus thereof, propagation material thereof, or an area infested with the unwanted pathogen to thereby control the plant disease caused by pathogen.

The present invention also provides a method for controlling fungal disease caused by unwanted fungus comprising applying an effective amount of any one of the herein described combination and/or composition and/or diluted composition to a plant, a locus thereof, propagation material thereof, an area affected by the unwanted fungus to thereby control the fungal disease caused by the unwanted fungus.

Controlling refers to preventing fungal disease, curative treatment, and persistence treatment.

In some embodiments, the locus of the plant is the vicinity of the plant.

In some embodiments, the method comprises applying the combination and/or composition and/or diluted composition to the area infested with the unwanted pathogen.

The present invention provides a method for controlling pathogen infection comprising applying a composition comprising (1) an amount of azole fungicide (2) thiourea and (3) at least one agriculturally acceptable additive.

The present invention provides a method for controlling pathogen infection comprising applying a composition comprising (1) an amount of azole fungicide (2) optionally additional fungicide(s) (3) thiourea and (4) at least one agriculturally acceptable additive.

The present invention also provides use of the combination, and/or composition, and/or diluted composition described herein for treating a plant, or a part of a plant against a pathogen.

The present invention also provides use of the combination, and/or composition and/or diluted composition described herein for increasing the rate of application of azole fungicide.

The present invention also provides use of the combination, and/or composition and/or diluted composition described herein for increasing the number of applications of azole fungicide.

In some embodiments, when the azole fungicide is applied in presence of thiourea, the application number per growth period is increased and/or the frequency of the treatment is higher and/or the time interval between the application is reduced compared to if the same azole fungicide in the same crop under the same condition is applied in absence of thiourea.

A composition and/or combination according to the invention is suitable for the control of pests that are encountered in horticulture, agriculture, and forestry. The compositions are active against normally sensitive and resistant pest species and during all or individual stages of development. Prior to use, a composition comprising azole fungicide according to the invention is preferably dissolved or dispersed in water, or diluted with water, to provide an aqueous composition comprising between 0.001 and 10 w/v % of azole fungicide.

A composition according to the invention is preferably diluted 2-5000 times, preferably about 200 times, with an aqueous solvent, preferably water, prior to contacting a plant, plant part or soil with the composition.

this effect, said plant or plant part, or a soil, is contacted with said combination, composition, including a diluted aqueous composition.

Said combination, composition including a diluted aqueous composition is used, for example, to control soybean rust, powdery mildew, and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g., by means of wax or electrostatically). In addition, the composition, including a diluted aqueous composition, may be injected into the soil.

For example, a plant of part thereof may be coated with a diluted aqueous composition comprising an azole fungicide and additive (I) according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

### Processes of Preparation

The present invention provides a process for producing a composition comprising a (1) azole fungicide and (2) additive (I) selected from group consisting of thiourea-based compounds, sodium thiosulfate, alkyl amine, thioamide-based compounds and any combination thereof, the process comprising the following steps: (a) preparing an aqueous composition of the azole fungicide and (b) adding additive (I) selected from group consisting of thiourea, sodium thiosulfate, alkyl amine and any combination thereof to obtain composition of azole fungicide and additive (I).

In some embodiments, the additive (I) is selected from the group consisting of thiourea, sodium thiosulfate, alkyl amine and any combination thereof.

In some embodiments, the composition prepared in said process is devoid of copper-based fungicide.

### Azole Fungicides

In some embodiments, the term “azole fungicide” may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole and mefentrifluconazole and in some embodiments, azole fungicide includes any combinations of two or more thereof.

In some embodiments, the azole fungicide is epoxiconazole.

In some embodiments, the azole fungicide is metconazole.

In some embodiments, the azole fungicide is mefentrifluconazole.

In some embodiments, the azole fungicide is prothioconazole.

In some embodiments, the azole fungicide is cyproconazole.

In some embodiments, the azole fungicide is difenoconazole.

In some embodiments, the azole fungicide is tebuconazole.

### Additional Fungicides

In some embodiments, the additional fungicide is selected from the group consisting of copper-based fungicide, strobilurin fungicides, benzamide fungicide, morpholines, QiI fungicide, SDHI and any combination thereof.

In some embodiments, the additional fungicide is flumetylsulforim. (5-fluoro-4-imino-3-methyl-1-tosyl-3,4-dihydropyrimidin-2 (1H)-one).

In some embodiments, the strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, metyltetraprole and fluoxastrobin.

In some embodiments, the strobilurin fungicide is selected from the group consisting of picoxystrobin, trifloxystrobin, azoxystrobin, pyraclostrobin, metominostrobin, metyltetraprole, mandestrobin and a combination thereof.

In some embodiments, the strobilurin fungicide is picoxystrobin.

In some embodiments, the strobilurin fungicide is azoxystrobin.

In some embodiments, the SDHI may include but is not limited to penthiopyrad, boscalid, flutolanil, fluxapyroxad, inpyrfluxam, fluopyram, fluindapyr, benzodiflupyr, bixafen and pydiflumetofen

In some embodiments, the SDHI fungicide is selected from the group consisting of bixafen; fluxapyroxad, fluindapyr; inpyrfluxam, benzodiflupyr and pydiflumetofen.

In some embodiments, the SDHI fungicide is fluxapyroxad.

In some embodiments, the QiI fungicide may include but is not limited to cyazofamid, amisulbrom and fenpicoxamid.

In some embodiments, QiI is fenpicoxamide.

In some embodiments, the morpholines may include but is not limited to aldimorph, fenpropimorph, ridemorph, dodemorph, spiroxamine, piperalin, fenpropidin.

In some embodiments, the additional fungicide is fluazinam.

In some embodiments, the additional fungicide is folpet.

In some embodiments, the additional fungicide is captan.

A preferred additional fungicide is selected from mancozeb, sodium ortho-phenylphenate, 2-phenylphenol; 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example, (RS)-1-(β-allyloxy-2,4-dichlorophenethyl) imidazole (imazalil; Janssen Pharmaceutica NV, Belgium) and N-propyl-N-[2-(2,4,6-trichlorophenoxy)ethyl] imidazole-1-carboxamide (prochloraz); cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; fluopicolide; flurprimidol; flusulfamide; flutolanil; folpet (N-(trichloromethylthio) phthalimide); fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; mandipropamid, meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-alph-a.-(methoxymethylene) benzeneacetate; methyl 2-[2-[3-(4-chlorophenyl)-1-methyl-allylideneaminooxymethyl]phenyl]-3-meth-oxyacrylate; metiram; metominostrobin; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl)cyclopropanecarboxamide; a polyene fungicide such as natamcyin; N-butyl-8-(1,1-dimethylethyl)-1-oxaspiro[4.5]decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phosphite salts such as disodium phosphite and potassium phosphite, phthalide; picobenzamid; picoxystrobin; piperalin; polyoxins; polyoxorim; procymidone; propamocarb; propanosine-sodium; propineb; proquinazid; prothioconazole; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicyofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)—N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl) sulphonyl]-N,N-dimethyl-1H-1,-2,4-triazole-1-sulphonamide, and/or mixtures thereof.

In some embodiments, the copper-based fungicide is soluble in water.

In some embodiments, the copper-based fungicide is not soluble in water.

In some embodiments, the copper-based fungicide is selected from group consisting of cupric acetate, cupric chloride, cupric chlorate, cupric formate, cupric hexafluorosilicate, cupric nitrate, cupric chromate, copper sulfate pentahydrate, Bordeaux mixture, copper hydroxide, cuprous oxide, copper oxychloride, copper oxychloride sulfate (COCS), tribasic copper sulfate such as cupric sulfate, tricupric hydroxide, hemihydrate, and any combination thereof.

In some embodiments, the copper-based fungicide may be but not limited to cupric acetate, cupric chloride, cupric chlorate, cupric formate, cupric hexafluorosilicate, cupric nitrate, cupric chromate, copper sulfate pentahydrate, Bordeaux mixture, copper hydroxide, cuprous oxide, copper oxychloride, copper oxychloride sulfate (COCS), tribasic copper sulfate such as cupric sulfate, tricupric hydroxide, hemihydrate, or any combination thereof.

In some embodiments, the copper-based fungicide is selected from the group consisting of cupric acetate, cupric chloride, cupric chlorate, cupric formate, cupric hexafluorosilicate, cupric nitrate, cupric chromate, copper sulfate pentahydrate, Bordeaux mixture, cuprous oxide, copper oxychloride, and any combination thereof.

In some embodiments, the copper-based fungicide is Bordeaux mixture.

In some embodiments, the copper-based fungicide is copper hydroxide.

In some embodiments, the copper-based fungicide is copper oxychloride.

In some embodiments, the copper-based fungicide is selected from the group consisting of copper sulfate pentahydrate, Bordeaux mixture and any combination thereof.

As used herein, the term “copper-based fungicide” refers to copper salt (such as copper sulfate, copper hydroxychloride, and copper oxide) and/or metallic copper.

As used herein, the term “metallic copper” refers to Cu²⁺ cation.

### Additive (I)

The additive (I) is selected from a group consisting of
(i) thiourea-based compound,
(ii) sodium thiosulfate,
(iii) alkyl amine,
(iv) thioamide-based compound, and
(v) any combination of (i), (ii), (iii) and (iv),

In some embodiments, the additive (I) is selected from the group consisting of (i) thiourea, (ii) sodium thiosulfate, (iii) alkyl amine and (iv) any combination of (i), (ii) and (iii).

In some embodiments, the alkyl amine is ethylene diamine.

In some embodiments, the alkyl amine is hexamethylene tetra amine.

In some embodiments, the alkyl amine is triethyl amine.

In some embodiments, the additive (I) is a mixture of two compounds selected from the group consisting of thiourea, hexamethylene tetra amine, sodium thiosulfate and ethylene diamine.

In some embodiments, the additive (I) is thiourea.

In some embodiments, the additive (I) is selected from the group consisting of thiourea-based compound, hexamethylene tetra amine, sodium thiosulfate, ethylene diamine and any combination thereof.

In some embodiments, the additive (I) is a mixture of two compounds selected from the group consisting of thiourea-based compound, sodium thiosulfate, alkyl amine and thioamide-based compound.

In some embodiments, the additive (I) is a mixture of two compounds selected from the group consisting of thiourea-based compound, hexamethylene tetra amine, sodium thiosulfate and ethylene diamine.

In some embodiments, the additive (I) is thiourea-based compound.

In some embodiments, the thiourea-based compound is thiourea.

In some embodiments, thiourea refers to the compound with the formula SC(NH₂)₂ and the structure H₂N—C(═S)—NH₂ (a.k.a. thiourea material, CAS number: 62-56-6).

Thiourea-based compound refers to a compound having the structure represented by the formula:

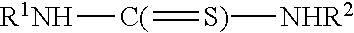

wherein,
(i) R¹, R², are both H;
(ii) R¹ is H and R² is alkyl or alkenyl or alkynyl or aryl or heterocyclic;
(iii) R¹, R² are each, independently, alkyl, alkenyl or alkynyl;
(iv) R¹, R² are each, independently, aryl, or heterocyclic;
(v) R¹ is alkyl or alkenyl or alkynyl and R² is aryl or heterocyclic, or
(vii) R¹ and R² can be taken together with the nitrogen atoms to which they are attached to form a ring containing 2 to 4 atoms of carbon and optionally one additional atom of nitrogen, sulfur or oxygen, said ring may be saturated or unsaturated and optionally substituted with 1 to 4 substituents selected from the group consisting of C₁-C₂ alkyl, halogen, CN, NO₂ and C₁-C₂ alkoxy.

In some embodiments, alkyl, which may be optionally substituted, denotes a linear or branched or cyclic hydrocarbon group comprising n carbon atoms, or up to 20 carbon atoms.

In some embodiments, alkyl denotes a linear or branched or cyclic hydrocarbon group comprising 1-8 carbon atoms.

In some embodiments, alkenyl, which may be optionally substituted, denotes a linear or branched or cyclic hydrocarbon group comprising n carbon atoms and at least one double bond.

In some embodiments, alkynyl which may be optionally substituted, denotes a linear or branched hydrocarbon group comprising n carbon atoms and at least one triple bond.

In some embodiments, alkenyl and alkynyl comprise 2-8 carbon atoms.

In some embodiments, aryl, which may be optionally substituted, denotes to carbocyclic aromatic radicals having from 6 to 14 carbon atoms.

In some embodiments, heterocyclic, which may be optionally substituted, denotes saturated, partially saturated, or fully unsaturated cyclic radical, which contains 3 to 6 ring atoms, of which 1 to 4 are from the group consisting of oxygen, nitrogen and sulfur.

In some embodiments, the thiourea-based compound is butyl thiourea, methyl propyl thiourea, phenylthiourea, ethylphenylthiourea, or diphenylthiourea.

In some embodiments, the thiourea-based compound is cyclic thiourea.

In some embodiments, Additive (I) is not a fungicidally active ingredient.

In some embodiments, Additive (I) is selected from thiourea-based compound which are not pesticidally active.

In some embodiments, the selected additive (I) is a thioamide-based compound.

In some embodiments, the thioamide-based compound may include but is not limited to thioacetamide, thiobenzamide, furan thioamide, pyridine thioamide and polythioamide.

In some embodiments, the thioamide-based compound is selected from the group consisting of thioacetamide, thiobenzamide, furan thioamide, pyridine thioamide and polythioamide.

In some embodiments, the additive (I) is sodium thiosulfate.

In some embodiments, the additive (I) is alkylamine. In some embodiments, the additive (I) comprises one or more alkylamines.

In some embodiments, the alkylamine comprises one or more mono amines.

In some embodiments, the alkylamine is mono amine.

In some embodiments, the alkylamine is a diamine.

In some embodiments, the alkylamine is a polyamine.

In some embodiments, the polyamine is hexamethylene tetra amine.

In some embodiments, the diamine is ethylene diamine.

In some embodiments, the alkylamine is represented by the structure A;

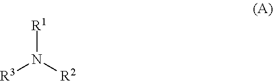

wherein:
(i) R¹ is hydrogen, alkyl, aryl, alkenyl, alkynyl or heterocyclic; R² is hydrogen, alkyl, aryl, alkenyl, alkynyl or heterocyclic; and R³ is hydrogen, alkyl, aryl, alkenyl, alkynyl or heterocyclic; and
(ii) at least one of R¹, R², and R³ is alkyl, aryl, alkenyl, alkynyl or heterocyclic.

In some embodiments, alkyl, which may be optionally substituted, denotes a linear or branched or cyclic hydrocarbon group comprising n carbon atoms.

In some embodiments, alkenyl, which may be optionally substituted, denotes a linear or branched or cyclic hydrocarbon group comprising n carbon atoms and at least one double bond.

In some embodiments, alkynyl which may be optionally substituted, denotes a linear or branched, hydrocarbon group comprising n carbon atoms and at least one triple bond.

In some embodiments, aryl, which may be optionally substituted, denotes to carbocyclic aromatic radicals having from 6 to 14 carbon atoms.

In some embodiments, heterocyclic, which may be optionally substituted, denotes saturated, partially saturated, or fully unsaturated cyclic radical, which contains 3 to 6 ring atoms, of which 1 to 4 are from the group consisting of oxygen, nitrogen and sulfur.

In some embodiments, substituted means that the group (R¹, R² and/or R³) may or may not be further substituted by one or more groups such as Cn alkyl, aryl, halogen, hydroxyl, thio, amino, cyano, oxo, nitro, acyl, amido, C₁₋₆ alkoxy, C₁₋₆ alkenyloxy, aryloxy, acyloxy, C₁₋₆ alkylamino, arylamino, C₁₋₆ alkylthio, alkylsulfonyl, arylsulfonyl, alkylsulfinyl, arylsulfinyl, C₁₋₈ alkylamido, and carboxyl.

In some embodiments, two or more of, R¹, R², R³ are the same.

In some embodiments, each of R¹, R², R³ are different.

In some embodiments where one or more of R¹, R², R³ is alkyl, one or more alkyl is linear.

In some embodiments, an alkyl is cyclic.

In some embodiments, an alkyl is an alkyl fatty chain.

In some embodiments, R¹, R² and R³ are methyl.

In some embodiments, R¹, R² and R³ are ethyl.

In some embodiments, the R¹ and R² are H and R³ is C₁₂ alkyl.

In some embodiments, the R¹ and R² are H and R³ is C₁₈ alkenyl.

In some embodiments, the selected additive (I) is an alkyl amine which is oleyl amine.

In some embodiments, the alkylamine is dodecyl amine.

In some embodiments, the alkylamine is benzyl amine.

In some embodiments, additive (I) is hexamethylene tetra amine.

In some embodiments, additive (I) is sodium thiosulfate.

In some embodiments, additive (I) is ethylene diamine.

In some embodiments, alkylamine is Butylamine.

In some embodiments, alkylamine is Diethyl amine.

In some embodiments, alkylamine is Triethylamine.

In some embodiments, additive (I) comprises thiourea.

In some embodiments, additive (I) comprises thioamide-based compound.

In some embodiments, additive (I) comprises sodium thiosulfate.

In some embodiments, additive (I) comprises alkylamine

In some embodiments, additive (I) comprises ethylene diamine.

In some embodiments, alkylamine comprises Butylamine.

In some embodiments, alkylamine comprises Diethyl amine.

In some embodiments, alkylamine comprises Triethylamine

In some embodiments, additive (I) is mixture of two compounds (I) and the weight ratio between them is from 10:1 to 1:10.

In some embodiments, additive (I) is a mixture of thiourea and sodium thiosulfate.

In some embodiments, the weight ratio between the thiourea and sodium thiosulfate is from 10:1 to 1:10.

In some embodiments, the weight ratio between the thiourea and sodium thiosulfate is from 10:1 to 1:10.

In some embodiments, additive (I) is a mixture of hexamethylene tetra amine and thiourea.

In some embodiments, the weight ratio between the thiourea and hexamethylene tetra amine is from 10:1 to 1:10.

In some embodiments, additive (I) is a mixture of hexamethylene tetra amine and sodium thiosulfate.

In some embodiments, the weight ratio between the hexamethylene tetra amine and sodium thiosulfate is from 10:1 to 1:10

In some embodiments, additive (I) is a mixture of sodium thiosulfate and ethylene diamine.

In some embodiments the weight ratio between the sodium thiosulfate and ethylene diamine is from 10:1 to 1:10.

In some embodiments, additive (I) is a mixture of thiourea and ethylene diamine.

In some embodiments, the weight ratio between the thiourea and ethylene diamine is from 10:1 to 1:10.

### Copper-Based Fungicide, Additional Fungicides and Polyelectrolyte

Combination, macromolecular complex, and composition comprising copper-based fungicide, polyelectrolyte, and additional fungicides. The present invention relates to combinations and compositions comprising a copper-based fungicide and a polyelectrolyte. The invention further relates to methods of preventing, reducing and/or eliminating the presence of a phytopathogen on a plant or on one or more plant parts, comprising applying a composition of the present invention to said plant or plant part. The present invention provides a suspoemulsion composition comprising a copper-based fungicide, (2) a polyelectrolyte, (3) at least one additional fungicide selected from the group consisting of strobilurin fungicides, azole fungicides, benzamide fungicides, morpholines, QiI fungicides, SDHI and any combination thereof, (4) water and (5) a water immiscible carrier, wherein the copper-based fungicide is suspended in the water and at least one of the additional fungicides is dissolved in the water immiscible carrier.

It is an objective of the present invention to provide compositions and methods that allow reduction in the amounts of copper-based fungicide needed to control phytopathogenic pests. Another objective of the present invention is to develop methods and compositions which provide effective plant growth control. Plant growth control refers to preventing damage to the plant by controlling pathogen and reduction negative effect on the plant health.

It was surprisingly found that a combination of copper-based fungicide and polyelectrolyte may significantly reduce the amount of copper-based fungicide needed to achieve a given level of pest control and enhance biological efficacy and plant health. Improved biological efficacy includes improved uptake and bioavailability.

As used herein, the term “copper-based fungicide” refers to copper salt (such as copper sulfate, copper hydroxychloride, and copper oxide) and/or metallic copper.

As used herein, the term “metallic copper” refers to Cu²⁺ cation.

Copper-based fungicide and polyelectrolyte can be the constituents of a macromolecular complex which significantly decreases the amount of the copper-based fungicide needed to achieve a certain level of biological efficacy, enhances the biological efficacy of a given amount of copper-based fungicide, improves persistence of the copper-based fungicide, and reduces phytotoxicity of the copper-based fungicide, when compared to copper-based fungicide applied in the absence of polyelectrolyte.

In addition, a macromolecular complex according to the invention reduces drift of the copper-based fungicide. Said macromolecular complex surprisingly results in a reduction of the mobility of copper-based fungicide in the soil or leakage. Said complex furthermore results in reduced toxicity to the plants, hence causing less phytotoxicity, when compared to copper-based fungicide that is not applied as part of a macromolecular complex as described in the present invention.

The copper-based fungicide composition according to the present invention also has improved physical properties such as viscosity, different morphology and particle size when compared to a composition of free copper-based fungicide without polyelectrolyte.

### Combinations and Compositions

The present invention provides a combination of copper-based fungicide and polyelectrolyte.

The present invention provides a composition comprising the combination described herein and at least one agriculturally acceptable additive.

The present invention provides a suspoemulsion composition comprising a copper-based fungicide, a polyelectrolyte, and at least one additional fungicide.

The present invention provides a suspoemulsion composition comprising (1) a copper-based fungicide, (2) a polyelectrolyte, (3) at least one additional fungicide selected from the group consisting of strobilurin fungicides, azole fungicides, benzamide fungicides, morpholines, QiI fungicides, SDHI and any combination thereof, (4) water, and (5) a water immiscible carrier, wherein the copper-based fungicide is suspended in the water and at least one additional fungicide is dissolved in the water immiscible carrier.

In some embodiments, the suspoemulsion composition comprises a macromolecular complex comprising the copper-based fungicide and the polyelectrolyte.

In some embodiments, the copper-based fungicide may be but not limited to cupric acetate, cupric chloride, cupric chlorate, cupric formate, cupric hexafluorosilicate, cupric nitrate, cupric chromate, copper sulfate pentahydrate, Bordeaux mixture, copper hydroxide, copper oxychloride sulfate (COCS), tribasic copper sulfate such as cupric sulfate, tricupric hydroxide, hemihydrate, or any combination thereof.

In some embodiments, the copper-based fungicide is selected from the group consisting of cupric acetate, cupric chloride, cupric chlorate, cupric formate, cupric hexafluorosilicate, cupric nitrate, cupric chromate, copper sulfate pentahydrate, Bordeaux mixture and any combination thereof.

In some embodiments, the copper-based fungicide is selected from the group consisting of copper sulfate pentahydrate, Bordeaux mixture and any combination thereof.

In some embodiments, the composition comprises two additional fungicides. In some embodiments, the composition comprises two or more additional fungicides.

In some embodiments, when the composition comprises two or more additional fungicides, at least one additional fungicide is dissolved in the water immiscible carrier and at least one additional fungicide is suspended in water and/or dissolved in the water immiscible carrier.

In some embodiments, the copper-based fungicide is Bordeaux mixture and the additional fungicide is prothioconazole.

In some embodiments, the copper-based fungicide is Bordeaux mixture and the additional fungicide is tebuconazole.

In some embodiments, the copper-based fungicide is Bordeaux mixture and the additional fungicide are prothioconazole and picoxystrobin.

In some embodiments, the copper-based fungicide is Bordeaux mixture and the additional fungicide are prothioconazole and azoxystrobin.

In some embodiments, the copper-based fungicide is Bordeaux mixture and the additional fungicide are tebuconazole and picoxystrobin.

In some embodiments, the copper-based fungicide is Bordeaux mixture and the additional fungicide are tebuconazole and azoxystrobin.

In some embodiments, the copper-based fungicide is Bordeaux mixture and the additional fungicide are prothioconazole and fluxapyroxad.

In some embodiments, the copper-based fungicide is Bordeaux mixture and the additional fungicide are tebuconazole and azoxystrobin.

In some embodiments, the copper-based fungicide is copper oxychloride and the additional fungicide is prothioconazole.

In some embodiments, the copper-based fungicide is copper oxychloride and the additional fungicide is tebuconazole.

In some embodiments, the copper-based fungicide is copper oxychloride and the additional fungicide are prothioconazole and picoxystrobin.

In some embodiments, the copper-based fungicide is copper oxychloride and the additional fungicide are prothioconazole and azoxystrobin.

In some embodiments, the copper-based fungicide is copper oxychloride mixture and the additional fungicide are tebuconazole and picoxystrobin.

In some embodiments, the copper-based fungicide is copper oxychloride and the additional fungicide are tebuconazole and azoxystrobin.

In some embodiments, the copper-based fungicide is copper oxychloride and the additional fungicide are prothioconazole and fluxapyroxad.

In some embodiments, the copper-based fungicide is copper oxychloride and the additional fungicide are tebuconazole and azoxystrobin.

In some embodiments, the amount of the copper-based fungicide in the composition is 1-50% by weight based on the total weight of the composition. In some embodiments, the amount of the copper-based fungicide in the composition is 5-40% by weight based on the total weight of the composition. In some embodiments, the amount of the copper-based fungicide in the composition is 5-18% by weight based on the total weight of the composition.

In some embodiments, the amount of additional fungicide(s) in the composition is 1-50% by weight based on the total weight of the composition. In some embodiments, the amount of additional fungicide(s) in the composition is 1-30% by weight based on the total weight of the composition. In some embodiments, the amount of additional fungicide(s) in the composition is 1-20% by weight based on the total weight of the composition. In some embodiments, the amount of additional fungicide(s) in the composition is 1-15% by weight based on the total weight of the composition.

In some embodiments, the amount of the strobilurin fungicide in the composition is 1-15% by weight based on the total weight of the composition. In some embodiments, the amount of the strobilurin fungicide in the composition is 1-5% by weight based on the total weight of the composition. In some embodiments, the amount of the strobilurin fungicide in the composition is 5-10% by weight based on the total weight of the composition. In some embodiments, the amount of the strobilurin fungicide in the composition is 10-15% by weight based on the total weight of the composition.

In some embodiments, the amount of the azole fungicide in the composition is 1-20% by weight based on the total weight of the composition. In some embodiments, the amount of the azole fungicide in the composition is 1-5% by weight based on the total weight of the composition. In some embodiments, the amount of the azole fungicide in the composition is 5-10% by weight based on the total weight of the composition. In some embodiments, the amount of the azole fungicide in the composition is 10-15% by weight based on the total weight of the composition. In some embodiments, the amount of the azole fungicide in the composition is 15-20% by weight based on the total weight of the composition.

In some embodiments, the amount of the succinate dehydrogenate inhibitor fungicide (SDHI) in the composition is 1-15% by weight based on the total weight of the composition. In some embodiments, the amount of the succinate dehydrogenate inhibitor fungicide (SDHI) in the composition is 1-5% by weight based on the total weight of the composition. In some embodiments, the amount of the succinate dehydrogenate inhibitor fungicide (SDHI) in the composition is 5-10% by weight based on the total weight of the composition. In some embodiments, the amount of the succinate dehydrogenate inhibitor fungicide (SDHI) in the composition is 10-15% by weight based on the total weight of the composition.

In some embodiments, the amount of the benzamide fungicide in the composition is 1-50% by weight based on the total weight of the composition.

In some embodiments, the amount of the morpholine(s) in the composition is 1-50% by weight based on the total weight of the composition.

In some embodiments, the amount of the QiI fungicide in the composition is 1-50% by weight based on the total weight of the composition.

In some embodiments, the copper-based fungicide is Bordeaux mixture.

In some embodiments, the composition comprises 5-18% by weight of the Bordeaux mixture, 1-15% by weight of the strobilurin fungicide, and 1-20% by weight of the azole fungicide.

In some embodiments, the composition comprises 5-18% by weight of the Bordeaux mixture, and 1-20% by weight of the azole fungicide.

In some embodiments, the composition comprises 5-18% by weight of the Bordeaux mixture, 1-20% by weight of the azole fungicide, and 1-15% by weight of the SDHI.

In some embodiments, the composition comprises 5-18% by weight of the Bordeaux mixture and 1-15% by weight of the strobilurin fungicide.

In some embodiments, the composition comprises 5-18% by weight of the Bordeaux mixture and 1-15% by weight of the SDHI.

In some embodiments, the copper-based fungicide is copper oxychloride.

In some embodiments, the composition comprises 5-40% by weight of copper oxychloride, 1-15% by weight of the strobilurin fungicide, and 1-20% by weight of the azole fungicide.

In some embodiments, the composition comprises 5-40% by weight of copper oxychloride, and 1-20% by weight of the azole fungicide.

In some embodiments, the composition comprises 5-40% by weight of copper oxychloride, 1-20% by weight of the azole fungicide, and 1-15% by weight of the SDHI.

In some embodiments, the composition comprises 5-40% by weight of copper oxychloride and 1-15% by weight of the strobilurin fungicide.

In some embodiments, the composition comprises 5-40% by weight of copper oxychloride and 1-15% by weight of the SDHI.

The present innovative combination increases the solubility and/or dispersibility of a copper-based fungicide and improves its biological efficacy by controlling the formation and release of the active component as copper ions. The net effect is that less copper-based fungicide is required to achieve control of agricultural pests, when compared to the same copper-based fungicide that is not formulated with polyelectrolytes.

The present invention provides a combination of copper-based fungicide and polyelectrolyte. The present invention provides a combination of copper-based fungicide and polyanion. The present invention provides a combination of an amount of copper-based fungicide and an amount of polyelectrolyte.

In some embodiments, the combination is a macromolecular complex comprising the copper-based fungicide and the polyelectrolyte. In some embodiments, the combination is (1) a macromolecular complex comprising the copper-based fungicide and the polyelectrolyte, and (2) at least one additional fungicide. In some embodiments, the combination is (1) a macromolecular complex comprising the copper-based fungicide and the polyelectrolyte, and (2) at least two additional fungicides.

In some embodiments, the additional fungicide is selected from the group consisting of strobilurin fungicides, azole fungicides, benzamide fungicides, morpholines, QiI fungicides, SDHI and any combination thereof.

The present invention provides a composition comprising the combination described herein and at least one agriculturally acceptable additive. In some embodiments, the composition comprise at least one additional fungicide.

In some embodiments, the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the copper-based fungicide. In some embodiments, the copper-based fungicide molecules interact chemically with the polyelectrolyte through intermolecular force(s).

The present invention provides a macromolecular complex of a copper-based fungicide and a polyelectrolyte, wherein the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the copper-based fungicide.

The present invention provides a composition comprising (1) a copper-based fungicide, (2) a polyelectrolyte, and (3) at least one agriculturally acceptable additive. The present invention provides a composition comprising (1) an amount of copper-based fungicide, (2) an amount of a polyelectrolyte, and (3) at least one agriculturally acceptable additive.

In some embodiments, the present invention provides a composition comprising (1) a copper-based fungicide, (2) a polyelectrolyte, (3) at least one additional fungicide, and (4) at least one agriculturally acceptable additive.

The present invention provides a composition comprising (1) an amount of copper-based fungicide, (2) an amount of a polyelectrolyte, (3) at least one additional fungicide, and (4) at least one agriculturally acceptable additive.

In some embodiments, the composition comprises a macromolecular complex of the copper-based fungicide and the polyelectrolyte.

The present invention provides a composition comprising macromolecular complex comprising copper-based fungicide and polyelectrolyte. The present invention provides a composition comprising (i) macromolecular complex comprising copper-based fungicide and polyelectrolyte, and (ii) at least one agriculturally acceptable additive. The present invention provides a composition comprising (i) a macromolecular complex comprising a copper-based fungicide and a polyelectrolyte and (ii) at least one additional fungicide.

The present invention provides a composition comprising (i) a macromolecular complex comprising a copper-based fungicide and a polyelectrolyte, (ii) at least one additional fungicide and (iii) at least one agriculturally acceptable additive.

The present invention provides a composition comprising a copper-based fungicide and a polyelectrolyte.

The present invention provides a composition comprising (i) a copper-based fungicide (ii) a polyelectrolyte, (iii) at least one additional fungicide, and (iv) at least one agriculturally acceptable additive.

In some embodiments, the polyelectrolyte comprises at least one polyanion. In some embodiments, the polyelectrolyte is a polyanion. In some embodiments, the polyelectrolyte comprises a polycation and a polyanion. In some embodiments, the polyelectrolyte is a complex of a polycation and a polyanion. The present invention provides a composition comprising any one of the combinations or macromolecular complexes described herein and at least one acceptable additive.

In some embodiments, the agriculturally acceptable additive is an agriculturally acceptable carrier.

In some embodiments, the agriculturally acceptable carrier is water.

In some embodiments, the agriculturally acceptable carrier is a water immiscible carrier.

In some embodiments, the copper-based fungicide is suspended in the water.

In some embodiments, the additional fungicide(s) is/are suspended in the water.

In some embodiments, the composition comprises at least two additional fungicides which are suspended in a water carrier.

In some embodiments, the composition further comprises an organic phase.

In some embodiments, the composition comprises an organic phase which comprises a water-immiscible carrier.

In some embodiments, the organic phase is oil-organic solvent drops in water.

In some embodiments, the composition comprises at least one additional fungicide which is dissolved in a water-immiscible carrier.

In some embodiments, the composition comprises at least one additional fungicide which is suspended in a water carrier.

In some embodiments, the composition comprises at least two additional fungicides which are dissolved in the water-immiscible carrier.

In some embodiments, the composition comprises at least two additional fungicides wherein one is dissolved in a water-immiscible carrier and the other is suspended in the water carrier.

In some embodiments, the composition has viscosity in the range of 1500-1800 cPs (measured with a Brookfield spindle 63 at 12 rpm).

In some embodiments, the composition comprises particles with a particle size distribution (d90) is 10 microns or less. In some embodiments, the composition comprises particles with a particle size distribution (d90) is 7 microns or less. In some embodiments, the composition comprises particles with a particle size distribution (d90) of 4 microns or less.

In some embodiments, the composition has a pH in the range of 5.0-7.5.

In some embodiments, the composition has a density (g/ml) of 1.26=0.05 at 25° C.

A composition according to the invention preferably is in the form of a suspension concentrate (SC), a water dispersible granule (WG), a wettable powder (WP), a dispersion concentrate (DC), a dry powder seed treatment (DS), a water slurriable powder (WS), or a flowable seed treatment (FS), or a suspo-emulsion (SE). Preferably, a composition of the invention is in the form of a suspension concentrate, or in the form of water dispersible granules. A most preferred composition is a suspension concentrate or SE. In embodiments, the SE is a dispersion of solid particles and oil-organic solvent drops in water intended for dilution with water prior to use.

In some embodiments, the copper-based fungicide is suspended in water. In some embodiments, the additional fungicide(s) can be suspended and/or dissolved in a water-immiscible carrier

In some embodiments, the polyelectrolyte comprises at least one polyanion. In some embodiments, the polyelectrolyte is a polyanion. In some embodiments, the polyelectrolyte comprises a polycation and a polyanion. In some embodiments, the polyelectrolyte is a complex of polycation and polyanion.

In some embodiments, the weight ratio between the polyelectrolyte and the metallic copper in the copper-based fungicide in the combination and/or composition is between 1:10 to 1:1. In some embodiments, the weight ratio between the polyelectrolyte and the metallic copper in the copper-based fungicide in the combination and/or composition is between 1:1 and 1:7. In some embodiments, the weight ratio between the polyelectrolyte and the metallic copper in the copper-based fungicide in the combination and/or composition is between 1:1 and 1:5. In some embodiments, the weight ratio between the polyelectrolyte and the metallic copper in the copper-based fungicide in the combination and/or composition is between 1:3 and 1:5. In some embodiments, the weight ratio between the polyelectrolyte and the metallic copper in the copper-based fungicide in the combination and/or composition is 1:3.5. In some embodiments, the weight ratio between the polyelectrolyte and the metallic copper in the copper-based fungicide in the combination and/or composition is 1:4.4. In some embodiments, the weight ratio between the polyelectrolyte and the metallic copper in the copper-based fungicide in the combination and/or composition is between 1:10 to 1:1, more preferred in a ratio between 1:10 and 1:5, and more preferred at a ratio of 1:3.5.

In some embodiments, the polyelectrolyte comprises polycation and polyanion and the weight ratio between the polyelectrolyte and the metallic copper in the copper-based fungicide in the combination and/or composition described herein is in the range of 1:1 to 1:10.

In some embodiments, the polyelectrolyte comprises a polycation and a polyanion and the weight ratio between the polyelectrolyte and the metallic copper in the copper-based fungicide in the combination and/or composition described herein is 1:3.5.

In some embodiments, the polyelectrolyte comprises polyanion and the weight ratio between the polyelectrolyte and the metallic copper in the copper-based fungicide in the combination and/or composition described herein is 1:4.4.

In some embodiments, the polyelectrolyte comprises a polycation and a polyanion and the weight ratio between the polycation and polyanion is 1:5.

In some embodiments, the polyelectrolyte comprises a polycation and a polyanion and the weight ratio between the polycation and polyanion is 1:9.

In some embodiments, the polyelectrolyte and the copper has neutral zeta potential. In some embodiments, neutral zeta potential refers to =5 Mv. In some embodiments, the zeta potential is measured in absence of additional acceptable agricultural additives.

In some embodiments, the copper-based fungicide interacts with the polyelectrolyte by intermolecular, non-covalent interactions, preferably electrostatic interactions such as ionic interactions, hydrogen bonds and van der Waals forces, such as dipole-dipole interactions, between the polycation and the copper-based fungicide.

In some embodiments, the macromolecular complex is characterized by non-covalent intermolecular interactions, preferably ionic interaction and hydrogen bonds between donor and acceptor groups of the polycation and the copper-based fungicide.

In some embodiments, the copper-based fungicide and polyelectrolyte are interacted by non-covalent intermolecular interactions, preferably ionic interaction and hydrogen bonds between donor and acceptor groups of the polycation and the copper-based fungicide.

In some embodiments, the combination, macromolecular complex, and/or composition comprises more than 1 part of polyanion per 3 to 5 parts of the metallic copper-based fungicide by weight. In some embodiments, the combination, macromolecular complex, and/or composition comprises more than 1 part of polyanion per 3 parts of the metallic copper-based fungicide by weight. In some embodiments, the combination, macromolecular complex, and/or composition comprises more than 1 part of polyanion per 4 parts of the metallic copper-based fungicide by weight. In some embodiments, the combination, macromolecular complex, and/or composition comprises more than 1 part of polyanion per 5 parts of the metallic copper-based fungicide by weight.

In some embodiments, the batch of copper-based fungicide is a mixture of the copper-based fungicide and at least one additive. In some embodiments, the batch of copper-based fungicide is a mixture of the copper-based fungicide and a stabilizer. In some embodiments, the stabilizer is a polyanion. In some embodiments, the additive is a polyanion.

The concentration of a polyelectrolyte in the combination or composition according to the invention is preferably between 0.1 and 50 g/kg. In some embodiments, the concentration of the polyelectrolyte in the combination or composition is between 0.1 and 50 g/kg.

The concentration of the polyelectrolyte in the combination or composition according to the invention is preferably 0.01-5% by weight based on the total weight of the combination or composition, more preferably 0.1-4% by weight based on the total weight of the combination or composition, such as 2-3% by weight based on the total weight of the combination or composition. In some embodiments, the concentration of the polyelectrolyte in the combination or composition is 0.01-10% by weight based on the total weight of the combination or composition. In some embodiments, the concentration of the polyelectrolyte in the combination or composition is 0.1-5% by weight based on the total weight of the combination or composition. In some embodiments, the concentration of the polyelectrolyte in the combination or composition is 0.1-4% by weight based on the total weight of the combination or composition. In some embodiments, the concentration of the polyelectrolyte in the combination or composition is 0.1-3% by weight based on the total weight of the combination or composition. In some embodiments, the concentration of the polyelectrolyte in the combination or composition is about 2-3% by weight based on the total weight of the combination or composition. In some embodiments, the concentration of the polyelectrolyte in the combination or composition is about 3% by weight based on the total weight of the combination or composition. In some embodiments, the concentration of the polyelectrolyte in the combination or composition is 2.3% by weight based on the total weight of the combination or composition. In some embodiments, the concentration of the polyelectrolyte in the combination or composition is 2.8% by weight based on the total weight of the combination or composition.

In some embodiments, the polycation is chitosan. In some embodiments, the polyanion is lignosulfonate. In some embodiments, the lignosulfonate is calcium lignosulfonate.

In some embodiments, the concentration of calcium lignosulfonate in the composition is between 2% to 3% by weight based on the total weight of the composition. In some embodiments, the concentration of calcium lignosulfonate in the composition is about 2.3% by weight based on the total weight of the composition.

In some embodiments, the concentration of chitosan in the composition is between 0.1% to 1% by weight based on the total weight of the composition. In some embodiments, the concentration of chitosan in the composition is about 0.5% by weight based on the total weight of the composition.

In some embodiments, the composition is substantially free or free of polycation. In some embodiments, the macromolecular complex is substantially free or free of polycation. In some embodiments, the composition is substantially free or free of chitosan. In some embodiments, macromolecular complex is substantially free or free of chitosan.

As used herein, “substantially free” refers to a concentration less than 0.1% w/w, preferably less than 0.05% w/w, more preferably less than 0.01% w/w.

In some embodiments, the composition comprises a polyanion and a polycation. In some embodiments, the macromolecular complex comprises a polyanion and a polycation. In some embodiments, the polyelectrolyte comprises a polyanion and a polycation. In some embodiments, the composition comprises lignosulfonate and chitosan. In some embodiments, the macromolecular complex comprises lignosulfonate and chitosan. In some embodiments, the polyelectrolyte is a complex of lignosulfonate and chitosan.

In some embodiments, the combined weight of lignosulfonate and chitosan in the composition is between 1% to 10% by weight based on the total weight of the composition. In some embodiments, the combined weight of lignosulfonate and chitosan in the composition is between 1% to 5% by weight based on the total weight of the composition. In some embodiments, the combined weight of lignosulfonate and chitosan in the composition is between 2% to 3% by weight based on the total weight of the composition. In some embodiments, the combined weight of lignosulfonate and chitosan in the composition is 2.8% by weight based on the total weight of the composition.

In some embodiments, the copper-based fungicide is added to the composition in the form of a formulation.

In some embodiments, the concentration of the copper-based fungicide is up to 25% by weight based on the total weight of the composition. In some embodiments, the concentration of the copper-based fungicide is up to 10% by weight based on the total weight of the composition. In some embodiments, the concentration of the copper-based fungicide in the composition is between 100 and 250 g/L. In some embodiments, the concentration of the copper-based fungicide in the composition is 110 g/L.

In some embodiments, the concentration of the copper-based fungicide is more than 25% by weight based on the total weight of the composition. In some embodiments, the concentration of the copper-based fungicide is more than 25% by weight based on the total weight of the composition. In some embodiments, the concentration of the copper-based fungicide in the composition is more than 30% by weight based on the total weight of the composition.

In some embodiments, the concentration of the metallic copper in the formulation comprising the copper-based fungicide is between 10 g/L to 250 g/L. In some embodiments, the concentration of the metallic copper in the formulation comprising the copper-based fungicide is between 50 g/L to 150 g/L. In some embodiments, the concentration of the metallic copper in the formulation comprising the copper-based fungicide is 100 g/L.

In some embodiments, the concentration of the metallic copper in the formulation comprising the copper-based fungicide is 1-25% by weight based on the total weight of the formulation. In some embodiments, the concentration of the metallic copper in the formulation comprising the copper-based fungicide is 5-25% by weight based on the total weight of the formulation. In some embodiments, the concentration of the metallic copper in the formulation comprising the copper-based fungicide is 5-15% by weight based on the total weight of the formulation. In some embodiments, the concentration of the metallic copper in the formulation comprising the copper-based fungicide is about 10% by weight based on the total weight of the formulation. In some embodiments, the concentration of the metallic copper in the formulation comprising the copper-based fungicide is 10.1% by weight based on the total weight of the formulation.

In some embodiments, the concentration of the metallic copper in the formulation comprising the copper-based fungicide is up to 25% by weight based on the total weight of the formulation. In some embodiments, the concentration of the metallic copper in the formulation comprising the copper-based fungicide is 10% by weight based on the total weight of the formulation.

In some embodiments, the concentration of the metallic copper in the formulation comprising the copper-based fungicide is between 100 and 250 g/L, preferably 110 g/L.

In some embodiments, the concentration of copper-based fungicide in the formulation is between 15% to 45% by weight based on the total weight of the formulation. In some embodiments, the concentration of copper-based fungicide in the formulation is between 20% to 35% by weight based on the total weight of the formulation. In some embodiments, the concentration of copper-based fungicide in the formulation is between 25% to 30% by weight based on the total weight of the formulation. In some embodiments, the concentration of copper-based fungicide in the formulation is 28.8% by weight based on the total weight of the formulation.

In some embodiments, the concentration of the formulation comprising the copper-based fungicide in the composition is between 150 and 500 g/L. In some embodiments, the concentration of the formulation comprising the copper-based fungicide in the composition is between 300 g/L to 400 g/L. In some embodiments, the concentration of the formulation comprising the copper-based fungicide in the composition is 345 g/L.

In some embodiments, the concentration of the metallic copper in the composition is 0.1% to 10% by weight based on the total weight of the composition. In some embodiments, the concentration of the metallic copper in the composition is 0.5% to 5% by weight based on the total weight of the composition. In some embodiments, the concentration of the metallic copper in the composition is 2% to 3% by weight based on the total weight of the composition. In some embodiments, the concentration of the metallic copper in the composition is 2.9% by weight based on the total weight of the composition.

In some embodiments, the copper-based fungicide is copper sulfate. In some embodiments, the copper-based fungicide is copper oxychloride. In some embodiments, the copper-based fungicide is copper hydroxide.

The addition of an additive affects the chemically and physically stability of the compositions. Said additives may, for example, improve the stability of the composition.

In some embodiments, the agriculturally acceptable additive is selected from agriculturally acceptable carriers, buffers, acidifiers, antifoaming agents, anti-freeze agents, solvents, co-solvents, stabilizers, light stabilizers, UV absorbers, radical scavengers and antioxidants, adhesives, neutralizers, thickeners, binders, sequestrates, biocides, drift retardants, surfactants, dispersants, pigments, wetting agents, safeners, and preservatives. Said additives include, but are not limited to, surfactants, pigments, wetting agents, as well as safeners, or such preservatives as bacteriostats or bactericides.

In some embodiments, the agriculturally acceptable additive is an agriculturally acceptable carrier. In some embodiments, the composition comprises at least one agriculturally acceptable carrier.

The addition of small amounts of one or more agriculturally acceptable additives may affect parameters such as stability, efficacy and/or rainfastness of a composition according to the invention. The addition of small amounts of one or more agriculturally acceptable carriers preferably increases stability, efficacy and/or rainfastness of a composition according to the invention.

In some embodiments, the agriculturally acceptable carrier is water.

In some embodiments, the composition comprises 40-80% by weight of water. In some embodiments, the composition comprises 50-70% by weight of water. In some embodiments, the composition comprises 50-55% by weight of water. In some embodiments, the composition comprises about 52% by weight of water. In some embodiments, the composition comprises about 53% by weight of water. In some embodiments, the composition comprises about 54% by weight of water. In some embodiments, the composition comprises about 55% by weight of water.

In some embodiments, the composition is an aqueous composition.

The present invention also provides an aqueous composition comprising any one or any combination of the combination and/or macromolecular complexes described herein, water and agriculturally acceptable additive.

In some embodiments, the concentration of the metallic copper in the copper-based fungicide in the aqueous composition is 10.1% by weight based on the total weight of the composition and the composition further comprises a stabilizer.

In some embodiments, the additive refers to surfactant.

In some embodiments, the surfactant is a wetting agent, dispersant, or a combination thereof.

In some embodiments, the dispersant is an anionic polymeric surfactant such as Metasperse 500L.

In some embodiments, the dispersant is an anionic surfactant such as Tensiofix LB350.

In some embodiments, the dispersant is a nonionic surfactant such as Tensiofix L051. In some embodiments, the dispersant is an anionic surfactant such as ECOSURF™ EH-6. In some embodiments, the dispersant is an anionic tristyrylphenol phosphate surfactant such as Soprophor FL or Soprophor® 3 D 33. In some embodiments, the dispersant is a nonionic surfactant such as TERGITOL™ XD. In some embodiments, the dispersant is a nonionic surfactant such as Atlox™ 4913.

In some embodiments, the dispersant is a mixture of anionic and nonionic surfactants such as Tensiofix CGA213.

In some embodiments, the dispersant is polyelectrolyte block copolymer (as described in WO2017/098325).

In some embodiments, the dispersing agent is a block polymer comprises 77% of sodium 2-acryloylamino-2-methylpropane-1-sulfonate (AMPS) monomers and 23% of the ethyl acrylate (EA) monomers.

In some embodiments, the dispersing agent is a water solution of 30% by weight solution of a block polymer comprising 77% of sodium 2-acryloylamino-2-methylpropane-1-sulfonate (AMPS) monomers and 23% of ethyl acrylate (EA) monomers, which may be prepared as described in Example 1 of WO2017/098325.

In some embodiment, the dispersant is Geropon® T-77.

In some embodiment, when the composition is suspoemulsion, the dispersant is Geropon T-77.

In some embodiments, the wetting agent is a high HLB polymeric wetting agent such as Atlas G65002L.

In some embodiments, high HLB is more than 10. In some embodiments, high HLB is more than 12. In some embodiments, high HLB is more than 13. In some embodiments, high HLB is more than 14.

In some embodiments, the high HLB of the nonionic polyalkylene oxide block polymer surfactant is more than 10. In some embodiments, the high HLB of the nonionic polyalkylene oxide block polymer surfactant is more than 12. In some embodiments, the high HLB of the nonionic polyalkylene oxide block polymer surfactant is more than 13. In some embodiments, the high HLB of the nonionic polyalkylene oxide block polymer surfactant is more than 14.

In some embodiments the wetting agent is Adsee 900 a decyl alcohol ethoxylate.

In some embodiments, the composition further comprises a stabilizer.

In some embodiments, the concentration of the metallic copper in the copper-based fungicide in the aqueous composition is more than 10% by weight based on the total weight of the composition, the dispersant is the anionic polymeric surfactant Metasperse 500L, the anionic surfactant Tensiofix LB350, the anionic surfactant ECOSURF™ EH-6, the anionic tristyrylphenol phosphate surfactant Soprophor FL or Soprophor® 3 D 33, the nonionic surfactant such as TERGITOL™ XD, the nonionic surfactant Atlox™ 4913, or the nonionic surfactant Tensiofix L051. The wetting agent is the high HLB polymeric wetting agent Atlas G65002L, and the composition further comprises a stabilizer.

In some embodiments, the concentration of metallic copper in the copper-based fungicide in the aqueous composition is more than 10% by weight based on the total weight of the composition, the surfactant is a combination of anionic and nonionic surfactants like Tensiofix CGA213 or TERGITOL™ XD.

The present invention also provides an aqueous composition comprising (1) macromolecular complex comprising (i) a copper-based fungicide and (ii) a polyelectrolyte, (2) water, and (3) at least one agriculturally acceptable additive, wherein (i) the viscosity is in the range of 1500-1800 cPs (measured with a Brookfield spindle 63 at 12 rpm), (ii) the particle size distribution (d90) is below 4 microns, (iii) the pH in the range of 5.0-7.5, and/or (iv) the density (g/ml) at 25° C. is 1.26=0.05.

In some embodiments, the viscosity is measured with a Brookfield spindle 63 at 12 rpm.

In some embodiments, the viscosity in the composition is in the range of 1500-1800 cPs (measured with a Brookfield spindle 63 at 12 rpm).

In some embodiments, the particle size distribution (d90) in the composition is below 10 microns and the particle size distribution (d50) is below 5 microns.

In some embodiments, the pH in the composition is in the range of 5.0-7.5.

In some embodiments, the density (g/ml) of the composition at 25° C. is 1.26=0.05.

In some embodiments, the agriculturally acceptable additive is a dispersant. In some embodiments, the composition comprises at least one dispersant.

In some embodiments the composition comprising at least one anionic dispersant and at least one non-ionic surfactant.

A composition of the invention may also comprise two or more different dispersants. A dispersant is preferably present in an amount of between 0 to up to 10% (w/v), more preferred between 0.01 to up to 5% (w/v), more preferred between 0.02 to up to 2% (w/v),

In some embodiments, the dispersant is a modified acrylic polymer, non-modified acrylic acid, or any combination thereof.

In some embodiments, the modified acrylic polymer is modified styrene acrylic acid, polymethyl methacrylate-polyethylene glycol graft copolymer or any combination thereof. In some embodiments, modified acrylic polymer is modified styrene acrylic polymer. In some embodiments, the modified styrene acrylic polymer is Atlox Metasperse™ 500L (sold by Croda). In some embodiments, the modified acrylic polymer is polymethyl methacrylate-polyethylene glycol graft copolymer.

In some embodiments, the concentration of the dispersant in the composition is 0.01-15% by weight based on the total weight of the composition.

In some embodiments, the concentration of the dispersant in the composition is 0.01-12% by weight based on the total weight of the composition. In some embodiments, the concentration of the dispersant in the composition is 1-12% by weight based on the total weight of the composition. In some embodiments, the concentration of the dispersant in the composition is 0.01-10% by weight based on the total weight of the composition. In some embodiments, the concentration of the dispersant in the composition is 1-5% by weight based on the total weight of the composition. In some embodiments, the concentration of the dispersant in the composition is 5-10% by weight based on the total weight of the composition. In some embodiments, the concentration of the dispersant is about 2% by weight based on the total weight of the composition. In some embodiments, the concentration of the dispersant is about 5% by weight based on the total weight of the composition. In some embodiments, the concentration of the dispersant is about 6% by weight based on the total weight of the composition. In some embodiments, the concentration of the dispersant is about 7% by weight based on the total weight of the composition. In some embodiments, the concentration of the dispersant is about 8% by weight based on the total weight of the composition. In some embodiments, the concentration of the dispersant is about 9% by weight based on the total weight of the composition. In some embodiments, the concentration of the dispersant is about 10% by weight based on the total weight of the composition.

A composition according to the invention may further comprise at least one pH adjuster or buffering agent such as organic or inorganic bases and/or organic or inorganic acids.

In some embodiments, the composition comprises one or more physical stabilizers such as buffers, acidifiers, defoaming agents, thickeners, and drift retardants.

In some embodiments, the composition comprises at least one stabilizer. In some embodiments, the agriculturally acceptable additive is a stabilizer.

When polyelectrolyte is complex of polyanion and polycation, a stabilizer, may be used. A stabilizer, when present, is preferably selected from carboxylic acids such as citric acid, acetic acid, and/or dodecylbenzensulfonic acid, orthophosphoric acid dodecylbenzensulfonic acid and suitable salts thereof. A composition of the invention may also comprise two or more different stabilizers. A stabilizer is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the stabilizer is an acid. In some embodiments, the acid is acetic acid. Acids are used to obtains dissolution of some polyelectrolyte. For example, chitosan is an aminoglycan consisting of beta-(1right4)-linked D-glucosamine residues. In acidic environment, global protonation of the 2-amino groups creates cationic chitosan.

In some embodiments, the concentration of the acid in the composition is 0-5% by weight based on the total weight of the composition. In some embodiments, the concentration of the acid in the composition is 0.01-5% by weight based on the total weight of the composition. In some embodiments, the concentration of the acid in the composition is 0.1-0.5% by weight based on the total weight of the composition. In some embodiments, the concentration of the acid in the composition is about 0.3% by weight based on the total weight of the composition. In some embodiments, the concentration of the acid in the composition is 1-3% by weight based on the total weight of the composition. In some embodiments, the concentration of the acid in the composition is 1.5-2% by weight based on the total weight of the composition. In some embodiments, the composition comprises at least one anti-foam agent. In some embodiments, the agriculturally acceptable additive is an anti-foam agent.

In some embodiments, the composition comprises at least one anti-foaming agent. In some embodiments, the agriculturally acceptable additive is an anti-foaming agent. An anti-foam agent, when present, is preferably selected from polymethylsiloxane, polydimethylsiloxane, simethicone octanol, and silicone oils. A composition of the invention may also comprise two or more different anti-foam agents. An anti-foam agent is preferably present in an amount of between 0 to up to 10% (w/v), more preferred between 0.05 to up to 5% (w/v), more preferred between 0.1 to up to 1% (w/v), more preferred about 0.05% (w/v).

In some embodiments, the anti-foam agent is silicone-based.

In some embodiments, the concentration of the anti-foam forming agent is 0.01-5% by weight based on the total weight of the composition. In some embodiments, the concentration of the anti-foam forming agent is 0.1-1% by weight based on the total weight of the composition. In some embodiments, the concentration of the anti-foam forming agent is about 0.4% by weight based on the total weight of the composition. In some embodiments, the concentration of the anti-foam forming agent is about 0.5% by weight based on the total weight of the composition.

In some embodiments, the composition comprises at least one antifreezing agent. In some embodiments, the agriculturally acceptable additive is an antifreezing agent.

An antifreezing agent (or “antifreeze”), when present, is preferably selected from glycerine, ethylene glycol, hexyleneglycol and propylene glycol. A composition of the invention may also comprise two or more different antifreezing agents. An antifreezing agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the antifreezing agent is propylene glycol.

In some embodiments, the concentration of the antifreezing agent in the composition is 1-10% by weight based on the total weight of the composition. In some embodiments, the concentration of the antifreezing agent in the composition is 1-5% by weight based on the total weight of the composition. In some embodiments, the concentration of the antifreezing agent in the composition is about 4% by weight based on the total weight of the composition. In some embodiments, the concentration of the antifreezing agent in the composition is about 5% by weight based on the total weight of the composition. In some embodiments, the concentration of the antifreezing agent in the composition is 4.2% by weight based on the total weight of the composition.

In some embodiments, the composition comprises at least one surfactant. In some embodiments, the agriculturally acceptable additive is a surfactant.

Surfactants may include but are not limited to ionic or non-ionic surface active agents. Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

Examples of surfactants include but is not limited to emulsifiers and wetting agents.

In some embodiments, the surfactant is a non-ionic surfactant. In some embodiments, the non-ionic surfactant is Tensiofix L051. In some embodiments, the concentration of non-ionic surfactant in the composition is between 0.1% to 0.5% by weight based on the total weight of the composition. In some embodiments, the concentration of non-ionic surfactant in the composition is about 0.2% by weight based on the total weight of the composition.

In some embodiments, the surfactant is an anionic surfactant. In some embodiments, the anionic surfactant is Tensiofix LB350. In some embodiments the anionic surfactant is a tristyrylphenol phosphate surfactant. In some embodiments the tristyrylphenol phosphate surfactant is Soprophor FL or Soprophor® 3 D 33. In some embodiments, the concentration of anionic surfactant in the composition is between 1% to 3% by weight based on the total weight of the composition. In some embodiments, the concentration of anionic surfactant in the composition is about 2% by weight based on the total weight of the composition.

In some embodiments, the surfactant is a combination of anionic and non-ionic surfactants. In some embodiments, the surfactant is Tensiofix CGA213. In some embodiments, the concentration of the surfactant containing a combination of anionic and non-ionic surfactants in the composition is between 0.1% to 2% by weight based on the total weight of the composition. In some embodiments, the concentration of the surfactant containing a combination of anionic and non-ionic surfactants in the composition is about 1% by weight based on the total weight of the composition.

In some embodiments, the concentration of the surfactant in the composition is 0-0.5% by weight based on the total weight of the composition. In some embodiments, the concentration of the surfactant in the composition is 0.001-0.5% by weight based on the total weight of the composition. In some embodiments, the concentration of the surfactant in the composition is 0.01-1% by weight based on the total weight of the composition. In some embodiments, the concentration of the surfactant in the composition is about 0.1% by weight based on the total weight of the composition.

In some embodiments, the surfactant is a non-ionic hydrocarbon-based surfactant.

In some embodiments, the concentration of the non-ionic hydrocarbon-based surfactant in the composition is 0.001-0.5% by weight based on the total weight of the composition. In some embodiments, the concentration of the non-ionic hydrocarbon-based surfactant in the composition is about 0.1% by weight based on the total weight of the composition. In some embodiments, the concentration of the non-ionic hydrocarbon-based surfactant in the composition is 0.001-0.1% by weight based on the total weight of the composition.

In some embodiments, the total concentration of the surfactant(s) in the composition is 2-5% w/w by weight based on the total weight of the total composition. In some embodiments, the total concentration of the surfactant(s) in the composition is 3-4% w/w by weight based on the total weight of the total composition. In some embodiments, the total concentration of the surfactant(s) in the composition is about 3.2% w/w by weight based on the total weight of the total composition.

In some embodiments, when the polyelectrolyte is a complex with chitosan, the composition further comprises a co-solvent. In some embodiments, the co-solvent is an antifreeze agent. In some embodiments, the co-solvent is propylene glycol. In some embodiments, the antifreeze agent is propylene glycol.

In some embodiments, wherein the composition comprises at least one wetting agent. In some embodiments, the agriculturally acceptable additive is a wetting agent.

Wetting agent can be selected from di-octylsuccinate, polyoxyethylene/polypropylene, a decyl alcohol ethoxylate and tri-stearyl sulphonate/phosphate. A composition of the invention may also comprise two or more different wetting agents. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the wetting agent is polyalkylene oxide block copolymer. In some embodiments, the wetting agent is butyl block copolymer. In some embodiments, the butyl block copolymer is Atlas™ G5002L (sold by Croda). In some embodiments the wetting agent is Adsee 900, a decyl alcohol ethoxylate.

In some embodiments, the concentration of the wetting agent in the composition is 1-10% by weight based on the total weight of the composition. In some embodiments, the concentration of the wetting agent in the composition is 0-5% by weight based on the total weight of the composition. In some embodiments, the concentration of the wetting agent in the composition is 1-5% by weight based on the total weight of the composition. In some embodiments, the concentration of the wetting agent in the composition is 1-3% by weight based on the total weight of the composition. In some embodiments, the concentration of the wetting agent in the composition is about 2% by weight based on the total weight of the composition.

In some embodiments, the composition comprises at least one rheology modifier. In some embodiments, the agriculturally acceptable additive is a rheology modifier.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidized starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the thickener is xanthan gum.

In some embodiments, the rheology modifier is Rhodopol® 23 (sold by Solvay). In some embodiments, the rheology modifier is xanthan gum.

In some embodiments, the concentration of the rheology modifier in the composition is 0.01-10% by weight based on the total weight of the composition. In some embodiments, the concentration of the rheology modifier in the composition is 5-10% by weight based on the total weight of the composition. In some embodiments, the concentration of the rheology modifier in the composition is about 6% by weight based on the total weight of the composition. In some embodiments, the concentration of the rheology modifier in the composition is about 8% by weight based on the total weight of the composition.

In some embodiments, the composition comprises at least one thickener and at least one biocide. In some embodiments, the amount of the thickener and the biocide in the composition is up to 1% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide. In some embodiments, the preservative is Acticide® MBS.

In some embodiments, the concentration of the preservative in the composition is 0.01-5% by weight based on the total weight of the composition. In some embodiments, the concentration of the preservative in the composition is 0.01-1% by weight based on the total weight of the composition. In some embodiments, the concentration of the preservative in the composition is about 0.1% by weight based on the total weight of the composition. In some embodiments, the concentration of the preservative in the composition is 0.083% by weight based on the total weight of the composition.

A composition according to the invention may comprise an additional bioactive ingredient, also termed additional agrochemical, such as a growth regulator, a bio-stimulant, a fungicide, a herbicide, an insecticide, an acaricide, a molluscicide, a miticide, a rodenticide; and/or an bactericide.

Various agrochemicals may be used as additional bioactive ingredient. Exemplary among such agrochemicals without limitation are crop protection agents, for example pesticides, safeners, plant growth regulators, repellents, bio-stimulants, and preservatives such as bacteriostats or bactericides.

In some embodiments, the composition comprises at least one additional bioactive ingredient, preferably an additional insecticide, fungicide and/or herbicide.

Additional agrochemicals that may be used with the combination, composition and macromolecular complex of the present invention are described below.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is an insecticide, a fungicide and/or an herbicide.

A preferred additional insecticide is a carbamate such as carbofuran, propoxur, methomyl, bendiocarb, formetanate, oxamyl, and aldicarb, an organochlorine such as methoxychlor, kelthane, lindane, toxaphene, and cyclodiene insecticides such as aldrin, dieldrin, endrin, mirex, chlordane, heptachlor, and endosulfan, an organophosphate such as parathion, malathion, methyl parathion, chlorpyrifos, diazinon, dichlorvos, phosmet, fenitrothion, tetrachlorvinphos, azamethiphos, azinphos-methyl, and terbufos, a formamidine such as amitraz, chlordimeform, formetanate, formparanate, medimeform, and semiamitraz, an organosulfur such as dipymetitrone, an avermectin such as ivermectin, doramectin, selamectin, milbemycin oxime and moxidectin, a neonicotinoid such as acetamiprid, clothianidine, imidacloprid, nitenpyram, nithiazine, thiacloprid and thiamethoxam and/or a pyrethroid insecticide such as allethrin, bifenthrin, cyfluthrin, cypermethrin, cyphenothrin, deltamethrin, esfenvalerate, etofenprox, fenpropathrin, fenvalerate, flucythrinate, flumethrin, fmiprothrin, lambda-cyhalothrin, metofluthrin, permethrin, resmethrin, silafluofen, sumithrin, tau-fluvalinate, tefluthrin, tetramethrin, tralomethrin, and transfluthrin.

A preferred additional fungicide is selected from mancozeb, sodium ortho-phenylphenate, 2-phenylphenol; 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example, (RS)-1-(β-allyloxy-2,4-dichlorophenethyl) imidazole (imazalil; Janssen Pharmaceutica NV, Belgium) and N-propyl-N-[2-(2,4,6-trichlorophenoxy)ethyl] imidazole-1-carboxamide (prochloraz); cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; fluopicolide; flurprimidol; flusulfamide; flutolanil; folpet (N-(trichloromethylthio) phthalimide); fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; mandipropamid, meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-.alph-a.-(methoxymethylene) benzeneacetate; methyl 2-[2-[3-(4-chlorophenyl)-1-methyl-allylideneaminooxymethyl]phenyl]-3-meth-oxyacrylate; metiram; metominostrobin; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl)cyclopropanecarboxamide; a polyene fungicide such as natamcyin; N-butyl-8-(1,1-dimethylethyl)-1-oxaspiro[4.5]decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phosphite salts such as disodium phosphite and potassium phosphite, phthalide; picobenzamid; picoxystrobin; piperalin; polyoxins; polyoxorim; procymidone; propamocarb; propanosine-sodium; propineb; proquinazid; prothioconazole; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicyofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)—N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl) sulphonyl]-N,N-dimethyl-1H-1,-2,4-triazole-1-sulphonamide, and/or mixtures thereof.

In some embodiments, the additional fungicide is natamycin. A composition of the invention may also comprise two or more additional fungicides, such as, for example, natamycin and a strobilurin type of fungicides such as azoxystrobin, picoxystrobin, natamycin and a triazole type of fungicides such as cyproconazole, prothioconazole, natamycin and a succinate dehydrogenase inhibitor type of fungicides such as boscalid, natamycin and a pthalimide/pthalonitrile type of fungicide such as chlorothalonil, natamycin and captan, natamycin and a benzimidazole type of fungicide such as thiabendazole, natamycin and a carbamate type of fungicides such as propamocarb, natamycin and a carboxamide type of fungicides such as fenoxanil, natamycin and a dicarboxamide type of fungicide such as iprodione, natamycin and a morpholine type of fungicide such as dimethamorph, natamycin and an organophosphate type of fungicide such as fosetyl, natamycin and an azole type of fungicide such as prothioconazole, a benzamide type of fungicide (such as fluopicolide), natamycin and a phenylamide type of fungicide such as metalaxyl, natamycin and a fungicide not belonging to a specific group of fungicides such as fludioxynil and/or folpet.

A preferred additional herbicide is selected from an inhibitor of amino acid synthesis such as inhibitors of 5-enolpyruvyl-shikimate-3-phosphate synthase, acetolactate synthase and glutamine synthetase such as a glyphosate, a sulfonylurea, an imidazolinone, a glufosinate and/or a 1,2,4-triazol [1,5A] pyrimidine; a photosynthetic inhibitor that binds D-1: quinone-binding protein, including anilides, benzimidazoles, biscarbamates, pyridazinones, triazinediones, triazines, triazinones, uracils, substituted ureas, quinones, hydroxybenzonitriles, and several unclassified heterocycles; inhibitors of acetyl-CoA carboxylase such as aryloxyphenoxy alkanoic acids and cyclohexanediones; inhibitors of cellular division such as phosphoric amide and dinitroaniline; inhibitors of the terpenoid synthesis pathway such as substituted pyridazinones, m-phenoxybenzamides, fluridone, difunone, 4-hydroxypyridine, aminotriazole amitrole, 6-methyl pyrimidine, isoxazolidinone; inhibitors of dihydropteroate synthase such as asulam, and/or mixtures thereof.

Such preferred additional herbicide is preferably selected from benzobicyclon, mesotrione, sulcotrione, tefuryltrione, tembotrione, 2,4-dichlorophenoxyacetic acid, 3,6-dichloro-2-methoxybenzoic acid (dicamba), 4-hydroxy-3-[[2-(2-methoxyethoxy)methyl]-6-(trifluoromethyl)-3-pyridinyl]carbonyl]-bicyclo[3.2.1]-oct-3-en-2-one (bicyclopyrone), ketospiradox or the free acid thereof, benzofenap, pyrasulfotole, pyrazolynate, pyrazoxyfen, topramezone, [2-chloro-3-(2-methoxyethoxy)-4-(methylsulfonyl)phenyl](1-ethyl-5-hydroxy-1H-pyrazol-4-yl)-methanone, (2,3-dihydro-3,3,4-trimethyl-1,1-dioxidobenzo[b]thien-5-yl) (5-hydroxy-1-methyl-1H-pyrazol-4-yl)-methanone, isoxachlortole, isoxaflutole, a-(cyclopropylcarbonyl)-2-(methylsulfonyl)-oxo-4-chloro-benzenepropanenitrile, and a-(cyclopropylcarbonyl)-2-(methylsulfonyl)-oxo-4-(trifluoromethyl)-benzenepropanenitrile.

Preferred additional fungicides are strobilurin fungicide and azole fungicides.

Strobilurin fungicide may be, but is not limited to, picoxystrobin, azoxystrobin or a combination thereof.

Azole fungicide may be, but is not limited to, tebuconazole, prothioconazole, or a combination thereof.

In some embodiments, benzamide fungicide is fluopicolide,

In some embodiments, when one or more additional fungicides are added to the composition, the dispersant a mixture of anionic tristyrylphenol phosphate surfactants (such as Soprophor FL or Soprophor 3D33) and a high HLB nonionic polyalkylene oxide block polymer surfactant (such as Atlas G5002L) or nonionic alcohol ethoxylate (such as ECOSURF EH6).

In some embodiments, the combination, composition and macromolecular complex of the present invention is combined with two additional fungicides. In some embodiments, the combination, composition and macromolecular complex of the present invention is combined with picoxystrobin and tebuconazole. In some embodiments, the combination, composition and macromolecular complex is combined with picoxystrobin and tebuconazole. In some embodiments, the combination, composition and macromolecular complex is combined with prothioconazole. In some embodiments, the combination, composition and macromolecular complex is combined with picoxystrobin and prothioconazole. In some embodiments, the combination, composition, and macromolecular complex is combined with fluopicolide.

In some embodiments, the combination, composition and macromolecular complex is combined with azoles and carboxamides. In some embodiments, the carboxamide is fluxapyroxad.

In some embodiments, the combination, composition and macromolecular complex is combined with morpholines. In some embodiments, the morpholine is fenpropidin.

In some embodiments, the composition comprising copper-based fungicide and polyelectrolyte further comprises picoxystrobin and tebuconazole. In some embodiments, the composition comprising copper-based fungicide and polyelectrolyte further comprises prothioconazole. In some embodiments, the composition comprising copper-based fungicide and polyelectrolyte further comprises picoxystrobin and prothioconazole. In some embodiments, the composition comprising copper-based fungicide and polyelectrolyte further comprises fluopicolide.

In some embodiments, the polyelectrolyte comprises at least one polyanion. In some embodiments, the polyelectrolyte is a polyanion. In some embodiments, the polyelectrolyte comprises a polycation and a polyanion. In some embodiments, the polyelectrolyte is a complex of a polycation and a polyanion.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is an insecticide, a fungicide and/or an herbicide.

In some embodiments, the additional bioactive ingredient is an azole fungicide.

In some embodiments, the additional bioactive ingredients are an azole fungicide and a strobilurin fungicide. In some embodiments, the strobilurin fungicide is picoxystrobin. In some embodiments, the azole fungicide is prothioconazole.

In some embodiments, the additional bioactive ingredients are an azole fungicide and a carboxamide fungicide. In some embodiments, the carboxamide fungicide is fluxapyroxad.

In some embodiments, the additional bioactive ingredient is a benzamide fungicide. In some embodiments, the benzamide fungicide is fluopicolide.

In some embodiments, the additional bioactive ingredients are an azole fungicide and a morpholine fungicide. In some embodiments, the morpholine fungicide is fenpropidin.

In some embodiments, the copper-based fungicide used in combination with the azole fungicide, strobilurin fungicide, carboxamide fungicide and/or morpholine fungicide is copper oxychloride, copper hydroxide, copper sulfate, cupric acetate, cupric chloride, cupric chlorate, cupric formate, cupric hexafluorosilicate, cupric nitrate, cupric chromate, copper sulfate pentahydrate, Bordeaux mixture and/or any combination thereof.

In some embodiments, the composition is substantially free of an agriculturally acceptable organic solvent. In some embodiments, the composition is aqueous.

In some embodiments, the composition is a suspension concentrate.

In some embodiments, the suspension concentrate composition comprises:

The present invention provides a concentrate composition comprising (1) a copper-based fungicide, (2) a polyelectrolyte, and (3) an aqueous carrier.

The present invention also provides a suspension concentrate comprising (1) a copper-based fungicide, (2) a polyelectrolyte, and (3) an aqueous carrier.

The present invention provides a concentrate composition comprising a (1) a macromolecular complex comprising (i) a copper-based fungicide and (ii) a polyelectrolyte, and (2) an aqueous carrier.

The present invention also provides a suspension concentrate comprising (1) a macromolecular complex comprising (i) a copper-based fungicide and (ii) a polyelectrolyte, and (2) an aqueous carrier.

The present invention provides a composition comprising (i) macromolecular complex comprising copper-based fungicide and polyelectrolyte, (ii) at least one additional fungicide and (iii) at least one agriculturally acceptable additive.

The present invention provides a composition comprising copper-based fungicide and polyelectrolyte.

The present invention provides a composition comprising (i) copper-based fungicide (ii) polyelectrolyte, (iii) at least one additional fungicide and (iv) at least one agriculturally acceptable additive.

In some embodiments, the composition comprises 40-80% by weight of water. In some embodiments, the composition comprises 50-70% by weight of water. In some embodiments, the composition comprises 50-55% by weight of water. In some embodiments, the composition comprises 40-80% by weight of water. In some embodiments, the composition comprises about 51% by weight of water. In some embodiments, the composition comprises about 62% by weight of water. In some embodiments, the composition comprises 30-50% by weight of water. In some embodiments, the composition comprises 30-60% by weight of water. In some embodiments, the composition comprises 30-80% by weight of water.

In some embodiments, the additional fungicide is selected from the group consisting of azole fungicides, strobilurin fungicides, benzamide fungicide, morpholines, QiI fungicide, SDHI and any combination thereof.

In some embodiments, the azole fungicide is triazole fungicide.

In some embodiments, azole fungicide may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole and prothioconazole, Mefentrifluconazole . . .

In some embodiments, strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, metyltetraprole and fluoxastrobin.

In some embodiments, the strobilurin fungicide is selected from group consisting of picoxystrobin, trifloxystrobin, azoxystrobin, pyraclostrobin, metominostrobin, metyltetraprole, mandestrobin and a combination thereof.

In some embodiments, the SDHI may include but is not limited to penthiopyrad, boscalid, flutolanil, fluxapyroxad, inpyrfluxam, fluopyram, fluindapyr, benzodiflupyr, bixafen and pydiflumetofen

In some embodiments, the SDHI fungicide is selected from group consisting of bixafen; fluxapyroxad, fluindapyr; inpyrfluxam, benzodiflupyr and pydiflumetofen.

In some embodiments, QiI fungicide may include but is not limited to cyazofamid, amisulbrom and fenpicoxamid.

In some embodiments, Morpholines may include but is not limited to aldimorph, fenpropimorph, ridemorph, dodemorph, spiroxamine, piperalin, fenpropidin.

In a preferred embodiment, the subject matter relates to a composition comprising: a) copper-based fungicide, prothioconazole and picoxystrobin suspended in the water.

In another preferred embodiment, the subject matter relates to a composition comprising: a) the copper-based fungicide and picoxystrobin are suspended in water; and b) the prothioconazole dissolved in the water-immiscible carrier.

In preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is picoxystrobin (3) the azole fungicide is prothioconazole (4) the copper based fungicide and strobilurin are suspended in the water and (5) the azole is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is picoxystrobin (3) the azole fungicide is prothioconazole (4) the copper based fungicide and strobilurin are suspended in the water and (5) the azole fungicide is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is picoxystrobin (3) the azole fungicide is tebuconazole (4) the copper based fungicide and strobilurin are suspended in the water and (5) the azole fungicide is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is picoxystrobin (3) the azole fungicide is tebuconazole (4) the copper based fungicide and strobilurin are suspended in the water and (5) the azole fungicide is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is azoxystrobin (3) the azole fungicide is prothioconazole (4) the copper based fungicide and strobilurin are suspended in the water and (5) the azole fungicide is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is azoxystrobin (3) the azole fungicide is prothioconazole (4) the copper based fungicide and strobilurin are suspended in the water and (5) the azole fungicide is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is azoxystrobin (3) the azole fungicide is tebuconazole (4) the copper based fungicide and strobilurin are suspended in the water and (5) the azole fungicide is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is azoxystrobin (3) the azole fungicide is tebuconazole (4) the copper based fungicide and strobilurin are suspended in the water and (5) the azole fungicide is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is picoxystrobin which (3) the azole fungicide is prothioconazole (4) the copper based fungicide is suspended in the water and (5) the azole fungicide and strobilurin are dissolved in the water-immiscible carrier.

is dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is picoxystrobin (3) the azole fungicide is prothioconazole (4) the copper based fungicide is suspended in the water and (5) the azole fungicide and strobilurin are dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is picoxystrobin (3) the azole fungicide is tebuconazole (4) the copper based fungicide is suspended in the water and (5) the azole fungicide and strobilurin are dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is picoxystrobin (3) the azole fungicide is tebuconazole (4) the copper based fungicide is suspended in the water and (5) the azole fungicide and strobilurin are dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is azoxystrobin (3) the azole fungicide is prothioconazole (4) the copper based fungicide is suspended in the water and (5) the azole fungicide and strobilurin are dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is azoxystrobin (3) the azole fungicide is prothioconazole (4) the copper based fungicide is suspended in the water and (5) the azole fungicide and strobilurin are dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is copper oxychloride (2) the strobilurin is azoxystrobin (3) the azole fungicide is tebuconazole (4) the copper based fungicide is suspended in the water and (5) the azole fungicide and strobilurin are dissolved in the water-immiscible carrier.

In another preferred embodiment, the suspoemulsion composition comprising: (i) copper-based fungicide, (ii) strobilurin, (iii) azole fungicide, (iv) water (v) water immiscible carrier and (vi) polyelectrolyte, wherein (1) the copper-based fungicide is Bordeaux mixture (2) the strobilurin is azoxystrobin (3) the azole fungicide is tebuconazole (4) the copper based fungicide is suspended in the water and (5) the azole fungicide and strobilurin are dissolved in the water-immiscible carrier.

In another preferred embodiment, the composition comprising: (i) copper-based fungicide, (ii) strobilurin, (iii) azole fungicide (iv) water and (v) polyelectrolyte, wherein (1) the copper-based fungicide is copper oxychloride (2) the strobilurin is picoxystrobin (3) the azole fungicide is prothioconazole and (4) the copper based fungicide, the azole fungicide and strobilurin are suspended in the water.

In another preferred embodiment, the subject matter relates to a composition comprising: (i) copper-based fungicide, (ii) strobilurin, (iii) azole fungicide and (iv) water, wherein (1) the copper-based fungicide is Bordeaux mixture (2) the strobilurin is picoxystrobin (3) the azole fungicide is prothioconazole and (4) the copper based fungicide, the azole fungicide and strobilurin are suspended in the water.

In another preferred embodiment, the subject matter relates to a composition comprising: (i) copper-based fungicide, (ii) strobilurin, (iii) azole fungicide and (iv) water, wherein (1) the copper-based fungicide is copper oxychloride, (2) the strobilurin is picoxystrobin which is dissolved in the water-immiscible carrier; and (3) the azole fungicide is tebuconazole and (4) the copper based fungicide, the azole fungicide and strobilurin are suspended in the water.

In another preferred embodiment, the subject matter relates to a composition comprising: (i) copper-based fungicide, (ii) strobilurin, (iii) azole fungicide and (iv) water, wherein (1) the copper-based fungicide is Bordeaux mixture (2) the strobilurin is picoxystrobin, (3) the azole fungicide is tebuconazole and (4) the copper based fungicide, the azole fungicide and strobilurin are suspended in the water.

In another preferred embodiment, the subject matter relates to a composition comprising: (i) copper-based fungicide, (ii) strobilurin, (iii) azole fungicide and (iv) water, wherein (1) the copper-based fungicide is copper oxychloride (2) the strobilurin is azoxystrobin, (3) the azole fungicide is prothioconazole and (4) the copper based fungicide, the azole fungicide and strobilurin are suspended in the water.

In another preferred embodiment, the subject matter relates to a composition comprising: (i) copper-based fungicide, (ii) strobilurin, (iii) azole fungicide and (iv) water, wherein (1) the copper-based fungicide is Bordeaux mixture, (2) the strobilurin is azoxystrobin, (3) the azole fungicide is prothioconazole and (4) the copper based fungicide, the azole fungicide and strobilurin are suspended in the water.

In another preferred embodiment, the subject matter relates to a composition comprising: (i) copper-based fungicide, (ii) strobilurin, (iii) azole fungicide and (iv), wherein (1) the copper-based fungicide is copper oxychloride, (2) the strobilurin is azoxystrobin, (3) the azole fungicide is tebuconazole and (4) the copper based fungicide, the azole fungicide and strobilurin are suspended in the water.

In another preferred embodiment, the subject matter relates to a composition comprising: (i) copper-based fungicide, (ii) strobilurin, (iii) azole fungicide, and (iv) water, wherein (1) the copper-based fungicide is Bordeaux mixture, (2) the strobilurin is azoxystrobin, (3) the azole fungicide is tebuconazole and (4) the copper based fungicide, the azole fungicide and strobilurin are suspended in the water.

In another preferred embodiment, the suspoemulsion composition comprising: (i) copper-based fungicide, (ii) SDHI, (iii) azole fungicide, (iv) water immiscible carrier, (v) water and (vi) polyelectrolyte, wherein (1) the copper-based fungicide is copper oxychloride (2) the SDHI is fluxapyroxad (3) the azole fungicide is prothioconazole, (4) the copper based fungicide is suspended in the water and (5) the azole fungicide and SDHI are suspended in the water immiscible carrier.

In another preferred embodiment, the suspoemulsion composition comprising: (i) copper-based fungicide, (ii) SDHI, (iii) azole fungicide (iv) water immiscible carrier, (v) water and (vi) polyelectrolyte, wherein (1) the copper-based fungicide is Bordeaux mixture (2) the SDHI is fluxapyroxad (3) the azole fungicide is prothioconazole (4) the copper based fungicide is suspended in water and (5) the SDHI and the azole fungicide are dissolved in the water immiscible carrier.

In another preferred embodiment, the suspension composition comprising: (i) copper-based fungicide, (ii) SDHI, (iii) azole fungicide (iv) water immiscible carrier, (v) water and (vi) polyelectrolyte wherein (1) the copper-based fungicide is copper oxychloride, (2) the SDHI is fluxapyroxad (3) the azole fungicide is tebuconazole, (4) the copper based fungicide is suspended in water and (5) the azole fungicide and SDHI are dissolved in water immiscible carrier.

In another preferred embodiment, the suspoemulsion composition comprising: (i) copper-based fungicide, (ii) SDHI, (iii) azole fungicide (iv) water immiscible carrier, (v) water and (vi) polyelectrolyte, wherein (1) the copper-based fungicide is Bordeaux mixture (2) the SDHI is fluxapyroxad (3) the azole fungicide is tebuconazole (4) the copper based fungicide is suspended in water and (5) the SDHI and the azole fungicide are dissolved in the water immiscible carrier.

In another preferred embodiment, the suspoemulsion composition comprising: (i) copper-based fungicide, (ii) SDHI, (iii) azole fungicide, (iv) water immiscible carrier, (v) water and (vi) polyelectrolyte, wherein (1) the copper-based fungicide is copper oxychloride (2) the SDHI is fluxapyroxad (3) the azole fungicide is prothioconazole, (4) the copper based fungicide is suspended in the water and (5) the azole fungicide and SDHI are suspended in the water immiscible carrier.

In another preferred embodiment, the suspoemulsion composition comprising: (i) copper-based fungicide, (ii) SDHI, (iii) azole fungicide (iv) water immiscible carrier, (v) water and (vi) polyelectrolyte, wherein (1) the copper-based fungicide is Bordeaux mixture (2) the SDHI is fluxapyroxad (3) the azole fungicide is prothioconazole (4) the copper based fungicide is suspended in water and (5) the SDHI and the azole fungicide are dissolved in the water immiscible carrier.

In another preferred embodiment, the suspension composition comprising: (i) copper-based fungicide, (ii) SDHI, (iii) azole fungicide (iv) water immiscible carrier, (v) water and (vi) polyelectrolyte wherein (1) the copper-based fungicide is copper oxychloride, (2) the SDHI is fluxapyroxad (3) the azole fungicide is tebuconazole, (4) the copper based fungicide is suspended in water and (5) the azole fungicide and SDHI are dissolved in water immiscible carrier.

In another preferred embodiment, the suspoemulsion composition comprising: (i) copper-based fungicide, (ii) SDHI, (iii) azole fungicide (iv) water immiscible carrier, (v) water and (vi) polyelectrolyte, wherein (1) the copper-based fungicide is Bordeaux mixture (2) the SDHI is fluxapyroxad (3) the azole fungicide is tebuconazole (4) the copper based fungicide is suspended in water and (5) the SDHI and the azole fungicide are dissolved in the water immiscible carrier.

In some embodiments, the polyelectrolyte comprises at least one polyanion. In some embodiments, the polyelectrolyte is a polyanion. In some embodiments, the polyelectrolyte comprises a polycation and a polyanion. In some embodiments, the polyelectrolyte is a complex of a polycation and a polyanion.

In some embodiments, the composition comprising macromolecular complex comprising copper based fungicide and the polyelectrolyte.

In some embodiments, the polyanion is lignosulfonate.

In another preferred embodiment, the subject matter relates to a composition comprising: a) a copper-based fungicide and fluopicolide, suspended in water.

In an embodiment, the amount of the additional fungicide(s) may be present in a concentration of about 0.1-30 wt. %, based on the total weight of the composition. In a further embodiment, the amount of the additional fungicide(s) may be present in a concentration of about 1-15% by weight based upon the total weight of the composition. In another embodiment, the amount of the additional fungicide(s) may be present in a concentration of about 1-10% by weight based upon the total weight of the composition. In yet another embodiment, the amount of the additional fungicide may be present in a concentration of about 3-8% by weight based upon the total weight of the composition. In a specific embodiment, the amount of the additional fungicide(s) may be present in a concentration of about 5.6% by weight based upon the total weight of the composition.

In some embodiments, water-immiscible carrier may include but is not limited to aromatic hydrocarbons (e.g., toluene, o-, m-, p-xylene, ethylbenzene, isopropylbenzene, tert-butylbenzene, naphthalenes, mono- or polyalkyl-substituted naphthalenes), paraffins (e.g. octane, nonane, decane, undecane, dodecane, tridecane, tetradecane, pentadecane, hexadecane, hepta-decane, octa-decane, nona-decane, eicosane, heneicosane, docosane, tricosane, tetracosane, pentacosane, and branched chain isomers thereof), petroleum, ketones (e.g. acetophenone, cyclohexanone), vegetable oil (e.g. olive oil, kapok oil, castor oil, papaya oil, camellia oil, palm oil, sesame oil, corn oil, rice bran oil, peanut oil, cotton seed oil, soybean oil, rapeseed oil, linseed oil, tung oil, sunflower oil, safflower oil, tall oil), alkyl ester of vegetable oils, (e.g. rapeseed oil methyl ester or rapeseed oil ethyl ester, rapeseed oil propyl esters, rapeseed oil butyl esters, tall oil fatty acids esters etc.), diesel, mineral oil, fatty acid amides (e.g. C₁-C₃ amines, alkylamines or alkanolamines with C₆-C₁₈ carboxylic acids), fatty acids, tall oil fatty acids, alkyl esters of fatty acids (e.g. C₁-C₄ monohydric alcohol esters of C₈ to C₂₂ fatty acids such as methyl oleate, ethyl oleate), modified vegetable oils and combinations thereof.

In a preferred embodiment, the water immiscible carrier may include but is not limited to aromatic hydrocarbons, fatty acid amides, alkyl ester of vegetable oils and vegetable oils.

In an embodiment, the amount of the water immiscible carrier may be about 0.1-20 wt. %, about 1-15 wt. %, or about 0.1-10 wt. %, or about 1-5% based on the total weight of the composition. In a specific embodiment, the non-aqueous liquid carrier may be present in a concentration of about 3% by weight based upon the total weight of the composition.

In some embodiments, embodiments, the adjuvant in the liquid carrier may include but is not limited to vegetable oils, alkyl esters of vegetable oils such as for example, soy methyl ester, soy ethyl ester, rapeseed oil methyl ester or rapeseed oil ethyl ester, alkoxylated sorbitan esters such as for example sorbitan monolaurate alkoxylates such as for example polyoxyethylene (16) sorbitan monolaurate (Tween™ 24), polyoxyethylene (20) sorbitan monolaurate (Tween™ 20; Alkamuls® PSML-20), polyoxyethylene (4) sorbitan monolaurate (Tween™ 21), polyoxyethylene (8) sorbitan monolaurate (Tween™ 22), polyoxyethylene (12) sorbitan monolaurate (Tween™ 23), sorbitan monolaurate (Alkamuls® S/20, Glycomul® LK, Glycomul® LC, Span® 20), polyoxyethylene (20) sorbitan monostearate alkoxylates such as for example polyoxyethylene (20) sorbitan monostearate (Tween™ 60), polyoxyethylene (4) sorbitan monostearate (Tween™ 61), sorbitan monostearate (Alkamuls® S/90, Glycomul® S, Span® 60), sorbitan monooleate alkoxylates such as for example polyoxyethylene (20) sorbitan monooleate (Tween™ 80, Emulgin® SMO 20, T-Maz® 80, Agnique® SMO 20U), polyoxyethylene (5) sorbitan monooleate (Tween™ 81), sorbitan monooleate (Alkamuls® S/80, Span® 80), and combinations thereof.

A composition according to the invention provides a stable aqueous suspension comprising a high concentration of a copper-based fungicide up to about 30% (w/w), with improved fungicidal activity and/or effective control of plant health compared to commercially available formulations of said copper-based fungicide

A composition according to the invention provides a stable aqueous suspension comprising a high concentration of a copper-based fungicide up to about 50% (w/v), with improved fungicidal activity and/or effective control of plant health compared to commercially available formulations of said copper-based fungicide, in the presence of relatively low amounts of adjuvants as agriculturally acceptable carriers.

In some embodiments, the macromolecular complex is made by pre-mixing the polyelectrolyte and the copper-based fungicide prior to addition of the other additive.

In some embodiments, the amount of the copper-based fungicide is more effective than if the same type and amount of copper base fungicide is formulated in the absence of polyelectrolyte.

In some embodiments, the amount of the copper-based fungicide is more effective in promoting growth of a crop plant in the presence of a fungus than if the same type and amount of copper base fungicide is formulated in the absence of polyelectrolyte.

In some embodiments, more effective refers but is not limited to biological control, rainfastness, adherence to leaves, controlled release, preventive efficacy, and/or increasing the plant health.

The present invention also provides a composition comprising (1) copper-based fungicide, (2) a polyelectrolyte, and (3) at least one agriculturally acceptable additive, wherein the composition has any one or any combination of the following features:
a. the composition is more fungicidally effective compared to a composition of copper-based fungicide which is not made in the presence of the polyelectrolyte,
b. the composition is more fungicidally effective compared to a composition of copper-based fungicide which is formulated in the absence of the polyelectrolyte,
c. the composition has improved leaf adhesion compared to a composition of copper-based fungicide which is formulated in the absence of the polyelectrolyte,
d. the composition has improved rainfastness compared to a composition of copper-based fungicide which is formulated in the absence of the polyelectrolyte,
e. the composition has decreased drift compared to a composition with of copper-based fungicide which is formulated in the absence of the polyelectrolyte, and
f. the composition has controlled bioavailability compared to a composition of copper-based fungicide which is formulated in the absence of the polyelectrolyte.

In some embodiments, controlled bioavailability means controlled rate of release of Cu²⁺.

The present invention provides a composition comprising:
(i) 28.8% by weight of Bordeaux,
(ii) 53.8% by weight of water,
(iii) 0.5% by weight of chitosan,
(iv) 2.3% by weight of calcium lignosulfonate,
(v) 2% by weight of Metasperse 500L,
(vi) 2% by weight of Atlas G5002L,
(vii) 0.4% by weight of Silicolapse 426R,
(viii) 4.2% by weight of propane-1,2-diol,
(ix) 0.083% by weight of Acticide® MBS, and
(x) 6% by weight of Rhodopol 23.

The present invention provides a composition comprising:
(i) 28.8% by weight of Bordeaux,
(ii) 55% by weight of water,
(iii) 0.5% by weight of chitosan,
(iv) 2.3% by weight of calcium lignosulfonate,
(v) 1% by weight of Tensiofix CGA213,
(vi) 2% by weight of Tensiofix LB350,
(vii) 0.2% by weight of Tensiofix L051,
(viii) 4.2% by weight of propane-1,2-diol,
(ix) 0.083% by weight of Acticide® MBS, and
(x) 6% by weight of Rhodopol 23.

The present invention provides a composition comprising:
(i) 28.8% by weight of Bordeaux,
(ii) 52.3% by weight of water,
(iii) 2.3% by weight of calcium lignosulfonate,
(iv) 2% by weight of Metasphere 500L,
(v) 2% by weight of Atlas G5002L,
(vi) 0.4% by weight of Silicolapse 426R,
(vii) 4.2% by weight of propane-1,2-diol,
(viii) 0.083% by weight of Acticide® MBS, and
(ix) 8% by weight of Rhodopol 23.

The present invention provides a composition comprising:
(i) 28.8% by weight of Bordeaux,
(ii) 53.4% by weight of water,
(iii) 2.3% by weight of calcium lignosulfonate,
(iv) 1% by weight of Tensiofix CGA213,
(v) 2% by weight of Tensiofix LB350,
(vi) 0.2% by weight of Tensiofix L051,
(vii) 4.2% by weight of propane-1,2-diol,
(viii) 0.083% by weight of Acticide® MBS, and
(ix) 8% by weight of Rhodopol 23.

The present invention provides a composition comprising:
(i) 30.5% by weight of Cu-oxychloride,
(ii) 5% by weight of Picoxystrobin (99)
(iii) 5.8% by weight of Prothioconazole (99.3)
(iv) 35.8% by weight of water,
(v) 2.6% by weight of Na citrate
(vi) 2.8% by weight of calcium lignosulfonate,
(vii) 0.3% by weight of chitosan
(viii) 5% by weight of Tergitol XD,
(ix) 0.9% by weight of Ecosurf EH6,
(x) 3.6% by weight of propane-1,2-diol,
(xi) 0.4% by weight of silcolapse 426R, and
(xii) 7.5% by weight of Rhodopol 23.

The present invention provides a composition comprising:
(i) 31.7% by weight of Bordeaux Mixture
(ii) 2.6% by weight of Picoxystrobin (99)
(iii) 3.0% by weight of Prothioconazole (99.3)
(iv) 41.2% by weight of water,
(v) 1.5% by weight of Na citrate
(vi) 1.0% by weight of calcium lignosulfonate,
(vii) 0.2% by weight of chitosan
(viii) 7.4% by weight of soprophor FL,
(ix) 1.5% by weight of atlas G5002L,
(x) 3.7% by weight of propane-1,2-diol,
(xi) 0.7% by weight of silcolapse 426R,
(xii) 0.1% by weight of acticide MBS and
(xiii) 6.3% by weight of Rhodopol 23.

The present invention provides a composition comprising:
(i) 31.7% by weight of Bordeaux Mixture,
(ii) 2.6% by weight of Picoxystrobin (99),
(iii) 3.0% by weight of Prothioconazole (99.3),
(iv) 38.8% by weight of water,
(v) 1.5% by weight of dipotassium hydrogen phosphate,
(vi) 2.1% by weight of calcium lignosulfonate,
(vii) 0.4% by weight of chitosan,
(viii) 0.2% by weight of acetic acid,
(ix) 7.4% by weight of soprophor FL,
(x) 1.5% by weight of atlas G5002L,
(xi) 3.7% by weight of propane-1,2-diol,
(xii) 0.7% by weight of silcolapse 426R,
(xiii) 0.1% by weight of acticide MBS and
(xiv) 6.3% by weight of Rhodopol 23.

The present invention provides a composition comprising:
(i) 31.7% by weight of Bordeaux Mixture,
(ii) 2.6% by weight of Picoxystrobin (99),
(iii) 3.0% by weight of Prothioconazole (99.3),
(iv) 41.9% by weight of water,
(v) 1.5% by weight of Na citrate,
(vi) 2% by weight of calcium lignosulfonate,
(vii) 0.5% by weight of chitosan,
(viii) 7.4% by weight of soprophor FL,
(ix) 1.5% by weight of atlas G5002L,
(x) 3.7% by weight of propane-1,2-diol,
(xi) 0.7% by weight of silcolapse 426R,
(xii) 0.1% by weight of acticide MBS and
(xiii) 3.4% by weight of Rhodopol 23.

The present invention provides a composition comprising:

(i) 35.5% by weight of Cu-oxychloride,
(ii) 5.6% by weight of fluopicolide,
(iii) 36.9% by weight of water,
(iv) 3.6% by weight of calcium lignosulfonate,
(v) 0.4% by weight of chitosan,
(vi) 2.5% by weight of soprophor 3D33,
(vii) 1.0% by weight of ecosurf EH6,
(viii) 4.2% by weight of propane-1,2-diol,
(ix) 0.4% by weight of silcolapse 426R, and
(x) 10% by weight of Rhodopol 23.

The present invention provides a composition comprising:
(i) 35.5% by weight of Cu-oxychloride,
(ii) 5.6% by weight of fluopicolide,
(iii) 41.5% by weight of water,
(iv) 3.6% by weight of calcium lignosulfonate,
(v) 0.7% by weight of PAA
(vi) 2.5% by weight of atlox 4913,
(vii) 1.0% by weight of adsee900,
(viii) 4.2% by weight of propane-1,2-diol,
(ix) 0.4% by weight of silcolapse 426R, and
(x) 5% by weight of Rhodopol 23.

The present invention provides a composition comprising:
(i) 35.5% by weight of Cu-oxychloride,
(ii) 5.6% by weight of fluopicolide,
(iii) 39.4% by weight of water,
(iv) 3.3% by weight of calcium lignosulfonate,
(v) 0.7% by weight of chitosan
(vi) 2.5% by weight of atlox 4913,
(vii) 1.0% by weight of adsee900,
(viii) 4.2% by weight of propane-1,2-diol,
(ix) 0.4% by weight of silcolapse 426R, and
(x) 7.5% by weight of Rhodopol 23.

The present invention provides a composition comprising:
(i) 34.29% by weight of Bordeaux Mixture,
(ii) 2.78% by weight of Picoxystrobin,
(iii) 5.0% by weight of propane-1,2-diol,
(iv) 1.0% by weight of Metasperse 550 S,
(v) 2.8% by weight of Borresperse CA
(vi) 2% by weight of Geropon® T-77,
(vii) 2.0% by weight of Atlox 4894
(viii) 0.1% by weight of SAG 1572,
(ix) 0.05% by weight of Proxel GXL,
(x) 36.86% by weight of DM water,
(xi) 3.06% by weight of prothioconazole and
(xii) 3.06% by weight of Armid DM 10.

The present invention provides a composition comprising:
(i) 34.29% by weight of Bordeaux Mixture,
(ii) 2.78% by weight of Picoxystrobin,
(iii) 5.0% by weight of propane-1,2-diol,
(iv) 1.0% by weight of Metasperse 550 S,
(v) 2.8% by weight of Borresperse CA
(vi) 2% by weight of Geropon® T-77,
(vii) 2.0% by weight of Atlox 4894
(viii) 0.1% by weight of SAG 1572,
(ix) 0.05% by weight of Proxel GXL,
(x) 36.86% by weight of DM water,
(xi) 3.06% by weight of prothioconazole and
(xii) 3.06% by weight of Armid DM 10.

The present invention provides a composition comprising:
(i) 30% by weight of Bordeaux Mixture,
(ii) 2.5% by weight of Picoxystrobin,
(iii) 5.0% by weight of propane-1,2-diol,
(iv) 1.0% by weight of Metasperse 550 S,
(v) 2.8% by weight of Borresperse CA
(vi) 2% by weight of Geropon® T-77,
(vii) 2.0% by weight of Atlox 4894
(viii) 0.1% by weight of SAG 1572,
(ix) 0.05% by weight of Proxel GXL,
(x) 36.86% by weight of DM water,
(xi) 3.06% by weight of prothioconazole and
(xii) 3.06% by weight of Armid DM 10.

The present invention provides a composition comprising:
(i) about 22.89% by weight of Cu-oxychloride,
(ii) about 3.67% by weight of picoxystrobin,
(iii) about 4.1% by weight of prothioconazole,
(iv) about 35.63% by weight of water,
(v) about 1.87% by weight of calcium lignosulfonate,
(vi) about 0.2% by weight of chitosan,
(vii) about 0.45% by weight of Acetic Acid,
(viii) about 13.22% by weight of Acetophenone,
(ix) about 1% by weight of Agnique BP 420,
(x) about 2.64% by weight of Agsolex 8,
(xi) about 5% by weight of POLYAGRO A,
(xii) about 3% by weight of Propylene glycol,
(xiii) about 0.02% by weight of Proxel GXL,
(xiv) about 0.2% by weight of SAG 1572,
(xv) about 2.54% by weight of sodium acetate,
(xvi) about 2.02% by weight of Soprophor TS/16,
(xvii) about 0.66% by weight of Synergen SOC,
(xviii) about 0.35% by weight of Thiourea,
(xix) about 0.3% by weight of Van Gel B, and
(xx) about 0.2% by weight of AG-RH 23

The present invention provides a composition comprising (1) macromolecular complex comprising (i) a copper-based fungicide and (ii) a polyelectrolyte, (2) at least one agriculturally acceptable additive and optionally (3) at least one additional fungicide.

The present invention also provides composition comprising (1) a copper-based fungicide, (2) a polyelectrolyte (3) at least one agriculturally acceptable additive and optionally (4) at least one additional fungicide.

The present invention also provides an aqueous composition comprising (1) a copper-based fungicide, (2) a polyelectrolyte, (3) water, and (4) at least one agriculturally acceptable additive.

The present invention provides a composition comprising (1) macromolecular complex comprising (i) a copper-based fungicide and (ii) a polyanion, optionally (2) at least one additional fungicide, and (3) at least one agriculturally acceptable additive.

The invention provides a macromolecular complex comprising (i) a copper-based fungicide and (ii) a polyanion.

### Delivery Systems

The invention also provides a pesticidal delivery system comprising any one of any combination, composition or macromolecular complexes described herein.

### Methods of Use

The present invention provides a method for controlling pathogen infection comprising applying a composition comprising (1) an amount of copper-based fungicide, (2) an amount of polyelectrolyte and (3) at least one agriculturally acceptable additive, wherein the application rate of the copper-based fungicide when is formulated with polyelectrolyte is less than when the same type of the copper base fungicide is formulated in the absence of polyelectrolyte.

In some embodiments, the amount of the copper-based fungicide is more effective than if the same type and amount of copper base fungicide is formulated in the absence of polyelectrolyte.

The present invention provides a method for improving efficacy of a copper-based fungicide comprising interacting the copper-based fungicide with a polyelectrolyte through intermolecular, non-covalent interactions before application of the copper-based fungicide.

In some embodiments, improving efficacy includes but is not limited to biological control, rainfastness, adherence to leaves, controlled release, preventive efficacy.

In some embodiments, the amount of the copper-based fungicide is more effective in promoting growth of a crop plant in the presence of a fungus than if the same type and amount of copper base fungicide is formulated in the absence of polyelectrolyte.

The present invention also provides use of the combination, macromolecular complex, composition, and/or delivery system described herein for treating a plant, or a part of a plant, against a pathogen.

The present invention also provides use of the combination, macromolecular complex, composition, and/or delivery system described herein for reducing the rate of application required for treating a plant, or a part of a plant, against a pathogen.

Said method or use of the composition, combination, delivery system and/or macromolecular complex, comprising a copper-based fungicide and a polyelectrolyte, may result in a reduced rate of application of the copper-based fungicide.

The terms “reduced rate of application” and “increasing biological activity” may refer to a rate of application that is more than 20%, preferably more than 50%, reduced, when compared to the rate of application of the same copper-based fungicide as a free copper-based fungicide.

The present invention provides a method of treating a plant, or a part of a plant, against a pathogen, comprising contacting the plant, or part of the plant, with any one or any combination of the macromolecular complexes described herein, and/or any one or any combination of the compositions described herein.

In some embodiments, treating comprises preventing, reducing and/or eliminating the presence of the pathogen on the plant, or part of the plant. In some embodiments, treating comprises controlling diseases caused by the pathogen.

The invention provides a method of increasing crop yield comprising contacting the plant, or part of the plant with any one of any combination, composition, macromolecular complexes and/or delivery system described herein.

The invention also provides a method of improving plant vigor comprising contacting the plant, or part of the plant with any one of any combination, composition, macromolecular complexes and/or delivery system described herein.

In some embodiments, the method of treating the plant, or the part of a plant against a pathogen comprises protecting the plant, or a part of a plant, against the pathogen, comprising contacting the plant, or part of the plant, with any one of any combination, composition, macromolecular complexes and/or delivery system described herein.

In some embodiments, the method of treating the plant, or the part of a plant against a pathogen comprises preventing, reducing and/or eliminating the presence of the pathogen on the plant, or part of the plant, comprising contacting the plant, or part of the plant, with any one of any combination, composition, macromolecular complexes and/or delivery system described herein.

In some embodiment, the method of treating the plant, or the part of a plant against a pathogen comprises controlling diseases caused by phytopathogenic fungi in plants or on propagation material thereof, which method comprises contacting the plants, or propagation material thereof, with any one of any combination, composition, macromolecular complexes and/or delivery system described herein.

In some embodiments, the method of treating the plant, or the part of a plant against a pathogen comprises improving pest control comprising applying any one of any combination, composition, macromolecular complexes and/or delivery system described herein to a plant/or soil.

In some embodiments, the method of treating the plant, or the part of a plant against a pathogen comprises prolonging a controlling effect of a copper-based fungicide, comprising applying any one of any combination, composition, macromolecular complexes and/or delivery system described herein to a plant/or soil.

In some embodiments, the pathogen is phytopathogenic fungi and the method comprises controlling diseases caused by phytopathogenic fungi in the plant or on propagation material thereof comprising contacting the plant, or propagation material thereof, with any one of any combination, composition, macromolecular complexes and/or delivery system described herein.

The invention further provides a method of protecting a plant or plant part against a pathogen, comprising contacting said plant or said plant part with a diluted aqueous composition according to this invention.

The invention further provides a method of preventing, reducing and/or eliminating the presence of a pathogen on a plant, or a part of a plant, comprising contacting said plant, or part of said plant, with an aqueous composition according to this invention.

In some embodiments, the method of treating the plant, or the part of a plant against a pathogen comprises preventing, reducing and/or eliminating the presence of the pathogen on the plant, or part of the plant, comprising contacting the plant, or part of the plant, with any one of any combination, composition, macromolecular complexes and/or delivery system described herein

The invention further provides a method of controlling diseases caused by phytopathogenic fungi in plants or on propagation material thereof, which method comprises contacting the plants, or propagation material thereof, with a composition according to the invention, including an aqueous diluted composition.

The present invention also provides a method of controlling pest comprising contacting (i) the pest or a locus thereof, (ii) a plant or a locus or propagation material thereof, (iii) soil, and/or (iv) an area in which pest infestation is to be prevented with a macromolecular complex of the invention. Said macromolecular complex of the invention preferably is provided as a composition according to the invention, and/or a delivery system according to the invention.

The present invention also provides a method for improving pest control comprising applying any one of the compositions, complexes or delivery systems described herein to a plant/or soil.

The present invention also provides a method for prolonging a controlling effect of a copper-based fungicide, comprising applying any one of the compositions, complexes or delivery systems described herein to a plant/or soil.

The present invention provides a method for controlling the release rate of copper cation from a copper-based fungicide comprising interacting the copper-based fungicide with a polyelectrolyte through intermolecular, non-covalent interactions before application of the copper-based fungicide.

In some embodiment, the combination of polyelectrolyte with the copper-based fungicide is before adding the co-formulants.

Rate of application may refer to an application rate of 22 g a.i./ha copper based fungicide (a.i.)/ha to 2.2 g a.i./ha, 0.22 g a.i./ha, 0.022 g a.i./ha, 0.0022 g a.i./ha, 750 g a.i./ha, 450 g a.i./ha, 375, 150 g a.i./ha, 15 g a.i./ha, 2.9 gr a.i./lit, 11.6 gr a.i./lit, preferably 0.0022 g a.i./ha to 0.75 kg a.i./ha. Rate of application may refer to an application rate of 22 g a.i./ha to 2.2 g a.i./ha of copper-based fungicide. In some embodiments, the copper-based fungicide is applied at a rate of 750 g a.i./ha, 605 mg a.i./ha, or 500 mg a.i./ha.

In some embodiments, the combination, composition, and/or delivery system is applied at an amount of 0.01-5 g/ha of the copper-based fungicide. In some embodiments, the combination, composition, and/or delivery system is applied at an amount of 0.01-3 g/ha of the copper-based fungicide. In some embodiments, the combination, composition, and/or delivery system is applied at an amount of 0.01-2 g/ha of the copper-based fungicide. In some embodiments, the combination, composition, and/or delivery system is applied at an amount of 0.01-1 g/ha of the copper-based fungicide.

In some embodiments, the combination, composition, and/or delivery system is applied at an amount of 0.018 g/ha of copper-based fungicide. In some embodiments, the combination, composition, and/or delivery system is applied at an amount of 0.97 g/ha of copper-based fungicide. In some embodiments, the combination, composition, and/or delivery system is applied at an amount of 0.39 g/ha of copper-based fungicide. In some embodiments, the combination, composition, and/or delivery system is applied at an amount of 1.56 g/ha of copper-based fungicide.

In some embodiments, the combination, composition, and/or delivery system is applied at an amount between 0.001 g/ha to 1000 g/ha of copper metal. In some embodiments, the combination, composition, and/or delivery system is applied at an amount between 100 g/ha to 1000 g/ha of copper metal. In some embodiments, the combination, composition, and/or delivery system is applied at an amount between 100 g/ha to 500 g/ha of copper metal. In some embodiments, the combination, composition, and/or delivery system is applied at an amount between 500 g/ha to 1000 g/ha of copper metal. In some embodiments, the combination, composition, and/or delivery system is applied at an amount between 0.001 g/ha to 100 g/ha of copper metal. In some embodiments, the combination, composition, and/or delivery system is applied at an amount between 0.001 g/ha to 50 g/ha of copper metal. In some embodiments, the combination, composition, and/or delivery system is applied at an amount between 0.001 g/ha to 25 g/ha of copper metal. In some embodiments, the combination, composition, and/or delivery system is applied at an amount between 0.001 g/ha to 10 g/ha of copper metal.

In some embodiments, the combination, composition, and/or delivery system is applied at an amount of about 0.0022 g/ha, 0.022 g/ha, 0.22 g/ha, 2.2 g/ha or 22 g/ha of copper metal.

In some embodiments, the combination, composition, and/or delivery system is applied at an amount of about 0.0075 g/ha, 0.075 g/ha, 0.75 g/ha, 7.5 g/ha or 75 g/ha of copper metal.

In some embodiments, the combination, composition, and/or delivery system is applied at an amount of about 0.0052 g/ha of copper metal. In some embodiments, the combination, composition, and/or delivery system is applied at an amount of about 0.001 g/ha of copper metal. In some embodiments, the combination, composition, and/or delivery system is applied at an amount of about 0.059 g/ha of copper metal. In some embodiments, the combination, composition, and/or delivery system is applied at an amount of about 0.0095 g/ha of copper metal.

In some embodiments, the combination, composition, and/or delivery system is applied at an amount of about 15 g/ha of copper metal. In some embodiments, the combination, composition, and/or delivery system is applied at an amount of about 150 g/ha of copper metal. In some embodiments, the combination, composition, and/or delivery system is applied at an amount of about 375 g/ha of copper metal. In some embodiments, the combination, composition, and/or delivery system is applied at an amount of about 450 g/ha of copper metal. In some embodiments, the combination, composition, and/or delivery system is applied at an amount of about 750 g/ha of copper metal.

A composition, combination, macromolecular complex and/or delivery system according to the invention is suitable for the control of pests that are encountered in horticulture, agriculture, and forestry. The macromolecular complexes are active against normally sensitive and resistant pest species and during all or individual stages of development. Prior to use, a composition comprising a macromolecular complex according to the invention is preferably dissolved or dispersed in water, or diluted with water, to provide an aqueous composition comprising between 0.001 and 10 w/v % of the copper-based fungicide. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the copper-based fungicide, prior to contacting a plant, plant part or soil with the composition.

To control agricultural pests, the invention provides a use of a composition comprising a macromolecular complex according to the invention for the protection of a plant, or a part of a plant, against a pathogen. In order to achieve this effect, said plant or plant part, or a soil, is contacted with said composition, including a diluted aqueous composition.

Said composition is used, for example, to control powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

For example, a plant of part thereof may be coated with a diluted aqueous composition comprising a copper-based fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

The invention provides a method for (i) increasing biological activity of a copper-based fungicide on a target, (ii) increasing persistence of a copper-based fungicide into a target, (iii) increasing retention of a copper-based fungicide by a target, (iv) increasing absorbance of a copper-based fungicide by a target, and/or (v) increasing or enhancing bioavailability of a copper-based fungicide to a target, wherein the method comprises interacting the copper-based fungicide with a polyelectrolyte prior to application of the copper-based fungicide to a plant, a plant part, and/or soil.

In some embodiments, the method comprises interacting the copper-based fungicide with the polyelectrolyte through complexation by non-covalent electrostatic interaction prior to application of the copper-based fungicide to the plant, plant part, and/or soil.

In some embodiments, the method comprises interacting the copper-based fungicide with the polyelectrolyte to form a macromolecular complex prior to application of the copper-based fungicide to the plant, plant part, and/or soil.

In some embodiments, the method comprises complexing, entrapping, or encapsulating the copper-based fungicide partially or completely within the polyelectrolyte prior to application of the copper-based fungicide to the plant, plant part, and/or soil. In some embodiments, the method comprises entrapping the copper-based fungicide partially or completely within the polyelectrolyte prior to application of the copper-based fungicide to the plant, plant part, and/or soil.

The invention provides the use of a macromolecular complex, a composition or a delivery system of the present invention for (i) increasing biological activity of a copper-based fungicide on a target, (ii) increasing uptake of a copper-based fungicide into a target, (iii) increasing retention of a copper-based fungicide by a target, (iv) increasing absorbance of a copper-based fungicide by a target, and/or (v) increasing or enhancing bioavailability of a copper-based fungicide to a target.

In some embodiments, the bioavailability of the copper-based fungicide is increased or enhanced by controlling the release rate of the copper ion from the copper-based fungicide.

In some embodiments, the target is a plant. In some embodiments, the target is a plant part. In some embodiments, the target is a fungus.

The invention provides a method for (i) reducing drift of a copper-based fungicide, (ii) increasing leaf adhesion of a copper-based fungicide, (iii) increasing rainfastness of a copper-based fungicide, (iv) increasing persistence of a copper-based fungicide, and/or (v) reducing phytotoxicity of a copper-based fungicide, wherein the method comprises interacting the copper-based fungicide with a polyelectrolyte prior to application of the copper-based fungicide.

In some embodiments, the method comprises interacting the copper-based fungicide with a polyelectrolyte through complexation by non-covalent electrostatic interaction.

In some embodiments, the method comprises interacting the copper-based fungicide with a polyelectrolyte to form a macromolecular complex.

The invention provides the use of a macromolecular complex, a composition, or a delivery system of the present invention for (i) reducing drift of a copper-based fungicide, (ii) increasing leaf adhesion of a copper-based fungicide, (iii) increasing rainfastness of a copper-based fungicide, and/or (iv) increasing persistence of a copper-based fungicide.

The invention also provides a method for reducing phytotoxicity of a copper-based fungicide on a plant, comprising interacting the copper-based fungicide with a polyelectrolyte through complexation by intermolecular electrostatic interactions prior to application of the copper-based fungicide to a plant, part of a plant and/or soil.

An aspect of the invention provides a use of the macromolecular complex, composition, and/or delivery system according to the invention, comprising a copper-based fungicide and a polyelectrolyte, for increasing biological activity of the copper-based fungicide.

An aspect of the invention provides a use of the polyelectrolyte, for increasing biological activity of the copper-based fungicide.

An aspect of the invention provides a use of the polyelectrolyte, for decrease the application rate of the copper-based fungicide.

An aspect of the invention provides a use of the polyelectrolyte for controlling the bioavailability of the copper-based fungicide by controlling the release profile of copper ion from the copper-based fungicide.

The present invention also provides a method for decreasing phytotoxicity of the copper-based fungicide comprising interacting the fungicide with a polyelectrolyte through complexation by intermolecular electrostatic interactions prior to application of the fungicide to a plant, part of a plant and/or soil.

The present invention also provides a method for decreasing the phytotoxicity of the copper-based fungicide comprising formulating the copper-based fungicide with a polyelectrolyte.

The present invention also provides a method for increasing biological activity of a copper-based fungicide on a fungus comprising interacting the copper-based fungicide with a polyelectrolyte through complexation by intermolecular electrostatic interactions prior to application of the copper-based fungicide to a plant, part of a plant and/or soil.

The present invention also provides a method for increasing fungicidal activity of a copper-based fungicide on a fungus comprising interacting the copper-based fungicide with a polyelectrolyte through complexation by intermolecular electrostatic interactions prior to application of the copper-based fungicide to a plant, part of a plant and/or soil.

The present invention also provides a method for increasing uptake of a copper-based fungicide by a target, comprising interacting the copper-based fungicide with a polyelectrolyte through complexation by intermolecular electrostatic interactions prior to application of the copper-based fungicide to a plant, part of a plant and/or soil.

The present invention also provides a method for increasing uptake of a copper-based fungicide by a target, comprising interacting the copper-based fungicide with a polyelectrolyte through complexation by intermolecular electrostatic interactions prior to application of the copper-based fungicide to a plant, part of a plant and/or soil.

The invention also provides a method for reducing drift of a copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

The invention also provides a method for increasing leaf adhesion of a copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

The invention also provides a method for increasing rainfastness of a copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

The invention also provides a method for increasing persistence of copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

In some embodiments, the target is a plant. In some embodiments, the target is a pest. In some embodiments, the pest is a fungus.

The present invention also provides a method for increasing bioavailability of a copper-based fungicide comprising interacting the copper-based fungicide with a polyelectrolyte by complexing the copper-based fungicide with the polyelectrolyte or entrapping or encapsulating the copper-based fungicide within the polyelectrolyte prior to application of the copper-based fungicide to a plant, part of a plant and/or soil.

The present invention also provides a method for increasing the biological activity of a copper-based fungicide on a pest comprising interacting the copper-based fungicide with a polyelectrolyte through complexation by intermolecular electrostatic interactions prior to application of the copper-based fungicide to a plant, part of a plant and/or soil.

The term “increasing biological activity” refers to curative, knock down, preventive and/or persistence performance.

The present invention also provides a method for increasing uptake of a copper-based fungicide by a target, comprising interacting the copper-based fungicide with a polyelectrolyte through complexation by intermolecular electrostatic interactions prior to application of the copper-based fungicide to a plant, part of a plant and/or soil.

In some embodiments, the target is a plant. In some embodiments, the target is a pest. In some embodiments, the pest is a fungus.

The present invention also provides a method for increasing absorbance of a copper-based fungicide by a plant tissue, comprising interacting the copper-based fungicide with a polyelectrolyte through complexation by intermolecular electrostatic interactions prior to application of the copper-based fungicide to a plant, part of a plant and/or soil.

The present invention also provides a method for increasing biological activity of a copper-based fungicide on a pest comprising interacting the copper-based fungicide with a polyelectrolyte through complexation by intermolecular electrostatic interactions prior to application of the copper-based fungicide to a plant, part of a plant and/or soil.

The present invention also provides a method for increasing the uptake of copper-based fungicide by a plant, comprising interacting the copper-based fungicide with a polyelectrolyte through complexation by intermolecular electrostatic interactions prior to application of the copper-based fungicide to the plant, part of a plant and/or soil.

The present invention also provides a method for increasing the bioavailability of a copper-based fungicide, comprising interacting the copper-based fungicide with a polyelectrolyte by complexing, entrapping or encapsulating molecules of the copper-based fungicide with or within molecules of the polyelectrolyte prior to application of the copper-based fungicide to a plant, part of a plant and/or soil.

The present invention also provides a method for increasing the biological activity of a copper-based fungicide on a plant comprising interacting the copper-based fungicide with a polyelectrolyte through non-covalent electrostatic interaction prior to application of the copper-based fungicide to a plant, part of a plant and/or soil.

The present invention also provides a method of increasing uptake of a copper-based fungicide by a plant, increasing retention of a copper-based fungicide by a plant and/or increasing bioavailability of a copper-based fungicide to a plant comprising interacting the copper-based fungicide with a polyelectrolyte through complexation by non-covalent electrostatic interaction prior to application of the copper-based fungicide to the plant, part of a plant and/or soil.

The present invention also provides a method for increasing the biological activity of a copper-based fungicide on a plant comprising interacting the copper-based fungicide with a polyelectrolyte through complexation by electrostatic intermolecular interaction prior to application of the copper-based fungicide to a plant, and/or soil.

The present invention also provides a method of increasing uptake of a copper-based fungicide by a plant, increasing retention of a copper-based fungicide by a plant and/or increasing bioavailability of a copper-based fungicide to a plant comprising interacting the copper-based fungicide with a polyelectrolyte through complexation by electrostatic intermolecular interaction prior to application of the copper-based fungicide to the plant, part of a plant and/or soil.

The method preferably comprises interacting the copper-based fungicide with the polyelectrolyte through non-covalent electrostatic interaction prior to the application.

The invention provides the use of a complex according to the invention for decreasing the application rate of a copper-based fungicide.

The invention provides the use of a macromolecular complex according to the invention for decreasing the application rate of a copper-based fungicide

The invention provides the use of a complex according to the invention for increasing the biological activity of a copper-based fungicide.

The invention provides the use of a macromolecular complex according to the invention for increasing the biological activity of a copper-based fungicide.

The present invention also provides a method for increasing the bioavailability of a copper-based fungicide, comprising interacting the copper-based fungicide with a polyelectrolyte by complexing, entrapping or encapsulating molecules of the copper-based fungicide entirely or partially within molecules of the polyelectrolyte prior to application of the copper-based fungicide to a plant, part of a plant and/or soil.

The invention provides the use of a complex according to the invention for enhancing the biological activity of a copper-based fungicide.

The invention provides the use of a macromolecular complex according to the invention for enhancing the biological activity of a copper-based fungicide.

The present invention also provides a method for enhancing the bioavailability of a copper-based fungicide, comprising interacting the copper-based fungicide with a polyelectrolyte by complexing, entrapping or encapsulating molecules of the copper-based fungicide entirely or partially within molecules of the polyelectrolyte prior to application of the copper-based fungicide to a plant, part of a plant and/or soil.

The invention provides the use of a macromolecular complex according to the invention for prolonging the fungicidal effect of a copper-based fungicide.

The use of at least one polyelectrolyte for formulating an aqueous suspension concentrate comprising copper-based fungicide.

The use of at least one dispersant and macromolecular complex for formulating an aqueous suspension concentrate comprising copper-based fungicide.

The use of at least one dispersant and macromolecular complex for formulating an aqueous suspension concentrate comprising a copper-based fungicide.

In some embodiments, molecules of the copper-based fungicide are entirely complexed with molecules of the polyelectrolyte by electrostatic interaction prior to application. In some embodiments, molecules of the copper-based fungicide are entirely complexed with molecules of the polyanion by electrostatic interaction prior to application In some embodiments, molecules of the copper-based fungicide are partially complexed with molecules of the polyelectrolyte prior to application. In some embodiments, molecules of the copper-based fungicide are partially complexed with molecules of the polyanion prior to application.

In some embodiments, molecules of the copper-based fungicide are entirely entrapped within the polyelectrolyte to form a macromolecular complex prior to application. In some embodiments, molecules of the copper-based fungicide are entirely entrapped within the polyanion to form a macromolecular complex prior to application In some embodiments, molecules of the bioactive ingredient which is copper-based fungicide are partially entrapped within the polyanion to form a macromolecular complex prior to application. In some embodiments, molecules of the bioactive ingredient which is copper-based fungicide are partially entrapped within the polyelectrolyte to form a macromolecular complex prior to application.

In some embodiments, molecules of the copper-based fungicide are entirely entrapped within the polyelectrolyte to form a macromolecular complex prior to application. In some embodiments, molecules of the copper-based fungicide are entirely entrapped within the polyanion to form a macromolecular complex prior to application. In some embodiments, molecules of the bioactive ingredient which is copper-based fungicide are partially entrapped within the polyanion to form a macromolecular complex prior to application. In some embodiments, molecules of the bioactive ingredient which is copper-based fungicide are partially entrapped within the polyelectrolyte to form a macromolecular complex prior to application.

The present invention also provides a method for pest control a plant disease caused

In some embodiments, at least 20% of the molecules of the copper-based fungicide are complexed by electrostatic interaction with the molecules of the polyelectrolyte prior to application. In some embodiments, at least 20% of the molecules of the copper-based fungicide are within the polyelectrolyte to form the complex prior to application.

The present invention also provides a method for pest control by preventive, curative or persistence treatments of a plant disease caused by phytopathogenic fungi comprising contacting a plant, a locus thereof or propagation material thereof with an effective amount of any one of the combinations, compositions, complexes, or delivery system disclosed herein.

The present invention also provides a method for pest control by preventive, curative and/or persistence treatment of a plant disease caused by phytopathologic fungi comprising contacting a plant, a locus thereof or propagation material thereof with an effective amount of any one of the herein disclosed macromolecular complexes comprising a copper-based fungicide.

The invention provides the use of a complex according to the invention for increasing uptake of a copper-based fungicide into a plant, increasing retention of a copper-based fungicide by a plant and/or increasing the bioavailability of a copper-based fungicide to a plant.

The invention provides the use of a macromolecular complex according to the invention for increasing uptake of a copper-based fungicide, into a plant, increasing retention of a copper-based fungicide by a plant and/or increasing the bioavailability of a copper-based fungicide to a plant.

The invention also provides the use of a polyelectrolyte for decreasing phytotoxicity of a copper-based fungicide.

The described (macromolecular) complexes, compositions and/or delivery systems may be applied to healthy or diseased plants. The described (macromolecular) complexes, compositions and/or delivery systems can be used on various plants including but not limited to crops, seeds, bulbs, propagation material, or ornamental species.

The present invention provides a method of controlling a disease caused by phytopathogenic fungi on plants or propagation material thereof, comprising contacting the plants, the locus thereof or propagation material thereof with at least one of the herein defined combination, matrix, compositions, or delivery systems.

The present invention provides a method for increasing the bioavailability of a copper-based fungicide, comprising interacting the copper-based fungicide with a polyelectrolyte to form a macromolecular matrix prior to application of the copper-based fungicide to a plant, plant part, and/or soil.

In some embodiments, the polyelectrolyte interacts with the copper-based fungicide by entrapping the copper-based fungicide partially or completely within the polyelectrolyte.

In some embodiments, the polyelectrolyte interacts with the copper-based fungicide by complexing or encapsulating the copper-based fungicide partially or completely within the polyelectrolyte.

The present invention provides use of any one of the combination, compositions described herein for the protection of a plant, or a part of a plant, against a pathogen.

In some embodiments, the composition is sprayed over a plant or a part of a plant.

In some embodiments, the plant part is leaf, seed or/and fruit.

In some embodiments, the combination, matrix, macromolecular complex, or composition is applied at an amount of 0.01-2 g/ha of the copper-based fungicide.

The present invention also provides a method of protecting a plant, or a part of a plant, against a pathogen, comprising contacting said plant, or part of said plant, with any one or any combination of the compositions described herein.

The present invention also provides a method of preventing, reducing and/or eliminating the presence of a pathogen on a plant, or a part of a plant, comprising contacting said plant, or part of said plant, with any one of the compositions described herein.

In some embodiments, the plant part is leaf, seed or/and fruit.

The present invention also provides a method of controlling diseases caused by phytopathogenic fungi in plants or on propagation material thereof which comprises contacting the plants, or propagation material thereof, with any one or any combination the compositions described herein.

The present invention also provides a method for reducing drift of a copper-based fungicide comprising interacting the copper-based fungicide with a polyelectrolyte to form a macromolecular complex prior to application of the copper-based fungicide to a plant, plant part, and/or soil.

The present invention also provides a method for increasing rainfastness of a copper-based fungicide comprising interacting the copper-based fungicide with a polyelectrolyte to form a macromolecular complex prior to application of the copper-based fungicide to a plant, plant part, and/or soil. The present invention also provides a method for increasing persistence of a copper-based fungicide comprising interacting the copper-based fungicide with a polyelectrolyte to form a macromolecular complex prior to application of the copper-based fungicide to a plant, plant part, and/or soil.

In some embodiments, the fungus is one of Leaf Blotch of Wheat (Mycosphaerella graminicola; anamorph: Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp.tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

In some embodiments, the macromolecular complex, composition and/or delivery system according to the invention is applied as a foliar application.

In some embodiments, the macromolecular complex, composition and/or delivery system according to the invention is applied as a soil application.

In some embodiments, the pesticide is applied at a rate effective for controlling a pest. In some embodiments, the pesticide is applied at a rate effective for preventing infestation of the pest. In some embodiments, the pesticide is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of the copper-based fungicide. In some embodiments, the method is effective for prolonging the pesticidal effect of the copper-based fungicide. In some embodiments, the method is effective for increasing uptake of the pesticide by the plant, increasing retention of the copper-based fungicide by the plant, and/or increasing the bioavailability of the copper-based fungicide to the plant.

In some embodiments, a method of the invention is effective for decreasing the half maximal effective concentration (EC50) of the copper-based fungicide. In some embodiments, the method is effective for decreasing the EC50 by at least 10%. In some embodiments, the method is effective for decreasing the EC50 by at least 25%. In some embodiments, the method is effective for decreasing the EC50 by at least 35%. In some embodiments, the method is effective for decreasing the EC50 by at least 50%.

In some embodiments, a method of the invention is effective for decreasing the LC50 of the copper-based fungicide. In some embodiments, the method is effective for decreasing the LC50 by at least 10%. In some embodiments, the method is effective for decreasing the LC50 by at least 25%. In some embodiments, the method is effective for decreasing the LC50 by at least 50%. In some embodiments, the method is effective for decreasing the LC50 by at least 75%. In some embodiments, the method is effective for decreasing the LC50 by at least 90%.

In some embodiments, a method of the invention is effective for decreasing the LC90 of the copper-based fungicide. In some embodiments, the method is effective for decreasing the LC90 by at least 10%. In some embodiments, the method is effective for decreasing the LC90 by at least 25%. In some embodiments, the method is effective for decreasing the LC90 by at least 50%. In some embodiments, the method is effective for decreasing the LC90 by at least 75%. In some embodiments, the method is effective for decreasing the LC90 by at least 90%.

In some embodiments, a method of the invention further comprises applying at least one additional agrochemical to a pest, a plant part, a plant, the locus, or propagation material thereof.

In some embodiments, a macromolecular complex, composition, or delivery system is tank mixed with an additional agrochemical. In some embodiments, the macromolecular complex, composition, or delivery system is applied sequentially with the additional agrochemical. In some embodiments, the macromolecular complex, composition, or delivery system is applied simultaneously with the additional agrochemical.

In some embodiments, the macromolecular complex, composition, or delivery system is tank mixed with an additional adjuvant. In some embodiments, the macromolecular complex, composition, or delivery system is applied sequentially with an additional adjuvant.

In some embodiments, the adjuvant is selected from group consisting of plant oil derivatives. In some embodiments, the plant oil derivative is a vegetable oil derivative. In some embodiments, the vegetable oil derivative is a soybean oil methyl ester.

In some embodiments, the combination, macromolecular complex, composition, or delivery system is tank mixed with an additional agrochemical. In some embodiments, the macromolecular complex, composition, or delivery system is applied sequentially with the additional agrochemical. In some embodiments, the macromolecular complex, composition, or delivery system is applied simultaneously with the additional agrochemical.

### Processes for Preparation

The present invention provides a process for preparation of a composition comprising a macromolecular complex comprising copper-based fungicides and polyelectrolyte, the process comprising preparing a solution of the antifreeze in water, adding the polyanion and polycation to form the polyelectrolyte complex, adding the dispersant and wetter, adding the copper-based fungicide, adding 80% of the antifoam agent, milling of the formulation to the desired particle size range, adding the remaining 20% of the antifoam agent, adding a solution of the rheology modifying agent in water and stirring until an homogeneous mixture is obtained.

The present invention provides a process for preparation of a composition comprising a macromolecular complex comprising copper-based fungicides and polyelectrolyte, the process comprising preparing a solution of antifreeze in water, adding the polyanion, adding the dispersant and wetter, adding the copper-based fungicide.

The present invention provides a process for preparation of a composition comprising a macromolecular complex comprising copper-based fungicides and polyelectrolyte, the process comprising preparing a solution of an antifreeze in water, adding the polyanion, adding the dispersant and wetter, adding the copper-based fungicide, adding 80% of the antifoam agent, milling of the formulation to the desired particle size range, adding the remaining 20% of the antifoam agent, adding a solution of the rheology modifying agent in water and stirring until an homogeneous mixture is obtained.

In some embodiments, the process comprises preparing a solution of the antifreeze in water, adding only the polyanion to the copper-based fungicide to form the macromolecular complex, adding the dispersant and wetter, adding 80% of the antifoam agent, milling of the formulation to the desired particle size range, adding the remaining 20% of the antifoam agent, adding a solution of the rheology modifying agent in water and stirring until an homogeneous mixture is obtained.

In some embodiments, the macromolecular complex is made by pre-mixing the polyelectrolyte and the copper-based fungicide prior to addition of the other additives, dispersant, wetter, antifoam, and rheology modifying agent.

In some embodiments, the macromolecular complex is made by premixing the polyelectrolyte with the dispersants prior to the addition of the cooper-based fungicide.

The invention provides a process for producing a macromolecular complex of the present invention, comprising the following steps:
(a) providing an aqueous composition of a polyelectrolyte,
(b) mixing a copper-based fungicide into the aqueous composition, and
(c) thereby producing a macromolecular complex of a polyelectrolyte and a copper-based fungicide in an aqueous composition.

In some embodiments, the process further comprises a step of milling or grinding the resultant macromolecular complex to reduce their particle size to any of the particle sizes described herein.

In some embodiments, the process further comprises milling or grinding the resultant macromolecular complex to reduce their particle size such that the particles have a d90 of 10 microns or less and a d50 of 5 microns or less.

The invention provides a process for producing a combination or composition described herein by mixing the macromolecular complex as described herein with at least one agriculturally acceptable additive.

In some embodiments, the macromolecular complex is made by pre-mixing the polyelectrolyte and the copper-based fungicide prior to addition of the other additive.

In some embodiments, the surfactants are added before adding the active ingredients.

In some embodiments, the composition comprises at least one additional fungicide.

The present invention provides a process for preparation of a composition comprising (1) a macromolecular complex comprising copper-based fungicides and polyelectrolyte and (2) an additional fungicide(s), the process comprising preparing a solution of antifreeze in water, adding the polyanion and polycation to form the polyelectrolyte complex, adding the dispersant and wetter, adding the copper-based fungicide, wherein the additional fungicide is added any time after the addition of the copper based fungicide.

The present invention provides a process for preparation of a composition comprising (1) a macromolecular complex comprising copper-based fungicides and a polyelectrolyte and (2) an additional fungicide(s), the process comprising preparing a solution of the antifreeze in water, adding a polyanion and a polycation to form the polyelectrolyte complex, adding the dispersant and wetter, adding the copper-based fungicide, adding 80% of the antifoam agent, milling of the formulation to the desired particle size range, adding the remaining 20% of the antifoam agent, adding a solution of the rheology modifying agent in water and stirring until an homogeneous mixture is obtained, wherein the additional fungicide is added any time after the addition of the copper based fungicide. In some embodiments, the process comprises preparing a solution of the antifreeze in water, adding only the polyanion to the copper-based fungicide to form the macromolecular complex, adding the dispersant and wetter, adding 80% of the antifoam agent, milling of the formulation to the desired particle size range, adding the remaining 20% of the antifoam agent, adding a solution of the rheology modifying agent in water and stirring until an homogeneous mixture is obtained, wherein the additional fungicide is added any time after the addition of the copper-based fungicide.

The present invention provides a process for preparation of a composition comprising macromolecular complex comprising copper-based fungicides and polyelectrolyte, the process comprising preparing a solution of the antifreeze in water, adding the polyanion, adding the dispersant and wetter, adding the copper-based fungicide, wherein the additional fungicide is added any time after the addition of the copper based fungicide.

The present invention provides a process for preparation of a composition comprising a macromolecular complex comprising copper-based fungicides and polyelectrolyte, the process comprising preparing a solution of antifreeze in water, adding a polyanion, adding dispersant and wetter, adding the copper-based fungicide, adding 80% of the antifoam agent, milling of the formulation to the desired particle size range, adding the remaining 20% of the antifoam agent, adding a solution of a rheology-modifying agent in water and stirring until a homogeneous mixture is obtained, wherein the additional fungicide is added any time after the addition of the copper-based fungicide.

The present invention provides a process for preparation of a composition comprising (1) a macromolecular complex comprising copper-based fungicides and a polyelectrolyte and optionally (2) at least one additional fungicide, the process comprising preparing a solution of antifreeze in water, adding a polyanion and a polycation to form the polyelectrolyte complex, adding dispersant and wetter, and adding the copper-based fungicide.

The present invention provides a process for preparation of a composition comprising (1) a macromolecular complex comprising copper-based fungicides and a polyelectrolyte and optionally (2) at least one addition fungicide, the process comprising preparing a solution of antifreeze in water, adding the polyanion, adding dispersant and wetter, and adding the copper-based fungicide.

In some embodiments, when the composition further comprises a water immiscible carrier (SE), the process further comprises mixing with an emulsifiable concentrate (EC) comprising the additional fungicide.

In some embodiments, the emulsifiable concentrate (EC) comprises a solution of azole, strobilurion and/or any other fungicide different from copper-based fungicide in a water immiscible carrier.

In some embodiments, the organic phase includes at least one water immiscible carrier.

In some embodiments, the water immiscible carrier is fatty acid amide.

In some embodiments, the organic phase includes at least one water immiscible carrier such as Armid DM10.

### Copper-Based Fungicides

In some embodiments, the copper-based fungicide is selected from the group consisting of copper hydroxide, copper oxychloride (tribasic), copper sulfate, copper gluconate, cuprous oxide, and any combination thereof.

In some embodiments, the copper-based fungicide is copper oxide. In some embodiments, the copper-based fungicide is copper oxychloride.

In some embodiments, the copper-based fungicide is CuSO₄·Cu(OH)₂·3CaSO₄ (equivalent to 66 g/L of Copper) (Bordeaux).

### Polyelectrolytes

Polyelectrolyte in the present application refer to polyanion and/or complex of polyanion and polycation.

Many different polyanions of both natural origins, for example xanthan gum, alginate, pectin, a lignin compound such as lignosulfonate, carrageenan, humic acid, fulvic acid, angico gum, gum Kondagogu, sodium alkyl naphtalene sulfonate, poly-γ-glutamic acid, maleic starch half-ester, carboxymethyl cellulose, chondroitin sulphate, dextran sulphate, and hyaluronic acid, and synthetic origin, for example poly(acrylic acid), polyphosphoric acid, and poly(L-lactide). Most preferably, said polyanion comprises or is lignosulfonate. The term “lignin compound” refers to a chemical compound that is derived from naturally occurring lignin or lignen by a process that includes sulphonation. The resulting sulfonic acids are strong acids and lignin compounds are therefore negatively charged at pH values below 7.

The polyelectrolyte as polyanion can be a mixture of two or more polyanions.

The polyelectrolyte as polyanion can be a mixture of two or more lignin compounds.

A preferred lignin compound is selected from Kraft lignin, organosolv lignin and/or lignosulfonate. A Kraft lignin is a polyphenols product from the Kraft pulping process for the conversion of wood into wood pulp. Included are derivatives from Kraft lignin obtained by oxidation or other chemical modification as is known to the skilled person.

An organosolv lignin is a polyphenolic product from delignification processes using organic solvents. Included are derivatives from organosolv lignin obtained by oxidation or other chemical modification as is known to the skilled person.

Lignosulfonate (also termed lignosulphonate, lignosulfate, lignin sulfonate, ligninsulfonate, ligninsulfonic acid, lignosulfonic acid, lignosulfuric acid, or LST 7) is a water-soluble anionic polymer which is, for example, formed as a by-product in the sulphite pulping process. Lignosulfonates generally have a wide molecular weight distribution, typically in the range of about 500 to about 150,000. Lignosulfonates may comprise different metal or ammonium ions as counter cations of the sulfonate groups such as, for example, copper, zinc, calcium, sodium, potassium, magnesium, and aluminum. Suitable examples of lignosulfonates comprise sodium lignosulfonate (e.g. sold as BORRESPERSE NAR, Borregaard LignoTech Ltd, Germany), calcium lignosulfonate (e.g. sold as BORRESPERSE CAR, Borregaard LignoTech Ltd, Germany), ammonium lignosulfonate, potassium lignosulfonate, modified lignosulfonate, derivatives of lignosulfonate, or mixtures thereof. Modified lignosulfonates, and derivatives of lignosulfonates are described in U.S. Pat. Nos. 3,639,263, 3,923,532, 4,006,779, 4,017,475, 4,019,995, 4,069,217, 4,088,640, 4,133,385, 4,181,652, 4,186,242, 4,196,777, 4,219,471, 4,236,579, 4,249,606, 4,250,088, 4,267,886, 4,269,270, 4,293,342 4,336,189, 4,344,487, 4,594,168, 4,666,522, 4,786,438, 5,032,164, 5,075,402, 5,286,412, 5,401,718, 5,446,133, 5,981,433, 6,420,602, and 7,238,645, which are incorporated herein by reference. A preferred lignin compound is lignosulfonate. A preferred lignosulfonate is copper-, zinc-, calcium-, sodium-, potassium-, ammonium-, magnesium- and/or aluminium-lignosulfonate, preferably calcium, sodium, potassium or ammonium lignosulfonate, most preferred calcium lignosulfonate.

The term chitosan relates to linear p-(1→4)-linked glucosamin and N-acetylglucosamin. It may be produced from chitin or its sodium salt (e.g. originating from shrimp) by treatment with aqueous sodium hydroxide at elevated temperatures, or by enzymatic treatment with, for example, a chitin deacetylase (EC 3.5.1.41). Further sources of chitin are fungi, including Basidiomycetes, Ascomycetes, and Phycomycetes, where it is a component of cell walls and structural membranes of mycelia, stalks, and spores. A most preferred chitosan is from fungi or derived from fungi.

The preferred MW of chitosan is 10-20 kDa. Using chitosan from with a higher MW of 20-30 kDa can cause differences in the physicochemical properties of the resultant compositions such as increase in viscosity or formation of aggregates.

In some embodiments, wherein the polyelectrolyte is complex of polyanion and polycation, polycation is selected from the group consisting of poly-L-lysine, epsilon-poly-L-lysine, poly-L-arginine, chitosan oligosaccharide, and chitosan. Most preferably, said polycation comprises or is chitosan. Typically, deacetylation as determined by colloidal titration is from 50 to 99.9%, preferably from 70 to 99.8% and most preferably from 90 to 99.7%, as compared to chitin. Chitosan derivatives can be prepared by reactions at the amino group (e.g. by N-acylation, formation of N-alkylidene and N-arylidene derivatives, N-alkylation and N-arylation) or at hydroxy groups, as is known to the skilled person.

A polycation preferably is or comprises cationic starch, poly(allylamine), chitosan, a chitosan derivative such as thiolated chitosan, 5-methyl-pyrrolidinone-chitosan, and chitosan oligosaccharide, epsilon-p-L-lysine, DEAE-dextran, or mixtures thereof, to form a polyelectrolyte complex with polyanion. Preferably, said polycation is selected from the group consisting of cationic starch, poly(allylamine), chitosan and chitosan derivatives. Preferably, said polycation is poly(allylamine). Preferably, said non-bioactive polycation is chitosan. In some embodiments, the polycation is chitosan (CTS), epsilon-poly-L-lysine (E-PLL), poly allyl amine (PAA), or any combination thereof. In some embodiments, the polycation is chitosan (CTS). In some embodiments, the polycation is poly allyl amine (PAA). In some embodiments, the polycation is epsilon-poly-L-lysine (E-PLL).

As used herein, the term “chitosan” refers to a linear polysaccharide composed of randomly distributed 6-(1-4)-linked D-glucosamine (deacetylated unit) and N-acetyl-D-glucosamine (acetylated unit). Chitosan is produced by deacetylation of chitin. The term “chitosan” relates to chitosan, chitosan derivatives and mixtures of chitosan and chitosan derivatives

The polyelectrolyte complex comprises a polyanion, such as a lignin-compound, xanthan gum and alginate, and a polycation, such as chitosan, in a relative amount of between 1:2 and 60:1 (w/w), more preferred between 1:1 and 50:1, more preferred between 2:1 and 30:1, such as about 6:1; about 5:1, about 4:1, (w/w). The relative amounts of polyanion, preferably a lignin compound, and a polycation, preferably chitosan, in a polyelectrolyte complex according to the invention is most preferred about 10:1, even more preferred about 5:1 (w/w).

In a watery solution at a pH of about 4.5, polycations such as chitosan polymers are positively charged and the cationic amino groups on the glucosamine subunits can interact electrostatically with anionic groups (usually carboxylic acid groups) of polyanions such as lignosulfonate to form polyelectrolyte complexes

Polyelectrolyte can be complex of mixture of two or more polyanion with a mixture of two or more polycation.

Polyelectrolyte can be complex of mixture of two or more lignin compound with a mixture of two or more chitosan.

In some embodiments, the composition is other than the SE composition exemplified in PCT International Application No. PCT/IB2021/061258.

In some embodiments, the composition is other than a composition consisting of:
a) Bordeaux mix,
b) picoxystrobin,
c) propylene glycol,
d) Metasperse 550 S,
e) Borresperse CA,
f) Geropon T-77,
g) Atlox 4894,
h) SAG 1572,
i) Proxel GXL,
j) DM water,
k) prothioconazole,
l) Armid DM 10,
m) Emulsogen TS 200,
n) TEA, and
o) Rhodopol 23 (2%).

In some embodiments, the composition is other than a composition consisting of:
a) 34.29% w/w of Bordeaux mix (9.4 at 27.22),
b) 2.78% w/w of picoxystrobin (2.7 at 97),
c) 5% w/w of propylene glycol,
d) 1% w/w of Metasperse 550 S,
e) 2.8% w/w of Borresperse CA,
f) 2% w/w of Geropon T-77,
g) 2% w/w of Atlox 4894,
h) 0.1% w/w of SAG 1572,
i) 0.05% w/w of Proxel GXL,
j) 36.86% w/w of DM water,
k) 3.06% w/w of prothioconazole,
l) 3.06% w/w of Armid DM 10,
m) 1.5% w/w of Emulsogen TS 200,
n) 0.5% w/w of TEA, and
o) 5% w/w of Rhodopol 23 (2%).

The present invention provides a suspoemulsion composition comprising (1) a copper-based fungicide, (2) a polyelectrolyte, (3) at least one additional fungicide selected from the group consisting of strobilurin fungicides, azole fungicides, benzamide fungicides, morpholines, QiI fungicides, SDHI and any combination thereof, (4) water, and (5) a water immiscible carrier, wherein the copper-based fungicide is suspended in the water and at least one additional fungicide is dissolved in the water immiscible carrier.

In some embodiments, the composition comprises two additional fungicides.

In some embodiments, the composition comprises two or more additional fungicide, at least on is dissolved in the water immiscible carrier and the other suspended in water and/or dissolved in the water immiscible carrier.

In some embodiments, the copper-based fungicide is selected from the group consisting of copper oxychloride, copper hydroxide, copper sulfate, and any combination thereof.

In some embodiments, the copper-based fungicide is copper sulfate.

In some embodiments, the polyelectrolyte is a complex of polycation and polyanion, the polyelectrolyte comprises at least one polyanion, or the polyelectrolyte is a polyanion.

In some embodiments, the polyanion is selected from the group consisting of xanthan gum, alginate, pectin, lignin compound, carrageenan, humic acid, fulvic acid, angico gum, gum Kondagogu, sodium alkyl naphtalene sulfonate, poly-γ-glutamic acid, maleic starch half-ester, carboxymethyl cellulose, chondroitin sulphate, dextran sulphate, and hyaluronic acid, and synthetic origin, for example poly(acrylic acid), polyphosphoric acid, poly(L-lactide), and any combination thereof.

In some embodiments, the polyelectrolyte comprises a lignin compound.

In some embodiments, the lignin compound is lignosulfonate.

In some embodiments, the polyelectrolyte is a complex of a polyanion and a polycation.

In some embodiments, the polycation is selected from the group consisting of poly-L-lysine, epsilon-poly-L-lysine, poly-L-arginine, polyallylamine, chitosan oligosaccharide, chitosan, and any combination thereof.

In some embodiments, the polycation is chitosan.

In some embodiments, the polyelectrolyte is a polyanion and is substantially free or free of a polycation.

In some embodiments, the weight ratio between the polyelectrolyte and the metallic copper in the copper-based fungicide is between 1:10 to 1:1.

In some embodiments, the weight ratio between the polyelectrolyte and the metallic copper in the copper-based fungicide is 1:3.5.

In some embodiments, the weight ratio between the polyelectrolyte and the metallic copper in the copper-based fungicide in the combination and/or composition described herein is 1:4.4.

In some embodiments, the concentration of copper-based fungicide in the composition is between 20% to 35% by weight based on the total weight of the composition.

In some embodiments, the concentration of additional fungicide in the composition is between 3-8% by weight based on the total weight of the composition.

In some embodiments, the concentration of the polyelectrolyte in the composition is 0.01-10% by weight based on the total weight of the composition.

In some embodiments, the concentration of the polyelectrolyte in the composition is about 3% by weight based on the total weight of the composition.

In some embodiments, the composition comprises an agriculturally acceptable additive selected from the group consisting of agriculturally acceptable carriers, buffers, acidifiers, defoaming agents, thickeners, drift retardants, surfactant, pigments, wetting agents, safeners, preservatives, and any combination thereof.

In some embodiments, the composition comprises 40-80% by weight of water.

In some embodiments, the composition comprises at least one dispersant.

In some embodiments, the composition comprises at least one anionic dispersant and at least one non-ionic surfactant.

In some embodiments, the concentration of the dispersant(s) in the composition is 0-15% by weight based on the total weight of the composition.

In some embodiments, the composition comprises at least one anti-foaming agent.

In some embodiments, the anti-foaming agent is silicone-based.

In some embodiments, the additional fungicides in the composition are prothioconazole and picoxystrobin fungicides.

In some embodiments, the composition has viscosity in the range of 1500-1800 cPs (measured with a Brookfield spindle 63 at 12 rpm).

In some embodiments, the composition comprises particles with a particle size distribution (d90) is 10 microns or less.

In some embodiments, the composition has a pH in the range of 5.0-7.5.

In some embodiments, the composition has a density (g/ml) of 1.26=0.05 at 25° C.

The present invention also provides a method of treating a plant, or a part of a plant, against a pathogen, comprising contacting the plant, or part of the plant, with an effective amount of the combination, composition, or delivery system of the invention so as to thereby treat the plant or part of the plant against the pathogen.

In some embodiments, treating comprises preventing, reducing and/or eliminating the presence of the pathogen on the plant, or part of the plant.

In some embodiments, treating comprises controlling diseases caused by the pathogen.

In some embodiments, treating comprises prolonging the controlling effect of the copper-based herbicide.

In some embodiments, the combination, composition, or delivery system is applied at an amount between 0.001 g/ha to 1000 g/ha of copper metal.

In some embodiments, the combination, composition, and/or delivery system is applied at an amount of about 0.0022 g/ha, 0.022 g/ha, 0.22 g/ha, 2.2 g/ha or 22 g/ha of copper metal.

In some embodiments, the combination, composition, and/or delivery system is applied at an amount of about 0.0075 g/ha, 0.075 g/ha, 0.75 g/ha, 7.5 g/ha or 75 g/ha of copper metal.

In some embodiments, the combination, composition, and/or delivery system is applied at an amount of about 0.0052 g/ha, 0.001 g/ha, 0.059 g/ha, or 0.0095 g/ha of copper metal.

In some embodiments, the combination, composition, and/or delivery system is applied at an amount of about 15 g/ha, 150 g/ha, 375 g/ha, 450 g/ha, or 750 g/ha of copper metal.

The present invention also provides a method of promoting growth of a crop plant in the presence of a pathogen comprising contacting the plant, or part of the plant, with an effective amount of the combination, composition or delivery system of the invention so as to thereby promote the growth of the crop plant treat than if the same type and amount of copper base fungicide is formulated in the absence of polyelectrolyte.

In some embodiments, the method is effective for improving plant vigor and/or increasing crop yield.

The present invention provides a pesticidal delivery system comprising the combination or composition described herein.

The present invention provides a method of treating a plant, or a part of a plant, against a pathogen, comprising contacting the plant, or part of the plant, with an effective amount of any one of the combination, composition or delivery system described herein so as to thereby treat the plant or part of the plant against the pathogen.

The present invention provides a method of promoting growth of a crop plant in the presence of a pathogen comprising contacting the plant, or part of the plant, with an effective amount of any one of the combination, composition or delivery system described herein so as to thereby promote the growth of the crop plant treat than if the same type and amount of copper base fungicide is formulated in the absence of polyelectrolyte.

The present invention provides a method for improving efficacy of a copper-based fungicide comprising interacting the copper-based fungicide with a polyelectrolyte prior to application of the copper-based fungicide to a plant, a plant part, and/or soil.

The present invention provides a method for controlling the release rate of copper cation from a copper-based fungicide comprising interacting the copper-based fungicide with a polyelectrolyte prior to application of the copper-based fungicide to a plant, a plant part, and/or soil.

The present invention provides a method for (i) increasing biological activity of a copper-based fungicide on a target, (ii) increasing persistence of a copper-based fungicide into a target, (iii) increasing retention of a copper-based fungicide by a target, (iv) increasing absorbance of a copper-based fungicide by a target, or (v) increasing or enhancing bioavailability of a copper-based fungicide to a target, wherein the method comprises interacting the copper-based fungicide with a polyelectrolyte prior to application of the copper-based fungicide to a plant, a plant part, and/or soil.

The present invention provides a method for (i) reducing drift of a copper-based fungicide, (ii) increasing leaf adhesion of a copper-based fungicide, (iii) increasing rainfastness of a copper-based fungicide, (iv) increasing persistence of a copper-based fungicide, and/or (v) reducing phytotoxicity of a copper-based fungicide, wherein the method comprises interacting the copper-based fungicide with a polyelectrolyte prior to application of the copper-based fungicide.

The present invention provides a process for producing a macromolecular complex comprising a copper-based fungicide and a polyelectrolyte comprising the following steps:
(a) providing an aqueous composition of the polyelectrolyte,
(b) mixing the copper-based fungicide into the aqueous composition, and
(c) thereby producing the macromolecular complex of the polyelectrolyte and the copper-based fungicide in an aqueous composition.

The present invention provides a process for preparing the composition described herein comprising mixing the macromolecular complex with at least one agriculturally acceptable additive.

When lists are provided, the list is to be considered as a disclosure of each member in the list, independently.

This invention will be better understood by reference to the Experimental Details which follow, but those skilled in the art will readily appreciate that the specific experiments detailed are only illustrative of the invention as described more fully in the claims which follow thereafter.

The invention is illustrated by the following examples without limiting it thereby.

### EXPERIMENTAL SECTION

### Example 1

### Method:

Young cucumbers transplants (2 weeks, “Oz”) are re-plant in pots at the greenhouse (20-25° C., RH ˜50%) for 14 days.

Application of azole fungicide in presence and in absence of thiourea, using air sprayer.

The plants are grown at the greenhouse (same conditions) for additional 8 days.

Phytotoxicity assessments at 1, 2 and 3 DAA.

The leaf damage (% necrosis) is measured.

Test 1. Prothioconazole in presence of thiourea as tank mix and in absence of thiourea

Rate of application of the prothioconazole is 80 g a.i/ha

Thiourea rate is 11.26 g/ha

Material: prothioconazole SC480 (Proline® 480 SC)

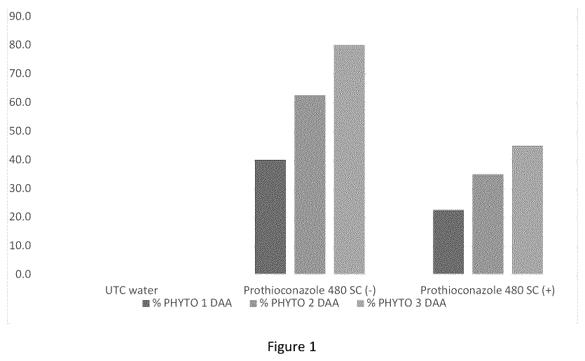

As disclosed in FIG. 1, the phytotoxicity of the thiourea-prothioconazole tank mix is significantly lower than the phytotoxicity of the prothioconazole alone.

Test 2. compositions comprising copper oxychloride, prothioconazole and picoxystrobin suspoemulsion (i) with thiourea as ready mix and (ii) free of thiourea

TABLE 1
Copper oxychloride (COC) 167 g/l, Prothioconazole
53 g/l, Picoxystrobin 47 g/l Suspoemulsion

| Material | % w/w |
|---|---|
| COC | 22.74 |
| prothioconazole | 4.1 |
| picoxystrobin | 3.67 |
| Chitosan | 0.2 |
| Borreseperse CA | 1.87 |
| Acetic acid | 0.45 |
| Sodium acetate | 2.54 |
| SAG 1572 | 0.2 |
| Thiourea | 0.35 |
| poly agro A | 5.0 |
| Propylene Glycol | 3.0 |
| Van Gel B | 0.3 |
| AG-RH 23 | 0.2 |
| Soft water | 35.63 |
| NOP | 2.64 |
| Agnique BP 420 | 1 |
| Soprophor TS/16 | 2.02 |
| Synergen SOC | 0.66 |
| Acetophenone | 13.22 |

TABLE 2
COC 167 g/l, Prothioconazole 53 g/l,
Picoxystrobin 47 g/l Suspoemulsion

| Material | % w/w |
|---|---|
| COC | 22.74 |
| Prothioconazole | 4.1 |
| Picoxystrobin | 3.67 |
| Chitosan | 0.2 |
| Borreseperse CA | 1.87 |
| Acetic acid | 0.45 |
| Sodium acetate | 2.54 |
| SAG 1572 | 0.2 |
| Poly Agro A | 5.0 |
| Propylene Glycol | 3.0 |
| Van Gel B | 0.3 |
| AG-RH 23 | 0.2 |
| Soft water | 35.98 |
| NOP | 2.64 |
| Agnique BP 420 | 1 |
| Soprophor TS/16 | 2.02 |
| Synergen SOC | 0.66 |
| Acetophenone | 13.22 |

### Material:

PolyAgro A-PolyAgro A is a di-block copolymer, with a total weight of 17000 g/mol, composed of a hydrophobic block (Anchor block-ANCHOR) and a hydrophilic block (Stabilizing block-STAB). The stabilizing, hydrophilic, block is made of sodium 2-Acryloylamino-2-methylpropane-1-sulfonate (AMPS) monomers, which are 77% of the overall monomers in the polymer. The other 23% of the monomers belongs to the anchor, hydrophobic, block which is made of ethyl acrylate monomers. The total amount of monomers in the polymer (degree of polymerization, DPn) is 85 monomers.

This polymer may be obtained according to the following procedure.

### a) Macro CTA

Into a 2L double jacketed reactor equipped with mechanical agitator and reflux condenser was added 11.26 g of O-ethyl-S-(1-methoxycarbonylethyl) xanthate (CH3CH(CO2CH3))S(C═S)Oet), 264.08 g of Ethanol, and 356.32 g of De-ionized water and 1400 g of AMPS (Na) solution (50% active) and 1.52 g of 4,4′-Azobis(4-cyanopentanoic acid). The reactor contents were heated to 70° C. under agitation and nitrogen. The reaction mixture was aged at 70° C. for a further hour whereupon it was cooled to ambient temperature and discharged. The measured solids content was 37.6% (115° C., 60 mins). GPC Mals: Mn=16300 Mw=2600 IP=1.6.

### b) Chain Extension

Into a 5L double jacketed reactor equipped with mechanical agitator and reflux condenser was added 2127 g of macro CTA solution (see a) and 330 g of de-ionized water. The reactor contents were heated to 70° C. under agitation and a nitrogen stream. Once 70° C. was reached, 106.67 g of ethyl acrylate (EA) was added over 2H00 and a 37.37 g of a solution of 10 wt % of 4,4′-Azobis(4-cyanopentanoic acid) was concomitantly added over 2 h30. After the end of the introduction of the initiator solution, the reaction solution was further aged for one hour. Thereafter a shot of 44.85 g of a 10 wt % solution of 4,4′-Azobis(4-cyanopentanoic acid) was added and the mixture aged at 70° C. for a further hour whereupon it was cooled to ambient temperature and discharged. The measured solids content was 40.0% (115° C., 60 mins).

Ethanol was removed from the polymer solution using a rotary evaporator. Water was back added to achieve a polymer solution with a final solids content of 40.4%.

2600 g of polymer solution was placed in a 5L double jacketed reactor equipped with mechanical agitator and reflux condenser. The pH of the solution was increased to 8,5 using a 50% solution of NaOH. The mixture was heated to 70° C. with stirring whereupon 48.4 of a 30% solution of hydrogen peroxide was added in 1 hour. At the end of the additions, the solution was aged for a further 3 h00 whereupon it was cooled and discharged.

The residuals monomers were measure by HPLC and GC (AMPS=22 ppm, EA=2 ppm).

The measured solids content was 37.5%. The polymer is used in the composition of the present invention as a ready aqua polymer solution at concentration of about 30% w/w.

TABLE 3
PolyAgro A

| | | | | Total | STAB | ANCHOR | | |
|---|---|---|---|---|---|---|---|---|
| AMPS | EA | AMPS | EA | Mnth | Mnth | Mnth | Dpn | Dpn |
| (mol %) | (mol %) | (wt %) | (wt %) | (g/mol) | (g/mol) | (g/mol) | STAB | ANCHOR |
| 77 | 23 | 88 | 12 | 17000 | 15000 | 2000 | 65 | 20 |

### Preparation Process

### Part A:

Mix Acetophenone and Agsolex 8. Add Prothioconazole and Picoxystrobin and mix well until full dissolution.

Add Agnique BP 420, Synergen SOC and Soprophor TS/16 and mix well until full dissolution.

### Part B

Dissolving Acetic acid and Sodium acetate in water. Adding Propylene Glycol and mix.

Add Borreseperse CA and mix. Add Chitosan and mix until full dissolution.

Add SAG 1572 and mix.

Add Polyagro A and mix. Add Cooper Oxychloride tech and mix. Add Thiourea (as a mixture with water (0.35:3) and mix

### SE Preparation:

Add the EC (A) to the water phase (part B) and perform High Shear.

Add the required amount of 10% Van Gel B and 2% AgRH.

SC compositions comprising COC 167 g/l, Prothioconazole 53 g/l, picoxystrobin 47 g/l with and without thiourea were also prepared.

To evaluate the phytotoxicity of the compositions the appearance on cucumber plants following foliar application of Copper+Picoxystrobin+Prothioconazole mixtures was compared.

Growth conditions: Young cucumbers transplants (2 weeks, “Oz”) were re-planted in pots in a greenhouse (20-25° C., RH ˜50%) for 14 days. After the formulations' application with air sprayer at, plants were grown at the greenhouse (same conditions) for an additional 8 days.

Phytotoxicity assessments were done at 1 & 3 DAA.

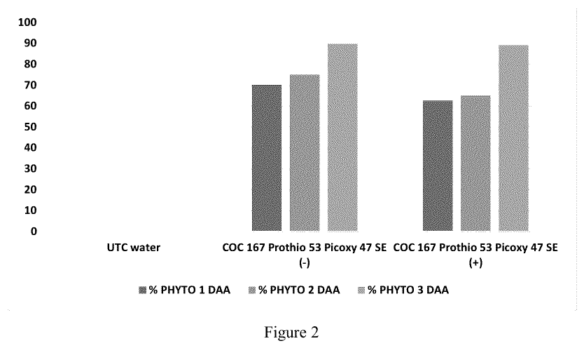

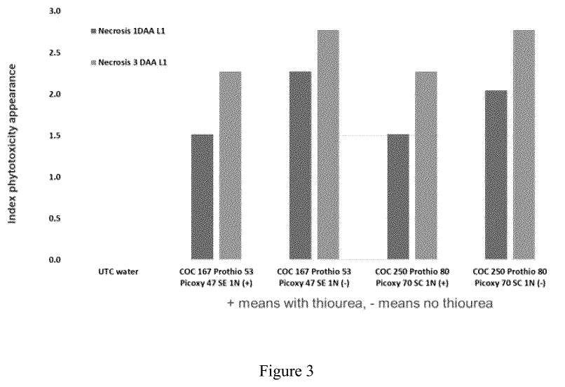

The phytotoxicity of the thiourea containing SE appears lower than the phytotoxicity of the SE without the thiourea (FIG. 2). It also appears that the type of formulation (SE or SC) has No Impact on the Phytotoxicity of the Compositions (FIG. 3).

### Example 2. Phytotoxicity Assessment of SE Compositions with and without Thiourea

TABLE 4
DT-CE-CPP-200-47T

| Ingredient | Chemical Name | v/w | w/w |
|---|---|---|---|
| Bordeaux | A mixture, with or without | 424.12 | 30.08 |
| mixture tech | stabilizing agents, of calcium | | |
| | hydroxide and copper(II) sulfate | | |
| | (but see Composition) | | |
| Picoxystrobin | methyl I-3-methoxy-2-[2-(6- | 38.2 | 2.71 |
| tech | trifluoromethyl-2- | | |
| | pyridyloxymethyl)phenyl]acrylate | | |
| Prothioconazole | 2-[(2RS)-2-(1- | 43.6 | 3.1 |
| | chlorocyclopropyl)-3-(2- | | |
| | chlorophenyl)-2-hydroxypropyl]- | | |
| | 2H-1,2,4-triazole-3(4H)-thione | | |
| AG-RH 23 | Xanthan Gum | 2.8 | 0.2 |
| ATLAS G- | oxirane, monobutyl ether | 14.1 | 1 |
| 5002L-LQ- | | | |
| (CQ) | | | |
| Atlox | Modified styrene acrylic polymer | 14.1 | 1 |
| Metasperse | | | |
| 500L-LQ-RB | | | |
| GEROPON T | (A)sodium 2- | 28.2 | 2 |
| 77 | [methyloleoylamino]ethane-1- | | |
| | sulphonate, (B)N-methyltaurine, | | |
| | (C) sodium N-methyltaurinate | | |
| Glycerine | Glycerine | 140.8 | 10 |
| Proxel GXL | (A) 1,2-Benzisothiazol-3(2H)- | 0.3 | 0.02 |
| | one, (B) Sodium hydroxide | | |
| RHODIASOLV | N,N-dimethyldecan-1-amide | 49.3 | 3.5 |
| ADMA 10 | | | |
| SAG 1572 | Sodium hydroxide | 1.4 | 0.1 |
| Soprophor BSU | Poly(oxy-1,2-ethanediyl), .alpha.- | 14.1 | 1 |
| | [tris(1-phenylethyl)phenyl]-.omega.- | | |
| | hydroxy | | |
| Thiourea | Thiourea, Thiocarbamide, | 5.6 | 0.4 |
| | NH2CSNH2 | | |
| Borresperse CA | Calcium lignosulfonate | 39.2 | 2.8 |
| Water soft | water | Up to | Up to |
| | | 1000 L | 100% |

TABLE 5
DT-CE-CPP-400-49T

| Ingredient | Chemical Name | v/w | w/w |
|---|---|---|---|
| Copper | dicopper chloride trihydroxide | 439 | 31.36 |
| oxychloride | (approximate composition) | | |
| tech | | | |
| Picoxystrobin | methyl I-3-methoxy-2-[2-(6- | 70 | 5 |
| tech | trifluoromethyl-2- | | |
| | pyridyloxymethyl)phenyl]acrylate | | |
| Prothioconazole | 2-[(2RS)-2-(1-chlorocyclopropyl)-3- | 80 | 5.71 |
| | (2-chlorophenyl)-2-hydroxypropyl]- | | |
| | 2H-1,2,4-triazole-3(4H)-thione | | |
| AG-RH 23 | Xanthan Gum | 2.1 | 0.15 |
| Borresperse CA | (Calcium lignosulfonate, Calcium | 39.2 | 2.8 |
| | lignosulfonate | | |
| Chitosan | | 4.4 | 0.31 |
| Ecosurf EH-6 | 2-Ethyl Hexanol EO-PO Nonionic | 12 | 0.86 |
| Surfactant | Surfactant | | |
| Propylene | 1,2 propanediol | 50 | 3.57 |
| glycol | | | |
| Proxel GXL | (A) 1,2-Benzisothiazol-3(2H)-one, | 0.2 | 0.02 |
| | (B) Sodium hydroxide | | |
| Silcolapse 426R | Dimethyl siloxanes & silicones, (A) | 5 | 0.36 |
| | (1,2-benzisothiazol-3(2H)-one; 1,2- | | |
| | benzisothiazolin-3-one < 0.05) | | |
| Tergitol XD | (A)Polyalkylene glycol monobutyl | 70 | 5 |
| | ether, (B)Polyalkylene glycol, | | |
| | (C)Poly(ethylene oxide), | | |
| | (D)Polypropylene glycol | | |
| Trisodium | Citric acid trisodium salt | 36 | 2.57 |
| citrate | | | |
| water | water | 102.7 | 7.34 |
| Water soft | water | Up to | Up to |
| | | 1000 L | 100% |

TABLE 6
SE composition comprising copper oxychloride, picoxystrobin
and prothioconazole. (DT-CE-CPP-267-50T)

| Ingredient | Chemical Name | v/w | w/w |
|---|---|---|---|
| Copper | dicopper chloride trihydroxide | 293 | 22.89 |
| oxychloride | (approximate composition) | | |
| tech | | | |
| Picoxystrobin | methyl I-3-methoxy-2-[2-(6- | 47 | 3.67 |
| tech | trifluoromethyl-2- | | |
| | pyridyloxymethyl)phenyl]acrylate | | |
| Prothioconazole | 2-[(2RS)-2-(1-chlorocyclopropyl)-3- | 53 | 4.14 |
| | (2-chlorophenyl)-2-hydroxypropyl]- | | |
| | 2H-1,2,4-triazole-3(4H)-thione | | |
| Acetic Acid | Acetic Acid | 5.8 | 0.45 |
| Acetophenone | Acetophenone | 169.2 | 13.22 |
| AG-RH 23 | Xanthan Gum | 2.6 | 0.2 |
| Agnique BP | Alcohols, C16-18, ethoxylated | 12.8 | 1 |
| 420 | propoxylated | | |
| Agsolex 8 | (A) 1-octylpyrrolidine-2-one, (B) | 33.8 | 2.64 |
| | Octylamine, (C) Dioctylamine, (D) | | |
| | gama-Butyrolactone | | |
| Borresperse CA | (A) Calcium lignosulfonate, (B) | 23.9 | 1.87 |
| | Water | | |
| Chitosan | | 2.6 | 0.2 |
| POLYAGRO A | | 64 | 5 |
| Propylene | 1,2 propanediol | 38.4 | 3 |
| glycol | | | |
| Proxel GXL | (A) 1,2-Benzisothiazol-3(2H)-one, | 0.3 | 0.02 |
| | (B) Sodium hydroxide | | |
| SAG 1572 | Sodium hydroxide | 2.6 | 0.2 |
| sodium acetate | | 32.5 | 2.54 |
| Soprophor | Poly(oxy-1,2-ethanediyl), .alpha.- | 25.9 | 2.02 |
| TS/16 | phenyl-.omega.-hydroxy-, styrenated | | |
| Synergen SOC | Poly(oxy(methyl-1,2- | 8.5 | 0.66 |
| | ethanediyl)), .alpha.-hydro-.omega.- | | |
| | hydr oxy- | | |
| Thiourea | | 4.5 | 0.35 |
| Van Gel B | smectite clay | 3.8 | 0.3 |
| water | water | 125.2 | 9.78 |
| water | water | Up to | Up to |
| | | 1000 L | 100% |

SE compositions comprising copper oxychloride, picoxystrobin and prothioconazole composition a-c:

TABLE 7
SE composition of Bordeaux mixture + Prothioconazole +
Picoxystrobin.

| Ingredients | % w/w |
|---|---|
| Bordeaux Mixture | 34.53 |
| Picoxystrobin | 2.70 |
| Propylene Glycol | 5.00 |
| Geropon T-77 | 2.00 |
| Borresperse CA | 1.00 |
| Atlox Metasperse 500L | 1.00 |
| Atlox 4894 | 3.00 |
| SAG 1572 | 0.10 |
| Proxel GXL | 0.10 |
| ethylene diamine 2% (a), or thiourea 0.32% (b) or | |
| mixture of sodium thiosulphate and thiourea 1% + | |
| 0.5% (c) | |
| Prothioconazole | 3.00 |
| Rhodiasolv ADMA 10 | 3.00 |
| Emulsogen TS 200 | 1.50 |
| Agrhopol 23 | 0.20 |
| Water | QS |
| | 100.00 |

### Preparation Process

### SC Preparation:

The required quantity of DM water was taken in the beaker followed by addition of proxel GXL, propylene glycol, Atlox 4894, Borosperse CA, Geropon T77, Metasperse 500L, and ⅓^{rd} part of SAG 1572 with continuous stirring at 350-500 rpm using pitched four blade impeller.

Later Bordeaux mixture is added slowly and mixed well with stirring at 350-500 rpm using pitched four blade impeller until homogeneous slurry is obtained.

Then picoxystrobin technical is added slowly and mixed well with stirring at 350-500 rpm using pitched four blade impeller until homogeneous slurry is obtained.

The above premix was grinded in bead mill to attain particle size D90<4 micron

The grinded premix was further stirred at 350-500 rpm using pitched four blade impeller for another 30 minutes after milling.

Compound (I) (ethylene diamine, thiourea or mixture of sodium thiosulphate and thio urea) was dissolved in water and added to the above SC part and mixed well for 5 minutes.

### Preparing the Emulsifiable Concentrate (EC) Comprising Azole Fungicide:

The required quantity of solvent (ADMA10) was taken in a beaker and Prothioconazole technical was added and dissolved.

The emulsifier Emulsogen TS200 was added to the above solution and stirred well at 350-500 rpm using pitched four blade impeller until clear solution is obtained.

### Preparation of Suspoemulsion—SE:

EC part was added slowly for 15-20 min under stirring using pitched four blade impeller at 800-1000 rpm to the SC part prepared earlier.

Increase in viscosity was observed during mixing due to emulsification of EC part with aqueous part of SC.

Stirring was continued for about 30 min and the remaining quantity of SAG 1572 was added. The suspoemulsion obtained was mixed for another 15 minute.

The required quantity of 4% solution of Aghropol 23 was added and stirred well to obtain final suspoemulsion formulation.

The phytotoxicity of SE composition 49T (without thiourea) has been found to be higher than that of compositions 47T and 50T (with thiourea)

### Example 3. Suspoemulsion (SE) Composition with Triethanolamine

TABLE 8

| | | % w/w |
|---|---|---|
| No. | Ingredients | (Batch # SE-07DA) |
| 1 | Bordeaux Mixture | 34.29 |
| 2 | Picoxystrobin | 2.78 |
| 3 | Propylene Glycol | 5.00 |
| 4 | Metasperse 550 S | 1.00 |
| 5 | Borresperse CA | 2.80 |
| 6 | Geropon T-77 | 2.00 |
| 7 | Atlox 4894 | 2.00 |
| 8 | SAG 1572 | 0.10 |
| 9 | Proxel GXL | 0.05 |
| 10 | DM water | 41.66 |
| 11 | Thio urea | 0.35 |
| 12 | Prothioconazole | 3.06 |
| 13 | Armid DM 10 | 3.06 |
| 14 | Emulsogen TS 200 | 1.50 |
| 15 | Tri ethanol amine | 0.25 |
| 16 | Rhodopol 23 | 0.095 |

### Preparation Process of the SE Formulation:

### SC Preparation:

The required quantity of DM water was taken in the beaker followed by addition of proxel GXL, propylene glycol, Atlox 4894, Borosperse CA, Geropon T77, Metasperse 550S, and ⅓^{rd} part of SAG 1572 with continuous stirring at 350-500 rpm using pitched four blade impeller.

Then, Bordeaux mixture was added slowly and mixed well with stirring at 350-500 rpm using pitched four blade impeller until homogeneous slurry was obtained.

Then, picoxystrobin technical was added slowly and mixed well with stirring at 350-500 rpm using pitched four blade impeller until homogeneous slurry was obtained.

The above premix was grinded in bead mill to attain particle size D90<4 micron.

The grinded premix was further stirred at 350-500 rpm using pitched four blade impeller for another 30 minutes after milling.

### EC Preparation:

The required quantity of solvent (Armid DM10) was taken in a beaker and Prothioconazole technical was added and dissolved.

The emulsifier Emulsogen TS200 was added to the above solution and stirred well at 350-500 rpm using pitched four blade impeller until clear solution is obtained.

### Preparation of SE:

EC part was added slowly for 15-20 min under stirring using pitched four blade impeller at 800-1000 rpm to the SC part prepared earlier.

Increase in viscosity was observed during mixing due to emulsification of EC part with aqueous part of SC.

Stirring was continued for about 30 min and the remaining quantity of SAG 1572 was added. The suspoemulsion obtained was mixed for another 15 minute.

The pH of the above mixture was adjusted to be around 6-7 using Triethanol amine.

The required quantity of 2% or 4% solution of Aghropol 23/Rhodopl 23 was added with stirring at 350-500 rpm using pitched four blade impeller to get final viscosity about 1200-1400 cPs when measured with Spindle 62 at 12 RPM.

### Example 4—Suspoemulsion (SE) Composition with Thiourea

TABLE 9

| | | % w/w |
|---|---|---|
| No. | Ingredients | (Batch # 044) |
| 1 | Bordeaux mixture | 35.49 |
| 2 | DM water | 39.72 |
| 3 | Picoxystrobin | 2.80 |
| 4 | Prothioconazole | 3.16 |
| 5 | Rhodiasolv Adma 10 | 3.50 |
| 7 | Geropon T-77 | 2 |
| 8 | Soprophor BSU | 1 |
| 9 | Atlox Metasperse 500L | 1 |
| 10 | Atlas G5002L | 1.00 |
| 11 | SAG 1572 | 0.1 |
| 12 | Glycerol | 10 |
| 13 | Proxel GXL | 0.02 |
| 14 | Rhodopol 23 | 0.2 |
| 15 | Thiourea | 0.4 |
| | | 100.00 |

### Example 5—Suspoemulsion (SE) Composition with Thiourea

TABLE 10

| | | % w/w |
|---|---|---|
| No. | Ingredients | (Batch # 043) |
| 1 | Bordeaux mixture | 35.49 |
| 2 | Borresperse CA | 2.80 |
| 3 | DM water | 37.62 |
| 4 | Picoxystrobin | 2.80 |
| 5 | Prothioconazole | 3.16 |
| 7 | Rhodiasolv Adma 10 | 3.50 |
| 8 | Geropon T-77 | 1 |
| 9 | Soprophor BSU | 1 |
| 10 | Atlox Metasperse 500L | 1 |
| 11 | Atlas G5002L | 1.00 |
| 12 | SAG 1572 | 0.1 |
| 13 | Glycerol | 10 |
| 14 | Proxel GXL | 0.02 |
| 15 | Rhodopol 23 | 0.1 |
| 16 | Thiourea | 0.4 |
| | | 100.00 |

### Preparation Process of the SE Formulations of Examples 4 and 5

### Part (A) SC Slurry/Premix Preparation:

The SC portion premix was by prepared by adding Glycerol, defoamer SAG 1572, Atlas G5002L, Atlox Metasperse 500L, partial amount of water and stirred well. Geropon T-77, calcium lignosulphonate (if required) were added and continued stirring to avoid any lump formation. Bordeaux mixture was added to slowly, followed by picoxystrobin. This slurry was mixed and stirred for 30 minutes and milled further in the bead mill at temperature less than 25 C to obtain particle size less than 7 micron.

### Part (B) EW Preparation:

Prothioconazole Tech was added into required quantity of solvent Adma 10 followed by addition of emulsifier Soprophor BSU to obtain clear EC solution. This EC was further mixed slowly into water containing thiourea and stirred well to obtain white milky homogeneous EW.

### Part (C) Suspoemulsion Preparation:

The EW prepared in previous step was added to the slurry/premix very slowly to obtain mixture which changes from Bluish green→Gray→Bluish green on stirring for 30-45 minutes. This was further homogenized at temperature less than 30° C. to obtain flowable mixture and required quantity of 2% aqueous rheology modifier, xanthan gum was added and stirred for 1 hour to obtain final suspoemulsion formulation.

The suspoemulsion composition of the present invention have less than 5% of phase separation during storage (at room temperature for two weeks or at 54° C. for two week) based on visual observation.

### Example 6: SE Composition of Bordeaux Mixture+Prothioconazole+Picoxystrobin

TABLE 11
Composition with Thiourea

| Ingredients | % w/w |
|---|---|
| Bordeaux Mixture | 34.53 |
| Picoxystrobin | 2.70 |
| Glycerol | 10.00 |
| Geropon ® T-77 | 2.00 |
| Atlox Metasperse ™ 500L | 1.00 |
| ATLAS G5002L | 1.00 |
| SAG 1572 | 0.10 |
| Proxel GXL | 0.02 |
| Prothioconazole | 3.00 |
| Rhodiasolv ® Adma 10 | 3.50 |
| Soprophor BSU | 1.00 |
| Rhodopol AgrhO 23 | 0.20 |
| Thiourea | 0.40 |
| Water | 40.95 |
| | 100.00 |

### Example 7. Copper-Based Fungicide-Polyelectrolyte Compositions

Polyelectrolyte, polyanion (A) and a complex of polyanion and polycation (B) were tested in the experiments described herein below: chitosan (CTS), lignosulfonate as polyelectrolytes, in combination with copper-based fungicide.

The general procedure for formulating copper-based fungicide-polyelectrolyte composition involves the following steps:
Addition of the antifreeze agent (for example propylene glycol) to the water
Addition of the polycation (for example chitosan)
Addition of the polyanion (for example calcium lignosulfonate)
Addition of the dispersant (for example Metasperse 500L) and wetter (for example Atlas G5002L) agents
Addition of copper-based fungicide
Addition of 80% of the antifoam agent (for example Silicolapse 426R)
Milling of the formulation to the desired particle size range
Addition of 20% of the antifoam agent (for example Silicolapse 426R)
Addition of a solution of the rheology modifying agent in water (for example xanthan gum) and stirring until a homogeneous mixture is obtained

The general procedure for preparing a composition comprising copper-based fungicide and polyelectrolyte, wherein the polyelectrolyte is a complex of polycation and polyanion, is summarized in Table 12 below.

TABLE 12

| | | Stirring | | |
|---|---|---|---|---|
| Step | Process | time* | | Comment |
| 0 | Prepare xanthan gum 2% Rhodopol 23 | 4+ | hours | |
| | solution upfront in a separate beaker | | | |
| | for later use | | | |
| 1 | Add 1,2-Propandiol to water under | 5 | min | |
| | stirring (500-600 RPM) stir until | | | |
| | homogenously blended | | | |
| 2 | Add chitosan portion-wise until | 15 | min | |
| | completely dissolved | | | |
| 3 | Add CaLS portion-wise and stir until | 30 | min | |
| | lumps are below 1 mm diameter | | | |
| 4 | Add dispersant and wetter until a | 30 | min | |
| | homogenous mixture is obtain, ensure | | | |
| | Atlas G 5002 L is dissolved | | | |
| 5 | Slowly add active ingredient (CuBM), | 30 | min | Adjust |
| | shovel-wise - 1 shovel/5 min - total 6- | | | stirring |
| | 7 shovels and stir afterwards for at | | | speed to |
| | least 30 min | | | reduce air |
| | | | | incorpora- |
| | | | | tion |
| 6 | Add 80% antifoam | 5 | min | |
| 7 | Mill the formulation until PSD is | 30-60 | min | Check the |
| | d50 < 3; d90 < 7; d99 < 20 | | | PSD graph |
| 8 | Add 20% antifoam | 5 | min | |
| 9 | Add xanthan gum under stirring and | 1+ | hour | |
| | mix until a homogenous mixture is | | | |
| | obtained | | | |

*Stirring times are indications for preparing 1 liter sample

The general procedure for preparing a composition comprising copper-based fungicide and polyelectrolyte, wherein the polyelectrolyte is a polyanion, is summarized in Table 13 below.

TABLE 13

| | | Stirring | | |
|---|---|---|---|---|
| Step | Process | time* | | Comment |
| 0 | Prepare xanthan gum 2% Rhodopol 23 | 4+ | hours | |
| | solution upfront in a separate beaker | | | |
| | for later use | | | |
| 1 | Add 1,2-Propanediol to water under | 5 | min | |
| | stirring (500-600 RPM) stir until | | | |
| | homogenously blended | | | |
| 2 | Add CaLS portion-wise and stir until | 30 | min | |
| | lumps are below 1 mm diameter | | | |
| 3 | Add 80% antifoam | 5 | min | |
| 4 | Add dispersant and wetter until a | 30 | min | |
| | homogenous mixture is obtain, ensure | | | |
| | Atlas G 5002 L is dissolved | | | |
| 5 | Slowly add active ingredient (CuBM), | 30 | min | Adjust |
| | shovel-wise - 1 shovel/5 min - total 6- | | | stirring |
| | 7 shovels and stir afterwards for at | | | speed to |
| | least 30 min | | | reduce air |
| | | | | incorpora- |
| | | | | tion |
| 6 | Mill the formulation until PSD is | 10-30 | min | Check the |
| | d50 < 3; d90 < 7; d99 < 20 | | | PSD graph |
| 7 | Add 20% antifoam | 5 | min | |
| 8 | Add xanthan gum under stirring and | 1+ | hour | |
| | mix until a homogenous mixture is | | | |
| | obtained | | | |

*Stirring times are indications for preparing 1 liter sample

The following formulations summarized in Tables 14 and 15 were prepared using the general procedure of Table 12.

TABLE 14
DT-CE-C4-345-08T - a composition comprising copper-based fungicide
and polyelectrolyte, wherein the polyelectrolyte is a complex
of polycation and polyanion, with Croda surfactants

| Code | [g/L] | [w/w %] |
|---|---|---|
| Bordeaux mix | 345 | 28.8 |
| water | 645.4 | 53.8 |
| Chitosan | 5.6 | 0.5 |
| CaLS (Starlig-Ca) | 28 | 2.3 |
| Metasphere 500L | 24 | 2 |
| Atlas G5002L | 24 | 2 |
| Silicolapse 426R | 5 | 0.4 |
| propan 1,2 diol | 50 | 4.2 |
| acticide MBS | 1 | 0.083 |
| Rhodopol 23 (2% gel in water) | 72 | 6 |

TABLE 15
DT-CE-C4-345-09T - a composition comprising copper-based fungicide
and polyelectrolyte, wherein the polyelectrolyte is a complex
of polycation and polyanion, with Tensiofix surfactants

| Code | [g/L] | [%] |
|---|---|---|
| Bordeaux mix | 345 | 28.8 |
| water | 635.7 | 55 |
| Chitosan | 5.6 | 0.5 |
| CaLS (Starlig-Ca) | 28 | 2.3 |
| Tensiofix CGA213 | 12 | 1 |
| Tensiofix LB350 | 24 | 2 |
| Tensiofix L051 | 2.7 | 0.2 |
| propan 1,2 diol | 50 | 4.2 |
| acticide MBS | 1 | 0.083 |
| Rhodopol 23 (2% gel in water) | 96 | 6 |

The following formulations summarized in Tables 16 and 17 were prepared using the general procedure of Table 13.

TABLE 16
DT-CE-C4-345-10T - a composition comprising copper-
based fungicide and polyelectrolyte, wherein the polyelectrolyte
is a polyanion, with Croda surfactants

| Code | [g/L] | [%] |
|---|---|---|
| Bordeaux mix | 345 | 28.8 |
| water | 627 | 52.3 |
| CaLS (Starlig-Ca) | 28 | 2.3 |
| Metasphere 500L | 24 | 2 |
| Atlas G5002L | 24 | 2 |
| Silicolapse 426R | 5 | 0.4 |
| propan 1,2 diol | 50 | 4.2 |
| acticide MBS | 1 | 0.083 |
| Rhodopol 23 (2% gel in water) | 96 | 8 |

TABLE 17
DT-CE-C4-345-11T - a composition comprising copper-based
fungicide and polyelectrolyte, wherein the polyelectrolyte
is a polyanion, with Tensiofix surfactants

| Code | [g/L] | [%] |
|---|---|---|
| Bordeaux mix | 345 | 28.8 |
| water | 641.3 | 53.4 |
| CaLS (Starlig-Ca) | 28 | 2.3 |
| Tensiofix CGA213 | 12 | 1 |
| Tensiofix LB350 | 24 | 2 |
| Tensiofix L051 | 2.7 | 0.2 |
| propan 1,2 diol | 50 | 4.2 |
| acticide MBS | 1 | 0.083 |
| Rhodopol 23 (2% gel in water) | 96 | 8 |

TABLE 18
Protocol CF1951 03. A composition comprising copper-based
fungicide Cu-oxychloride, Picoxystrobin, Prothioconazole
and polyelectrolyte (3.1%), wherein the polyelectrolyte is
a complex of polycation and polyanion at a ratio of 1:9.

| Ingredient | g/L | w/w % |
|---|---|---|
| Water | 500.6 | 35.8% |
| Propan-1,2-diol | 50.0 | 3.6% |
| Chitosan Bovlin | 4.36 | 0.3% |
| CaLS | 39.2 | 2.8% |
| Cu-oxychloride | 427.14 | 30.5% |
| Na citrate | 36.00 | 2.6% |
| Picoxystrobin (99.9) | 70.07 | 5.0% |
| Prothioconazole (99.3) | 80.56 | 5.8% |
| Tergitol XD | 70 | 5.0% |
| Ecosurf EH6 | 12 | 0.9% |
| Silcolapse 426R | 5 | 0.4% |
| Xanthan gum (2% Rhodopol23) | 105 | 7.5% |

TABLE 18a
The method of preparation for CF1951-03 composition comprising
PEM copper-based fungicide Cu-oxychloride, and additional
fungicides Picoxystrobin, and Prothioconazole is as follows:

| | | Stirring | | |
|---|---|---|---|---|
| Step | Process | time *¹ | | Comment |
| 0 | Prepare upfront in a separate | 4+ | hours | mechanical |
| | beaker for later use xanthan gum | | | stirrer (500- |
| | 2% Rhodopol 23 solution | | | 2000 RPM) |
| 1 | Add 1,2 propanediol to water | 5 | min | mechanical |
| | under stirring, blend | | | stirrer (500- |
| | homogeneously | | | 600 RPM) |
| 2 | Add chitosan portion-wise until | 15 | min | |
| | completely dissolved | | | |
| 3 | Add half of CaLS portion-wise and | 10 | min | Dispersion |
| | stir until lumps are below 1 mm | | | becomes light |
| | diameter | | | beige |
| 4 | Add remaining CaLS and stir until | 20 | min | Dispersion |
| | lumps are below 1 mm diameter | | | becomes brown |
| 5 | Add Tergitol XD, Ecosurf EH6 | 30 | min | Adjust RPM to |
| | and mix for 30 min | | | have proper |
| | | | | stirring |
| 6 | Add 80% of the Silcolapse 416 and | 5 | min | |
| | mix for 5 minutes | | | |
| 7 | Add Cu-Oxychloride portion-wise | 30 | min | |
| | (30 minutes) into the solution and | | | |
| | mix for an additional 10 minutes | | | |
| 8 | Check pH-value and add 20% of | 10 | min | pH-value should |
| | Na-citrate salt if needed | | | be 6.0-7.0 |
| 9 | Add Picoxystrobin, add Na-citrate | 15 | min | control pH and |
| | if required | | | keep between |
| | | | | 6.0-7.0 |
| 10 | Add Prothioconazole | 15 | min | control pH and |
| | | | | keep between |
| | | | | 6.0-7.0 |
| 11 | Check pH-value and add remaining | 30 | min | control pH and |
| | citrate salt | | | keep between |
| | | | | 6.0-7.0 |
| 12 | Slurry is milled until PSD is | 20 | min | Dispermat SL |
| | d50 <3; d90 <7; check graph of | | | Zirkonium beads |
| | PSD d99 <20 | | | 3000-4000 RPM |
| | | | | (100-300 W) |
| 13 | Transfer slurry after milling to | | | Mechanical |
| | normal stirrer | | | stirrer (500- |
| | | | | 1000 RPM) |
| 14 | Add 20% of Silcolapse 426R | 1 | min | |
| 15 | Add Xanthan gum pregel | 60 | min | |

TABLE 19
CF1901-04-07. A composition comprising copper-based fungicide
Bordeaux mixture, Picoxystrobine, Prothioconazole and polyelectrolyte
(1.2%), wherein the polyelectrolyte is a complex of polycation
and polyanion at a weight % ratio of 1:5.

| Ingredient | g/L | w/w % |
|---|---|---|
| Water | 556.3 | 41.2% |
| Propan-1,2-diol | 50.0 | 3.7% |
| Bolin - Chitosan | 3.36 | 0.2% |
| Acetic acid | 0 | 0% |
| Borreseperse CA - CaLS | 13.4 | 1.0% |
| Cu-BM (29.2% Cu) | 428.1 | 31.7% |
| Prothioconazole 99.3% | 40.0 | 3.0% |
| Picoxystrobin 99.9% | 35.0 | 2.6% |
| Sodium citrate | 8 | 1.5 |
| Soprophor FL | 100 | 7.4% |
| Atlas G5002L | 20 | 1.5% |
| Silcolapse 426R | 10 | 0.7% |
| Acticide MBS | 1.0 | 0.1% |
| Xanthan gum (2% Rhodopol 23) | 85 | 6.3% |

TABLE 19a
The method of preparation for CF1951-03 composition comprising
PEM copper-based Bordeaux mixture fungicide, and additional
fungicides Picoxystrobine, and Prothioconazole is as follows:

| | | Stirring | | |
|---|---|---|---|---|
| Step | Process | time *¹ | | Comment |
| 0 | Prepare upfront in a separate | 4+ | hours | mechanical |
| | beaker for later use xanthan gum | | | stirrer |
| | 2% Rhodopol 23 solution | | | (500-2000 RPM) |
| 1 | Add 1,2-propanediol to water | 5 | min | mechanical |
| | under stirring, stir until blended | | | stirrer |
| | homogeneously | | | (500-600 RPM) |
| 2 | Add acetic acid*² (ratio | 5 | min | ~pH 3 |
| | Chitosan:Acetic acid 1:0.6) | | | |
| 3 | Add chitosan portion wise until | 15 | min | |
| | completely dissolved | | | |
| 4 | Add CaLS portion wise and stir | >30 | min | |
| | until lumps are below 1 mm | | | |
| | diameter | | | |
| 5 | Add Soprophor FL ad Atlas | 30 | min | Adjust RPM to |
| | G5002L and mix for 30 min | | | have proper |
| | | | | stirring |
| 6 | Add 80% of the Silcolapse 426R | 5 | min | |
| | and mix for 5 minutes | | | |
| 7 | Add CuBM portion-wise (30 | 30 | min | |
| | minutes) into the solution and | | | |
| | mix for an additional 10 minutes | | | |
| 8 | Check pH-value and add buffer | 10 | min | pH-wise should |
| 9 | Add Picoxystrobin | 15 | min | be 6.0-7.0 |
| 10 | Add Prothioconazole | 15 | min | |
| 11 | Slurry is milled until PSD is | 30-60 | min | Dispermat SL |
| | d50 <3; d90 <7; check graph of | | | Zirkonium beads |
| | PSD d99 <20 | | | 3000-4000-RPM |
| | | | | (100-300 W) |
| 12 | Transfer slurry after milling to | | | Mechanical |
| | normal stirrer | | | stirrer |
| | Add 20% of Silcolapse 426R | 1 | min | (500-1000 RPM) |
| 13 | Add Acticide MBS | 1 | min | |
| 14 | Add Xanthan gum pregel | 60 | min | |

TABLE 20
CF1901-04-04. A composition comprising copper-based fungicide
Bordeaux mixture, Picoxystrobine, Prothioconazole and polyelectrolyte
(2.5%), wherein the polyelectrolyte is a complex of polycation
and polyanion at a weight % ratio of 1:5.3.

| Ingredient | g/L | w/w % |
|---|---|---|
| Water | 523.94 | 38.8% |
| Propan-1,2-diol | 50.0 | 3.7% |
| Kitogreen - Chitosan | 5.6 | 0.4% |
| Acetic acid | 3.36 | 0.2% |
| Borreseperse CA - CaLS | 28.0 | 2.1% |
| Cu-BM (29.2% Cu) | 428.1 | 31.7% |
| Prothioconazole 99.3% | 40.0 | 3.0% |
| Picoxystrobin 99.9% | 35.0 | 2.6% |
| Dipotassiumhydrogenphosphate | 20 | 1.5 |
| Soprophor FL | 100 | 7.4% |
| Atlas G5002L | 20 | 1.5% |
| Silcolapse 426R | 10 | 0.7% |
| Acticide MBS | 1.0 | 0.1% |
| Xanthan gum (2% Rhodopol 23) | 85 | 6.3% |

TABLE 21
CF1901-04-05. A composition comprising copper-based fungicide
Bordeaux mixture, Picoxystrobine, Prothioconazole and polyelectrolyte
(2.5%), wherein the polyelectrolyte is a complex of polycation
and polyanion at a weight % ratio of 1:4.

| Ingredient | g/L | w/w % |
|---|---|---|
| Water | 566.3 | 41.9% |
| Propan-1,2-diol | 50.0 | 3.7% |
| Bolin - Chitosan | 6.72 | 0.5% |
| Acetic acid | 0 | 0% |
| Borreseperse CA - CaLS | 26.9 | 2.0% |
| Cu-BM (29.2% Cu) | 428.1 | 31.7% |
| Prothioconazole 99.3% | 40.0 | 3.0% |
| Picoxystrobin 99.9% | 35.0 | 2.6% |
| Dipotassiumhydrogenphosphate | 20 | 1.5 |
| Soprophor FL | 100 | 7.4% |
| Atlas G5002L | 20 | 1.5% |
| Silcolapse 426R | 10 | 0.7% |
| Acticide MBS | 1.0 | 0.1% |
| Xanthan gum (2% Rhodopol 23) | 46 | 3.4% |

TABLE 22
CF1950-15-01. A composition comprising copper-based fungicide Cu-
oxychloride, fluopicolide and polyelectrolyte (4.0%), wherein the
polyelectrolyte is a complex of chitosan polycation and calcium
lignosulfonate (CaLS) polyanion at a weight % ratio of 1:9.

| CF1950-15-01 | | |
|---|---|---|
| Ingredients | g/L | w/w % |
| Water | 442.48 | 36.9% |
| Propan-1,2-diol | 50.0 | 4.2% |
| Chitosan | 4.36 | 0.4% |
| CaLS | 43.6 | 3.6% |
| Cu-oxychloride | 425.89 | 35.5% |
| Fluopicolide | 66.67 | 5.6% |
| Soprophor 3D33 | 30 | 2.5% |
| Ecosurf EH6 | 12 | 1.0% |
| Silcolapse 426R | 5 | 0.4% |
| Xanthan gum (2% Rhodopol 23) | 120 | 10.0% |
| Total | 1200 | 100.0% |

TABLE 22a
The method of preparation for CF1950-15-01 composition
comprising PEM copper-based fungicide Cu-oxychloride,
and additional fluopicolide fungicide is as follows:

| | | Stirring | | |
|---|---|---|---|---|
| Step | Process | time *¹ | | Comment |
| 0 | Prepare upfront in a separate beaker for | 4+ | hours | mechanical |
| | later use xanthan gum 2% Rhodopol 23 | | | stirrer (500- |
| | solution | | | 2000 RPM) |
| 1 | Add 1,2-propanediol to water under | 5 | min | mechanical |
| | stirring, stir until blended | | | stirrer (500- |
| | homogeneously | | | 600 RPM) |
| 2 | Add 80% of the Silcolapse 426R and | 5 | min | |
| | mix for 5 minutes | | | |
| 3 | Add chitosan*² portion wise until | 15 | min | |
| | completely dissolved | | | |
| 4 | Add CaLS portion wise and stir until | 30 | min | |
| | lumps are below 1 mm diameter | | | |
| 5 | Add Cu-oxychloride portion-wise (30 | 40 | min | Adjust RPM |
| | minutes) into the solution and mix for | | | to have |
| | an additional 10 minutes | | | proper |
| | | | | stirring |
| 6 | Add Fluopicolide portion-wise (10 | 40 | min | |
| | minutes) into the solution and mix for | | | |
| | an additional 30 minutes | | | |
| 7 | Add dispersant Soprophor 3D33 and | 15 | min | |
| | wetter Ecosurf EH6 until mixture is | | | |
| | homogenously blended | | | |
| 8 | Mill the blend until PSD is d50 <3; | | | Dispermat |
| | d90 <7; d99 <20 | | | TML at 6000 |
| | | | | RPM |
| 9 | Add the missing 20% of the antifoam | 5 | min | |
| | Silcolapse 426R and mix for 15 minutes | | | |
| 10 | Add xanthan gum gel under stirring and | 1+ | hour | |
| | mix until homogeneous mixture is | | | |
| | obtained | | | |

TABLE 23
CF1950-16-01. A composition comprising copper-based fungicide
Cu-oxychloride, fluopicolide and polyelectrolyte (4.3%), wherein
the polyelectrolyte is a complex of polyallylamine (PAA) polycation
and CaLS polyanion at a weight % ratio of 1:5.

| CF1950-15-01 | | |
|---|---|---|
| Ingredients | g/L | w/w % |
| Water | 498.12 | 41.5% |
| Propan-1,2-diol | 50.0 | 4.2% |
| PAA (50%) | 8.72 | 0.7% |
| CaLS | 43.6 | 3.6% |
| Cu-oxychloride | 425.89 | 35.5% |
| Fluopicolide | 66.67 | 5.6% |
| Atlox 4913 | 30 | 2.5% |
| Adsee 900 | 12 | 1.0% |
| Silcolapse 426R | 5 | 0.4% |
| Xanthan gum (2% Rhodopol 23) | 60 | 5.0% |
| Total | 1200 | 100.0% |

TABLE 24
CF1950-18-01. A composition comprising copper-based fungicide
Cu-oxychloride, fluopicolide and polyelectrolyte (4.0%),
wherein the polyelectrolyte is a complex of chitosan polycation
and CaLS polyanion at a weight % ratio of 1:4.7.

| CF1950-15-01 | | |
|---|---|---|
| Ingredients | g/L | w/w % |
| Water | 472.44 | 39.4% |
| Propan-1,2-diol | 50.0 | 4.2% |
| Chitosan | 8.00 | 0.7% |
| CaLS | 40.0 | 3.3% |
| Cu-oxychloride | 425.89 | 35.5% |
| Fluopicolide | 66.67 | 5.6% |
| Atlox 4913 | 30 | 2.5% |
| Adsee 900 | 12 | 1.0% |
| Silcolapse 426R | 5 | 0.4% |
| Xanthan gum (2% Rhodopol 23) | 90 | 7.5% |
| Total | 1200 | 100.0% |

TABLE 25
A composition comprising copper-based fungicide CuSO4 Bordeaux
mixture 125 g/L + Picoxystrobine 35 g/L + Prothioconazole 40 g/L,
and polyelectrolyte, wherein the polyelectrolyte comprises only
Calcium lignosulfonate polyanion.
Metallic Copper 125 g/L + Picoxystrobin
35 g/L + Prothioconazole 40 g/L SE
Date: May 10, 2021

| S. No. | Ingredients | % w/w |
|---|---|---|
| 1 | Bodeaux Mix. (9.4@27.22) | 34.29 |
| 2 | Picoxystrobin (2.7@97) | 2.78 |
| 3 | Propylene Glycol | 5.00 |
| 4 | Metasperse 550 S | 1.00 |
| 5 | Borresperse CA | 2.80 |
| 6 | Geropon ® T-77 | 2.00 |
| 7 | Atlox 4894 | 2.00 |
| 8 | SAG 1572 | 0.10 |
| 9 | Proxel GXL | 0.05 |
| 10 | DM water | 36.86 |
| 11 | Prothioconazole (3.0@98) | 3.06 |
| 12 | Armid DM 10 | 3.06 |
| 13 | Emulsogen TS 200 | 1.50 |
| 14 | TEA | 0.50 |
| 15 | Rhodopol 23 (2%) | 5.00 |
| | | 100.00 |

### SC Preparation:

The required quantity of DM water was taken in the beaker followed by addition of proxel GXL, propylene glycol, Atlox 4894, Borosperse CA, Geropon T77, Metasperse 550S, and ⅓^{rd} part of SAG 1572 with continuous stirring at 350-500 rpm using pitched four blade impeller.

then Bordeaux mixture is added slowly and mixed well with stirring at 350-500 rpm using pitched four blade impeller until homogeneous slurry is obtained.

then picoxystrobin technical is added slowly and mixed well with stirring at 350-500 rpm using pitched four blade impeller until homogeneous slurry is obtained.

The above premix was grinded in bead mill to attain particle size D90<4 micron

The grinded premix was further stirred at 350-500 rpm using pitched four blade impeller for another 30 minutes after milling.

### EC Preparation:

The required quantity of solvent (Armid DM10) was taken in a beaker and Prothioconazole technical was added and dissolved.

The emulsifier Emulsogen TS200 was added to the above solution and stirred well at 350-500 rpm using pitched four blade impeller until clear solution is obtained.

### Preparation of SE:

EC part was added slowly for 15-20 min under stirring using pitched four blade impeller at 800-1000 rpm to the SC part prepared earlier.

Increase in viscosity was observed during mixing due to emulsification of EC part with aqueous part of SC.

Stirring was continued for about 30 min and the remaining quantity of SAG 1572 was added. The suspoemulsion obtained was mixed for another 15 minute.

The pH of the above mixture was adjusted to be around 6-7 using Triethanol amine.

The required quantity of 2% solution of Aghropol 23 was added with stirring at 350-500 rpm using pitched four blade impeller to get final viscosity about 1200-1400 cPs when measured with Spindle 62 at 12 RPM.

### Example 8

TABLE 26

| Ingredient | Chemical Name | v/w | w/w |
|---|---|---|---|
| Bordeaux mixture | A mixture, with or without | 428.1 | 31.71 |
| tech | stabilizing agents, of calcium | | |
| | hydroxide and copper(II) sulfate | | |
| | (but see Composition) | | |
| Picoxystrobin tech | methyl (E)-3-methoxy-2-[2-(6- | 35 | 2.59 |
| | trifluoromethyl-2- | | |
| | pyridyloxymethyl)phenyl]acrylate | | |
| Prothioconazole | 2-[(2RS)-2-(1-chlorocyclopropyl)- | 39.7 | 2.94 |
| | 3-(2-chlorophenyl)-2- | | |
| | hydroxypropyl]-2H-1,2,4-triazole- | | |
| | 3(4H)-thione | | |
| Acetic Acid | Acetic Acid | 0 | 0 |
| ACTICIDE MBS | (A) 2-methylisothiazol-3(2H)-one, | 1 | 0.07 |
| | (B) 1,2-benzisothiazol-3(2H)-one | | |
| AG-RH 23 | Xanthan Gum | 1.7 | 0.13 |
| ATLAS G-5002L- | oxirane, monobutyl ether | 20 | 1.48 |
| LQ-(CQ) | | | |
| Borresperse CA | (A) Calcium lignosulfonate, (B) | 13.4 | 0.99 |
| | Water | | |
| CHITOSAN | | 3.4 | 0.25 |
| HYDROCHLORIDE | | | |
| Propylene glycol | 1,2 propanediol | 50 | 3.7 |
| Proxel GXL | (A) 1,2-Benzisothiazol-3(2H)-one, | 0.2 | 1.30E−02 |
| | (B) Sodium hydroxide | | |
| Silcolapse 426R | Dimethyl siloxanes & silicones, | 10 | 0.74 |
| | (A) (1,2-benzisothiazol-3(2H)- | | |
| | one; 1,2-benzisothiazolin-3- | | |
| | one <0.05) | | |
| Sodium citrate | Sodium citrate dihydrate | 8 | 0.59 |
| dihydrate | | | |
| Soprophor FL | (A) Poly(oxy-1,2- | 100 | 7.41 |
| | ethanediyl),.alpha.-[tris(1- | | |
| | phenylethyl)phenyl]-.omega.- | | |
| | hydroxy- | | |
| water | Water | 83.1 | 6.16 |
| Water soft | Water | Up to | Up to |
| | | 1000 L | 100% |

TABLE 27

| Ingredients | % w/w |
|---|---|
| Bordeaux Mixture | 34.53 |
| Picoxystrobin | 2.70 |
| Propylene Glycol | 5.00 |
| Geropon T-77 | 2.00 |
| Borresperse CA | 1.00 |
| Atlox Metasperse 500L | 1.00 |
| Atlox 4894 | 3.00 |
| SAG 1572 | 0.10 |
| Proxel GXL | 0.10 |
| Prothioconazole | 3.00 |
| Rhodiasolv ADMA 10 | 3.00 |
| Emulsogen TS 200 | 1.50 |
| Agrhopol 23 | 0.20 |
| Water | QS |
| | 100.00 |

### Preparation Process

### SC Preparation:

The required quantity of DM water was taken in the beaker followed by addition of proxel GXL, propylene glycol, Atlox 4894, Borosperse CA, Geropon T77, Metasperse 500L, and ⅓^{rd} part of SAG 1572 with continuous stirring at 350-500 rpm using pitched four blade impeller.

Later Bordeaux mixture is added slowly and mixed well with stirring at 350-500 rpm using pitched four blade impeller until homogeneous slurry is obtained.

then picoxystrobin technical is added slowly and mixed well with stirring at 350-500 rpm using pitched four blade impeller until homogeneous slurry is obtained.

The above premix was grinded in bead mill to attain particle size D90<4 micron

The grinded premix was further stirred at 350-500 rpm using pitched four blade impeller for another 30 minutes after milling.

Preparing the emulsifiable concentrate (EC) comprising azole fungicide:

The required quantity of solvent (ADMA10) was taken in a beaker and Prothioconazole technical was added and dissolved.

The emulsifier Emulsogen TS200 was added to the above solution and stirred well at 350-500 rpm using pitched four blade impeller until clear solution is obtained.

### Preparation of Suspoemulsion—SE:

EC part was added slowly for 15-20 min under stirring using pitched four blade impeller at 800-1000 rpm to the SC part prepared earlier.

Increase in viscosity was observed during mixing due to emulsification of EC part with aqueous part of SC.

Stirring was continued for about 30 min and the remaining quantity of SAG 1572 was added. The suspoemulsion obtained was mixed for another 15 minute.

The required quantity of 4% solution of Aghropol 23 was added and stirred well to obtain final suspoemulsion formulation.

### Example 9—Biological Tests

Test 1. Preventive Treatment Towards P. pachyrhizi Strain THAI1 on Soybean

The four new liquid copper prototype formulations of Tables 14-17 and Difere were tested at five rates (0.0075-0.075-0.75-7.5 and 75 g copper metal/ha, corresponding to 500-50-5-0.5 and 0.05 mg a.i./L for Difere reference (Dicopper chloride trihydroxide; CAS #1332-40-7, Cu2Cl(OH)3 90%) or ppm/0.0022-0.022-0.22-2.2 and 22 g copper metal/ha, corresponding to 148-14.8-1.48-0.148-0.0148 mf of Cu metal/L for copper prototypes) with 0.05% Tween 80. Difere is a commercially available suspension concentrate (SC) formulation containing 588 g/L (58.8% m/v) of copper oxychloride. The fungicides were prepared one hour before treatment in a volume of water corresponding to 150 l/ha.

The fungicides were sprayed by the aim of a hand sprayer in presence of Tween 80 (0.05%). Control true leaves are treated with distilled water. After treatment soybean leaves were left to dry at room temperature and then placed adaxial face up on 120×120 cm Petri dishes containing 0.4% water agar supplemented with antibiotic and anti-senescing product (3 replicates per treatment).

Twenty-four hours (24 h) after treatment (preventive treatment), soybean true leaves plantlets were inoculated with a calibrated uredospores suspension of the reference P. pachyrhizi strain THAI1. The inoculated soybean leaves are incubated in a climatic chamber.

TABLE 28
EC50 values of 4 copper prototypes, compared to Difere.

| Product | EC₅₀ |
|---|---|
| DT-CE-C4-345-08T + 0.05% Tween 80 | 0.0052 g Copper Metal/Ha |
| DT-CE-C4-345-09T + 0.05% Tween 80 | 0.0100 g Copper Metal/Ha |
| DT-CE-C4-345-10T + 0.05% Tween 80 | 0.0590 g Copper Metal/Ha |
| DT-CE-C4-345-11T + 0.05% Tween 80 | 0.0095 g Copper Metal/Ha |
| Difere + 0.05% Tween 80 | 0.600 g Copper Metal/Ha |

TABLE 29
Dose-response effect of the 4 new Copper prototypes, DT-CE-C4-345-08T
to -11T and Difere + 0.05% Tween 80, applied preventively, towards
P. pachyrhizi strain THAI1 on soybean leaves in controlled conditions.

| Product | 0 g | 0.0022 g | 0.022 g | 0.22 g | 2.2 g | 22 g |
|---|---|---|---|---|---|---|
| | AI/Ha | AI/Ha | AI/Ha | AI/Ha | AI/Ha | AI/Ha |
| DT-CE-C4- | 1088.8 +/− | 671.3 +/− | 330.0 +/− | 221.2 +/− | 13.5 +/− | 0.0 +/− |
| 345-08T | 18.9a | 30.7d | 43.2fg | 16.3gh | 6.8i | 0.0i |
| | | (38.3%) | (69.7%) | (79.7%) | (98.8%) | (100.0%) |
| DT-CE-C4- | 1088.8 +/− | 1046.3 +/− | 281.3 +/− | 43.5 +/− | 1.5 +/− | 1.5 +/− |
| 345-09T | 18.9a | 89.3a | 45.5fg | 19.9i | 1.5i | 1.5i |
| | | (3.9%) | (74.2%) | (96.0%) | (99.9%) | (99.9%) |
| DT-CE-C4- | 1088.8 +/− | 975.0 +/− | 843.8 +/− | 132.0 +/− | 15.0 +/− | 0.0 +/− |
| 345-10T | 18.9a | 36.9ab | 87.9c | 38.5hi | 5.9i | 0.0i |
| | | (10.4%) | (22.5%) | (87.9%) | (98.6%) | (100.0%) |
| DT-CE-C4- | 1088.8 +/− | 806.3 +/− | 393.8 +/− | 43.5 +/− | 9.7 +/− | 8.3 +/− |
| 345-11T | 18.9a | 38.1c | 33.8ef | 11.7i | 7.6i | 8.3i |
| | | (25.9%) | (63.8%) | (95.9%) | (99.1%) | (99.2%) |
| Product | 0 g | 0.0075 g | 0.075 g | 0.75 g | 7.5 g | 75 g |
| | AI/Ha | AI/Ha | AI/Ha | AI/Ha | AI/Ha | AI/Ha |
| Difere | 1088.8 +/− | 1083.8 +/− | 903.8 +/− | 506.3 +/− | 29.3 +/− | 1.5 +/− |
| | 18.9a | 64.1a | 26.3bc | 23.4^{e} | 5.2i | 1.5i |
| | | (0.5%) | (17.0%) | (53.5%) | (97.3%) | (99.9%) |

^{a}Each value corresponds to mean of 3 replicates (Petri dishes) of 3 soybean leaf each +/− standard error. The values between brackets correspond to the fungicide efficacy in percent of the untreated control. The values followed by the same letter are not significantly different according to the Newman & Keuls test (P = 0.005).

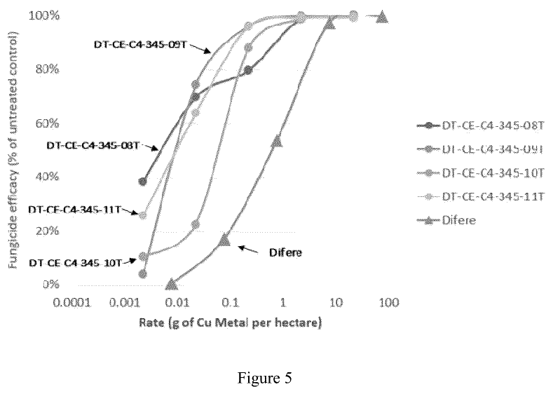

The results are shown in FIG. 5.

Test 2. Preventive Treatment Towards Phytophthora infestans Strain Pi96 in Potato

The 4 copper prototypes DT-CE-C4-345-08T, DT-CE-C4-345-09T, DT-CE-C4-345-10T, DT-CE-C4-345-11T and the reference copper fungicide Kocide Opti were applied on potato whole plants at five rates (750, 450, 375, 150, 15 gr metallic copper/Ha) a second copper fungicide reference, Kocide 2000, was applied at 375 and 150 gr metallic copper/Ha. All copper formulations were supplemented with Tween 80 0.05% and applied by the aim of a hand-sprayer calibrated to deliver 300 L/ha. After 24 hours, the plants were inoculated with a calibrated sporangia suspension of P. infestans strain Pi96. Following inoculation, the plants were transferred to a climatic chamber (20° C./16° C.-16 h light/day 8 h dark/night) under saturated humidity. Disease assessment was carried out 7 days after infection by estimating the Disease Severity Index (DSI). The DSI is calculated per leaf, a minimum of 12 leaves (from a minimum of 2 plants) are considered for each condition.

Results of test 1, show that copper compositions according to the invention brings an added value in terms of treatment towards P. pachyrhizi strain THAI1, when compared to the Difere commercial product reference control. The efficacy results are shown in Tables 28 and 29. Especially, compositions DT-CE-C4-345-09T and DT-CE-C4-345-11T outperformed control copper over the whole range, as is clearly shown in FIG. 2. The EC50 values of the copper compositions according to the invention were 10 to 100-fold lower than that of the Difere commercial product reference control (see Table 18).

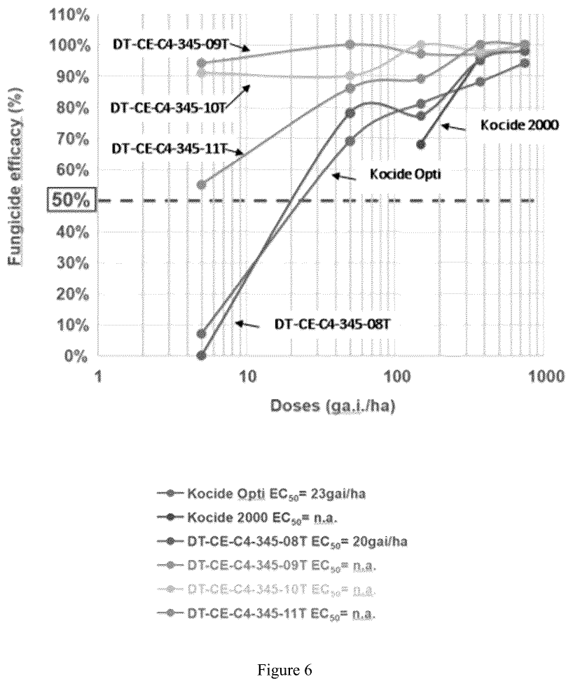

Results of test 2 in FIG. 6 show that the fungicidal efficacy of the copper compositions according to the invention were superior to that of the Kocide commercial product reference control.

It was surprising that the compositions comprising copper-polyelectrolyte macromolecular complexes according to the invention showed improved fungicidal efficacy compared to commercial product. It is reasonable to expect that when copper sulfate is replaced with another copper-based fungicide, a similar improvement in fungicidal efficacy will be observed.

### Test 3. Improved Rainfastness.

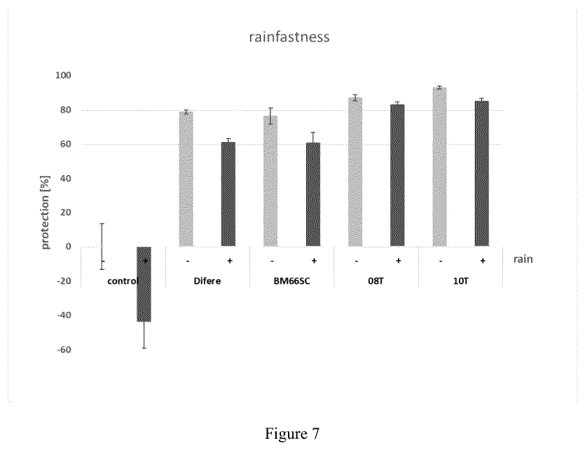

FIG. 7 shows the improved rainfastness of DT-CE-C4-345-08T and DT-CE-C4-345-10T in soybean compared to other copper formulations. Soybean plants were treated adaxial with Copper BM formulations at 300 ppm copper using airbrush device (AB-350, Conrad Electronics). After 4 hours the plants were watered with 40 mm rain/hour and left to dry for 24 hours. The next day, the plants were inoculated adxial with spore suspension of Phakopsora pachyrhizi strain BR05 at 1 mg spores/ml and incubated for one night. The next day the leaves were detached and placed adaxial side up in petri dishes +3 mL water (3 leaflets per dish) and incubated at 22° C. (16 h light/8 h dark). The number of lesions was evaluated after 13 days.

### Test 4. Lack of Toxicity.

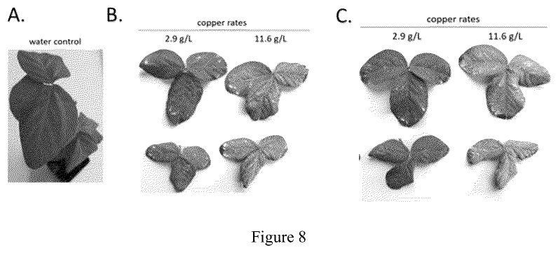

FIG. 8 shows no phytotoxicity of DT-CE-C4-345-08T and DT-CE-C4-345-10T towards Soybeans (Glycine max Abelina). Two plants with two trifolia each were treated with different rates of fungicides (2.9 gr metallic copper/lit or 11.6 gr metallic copper/lit) (tap water is used as a control) on day 0 and on day 5 of the experiment. Treatment was performed via spraying with an Airbrush Device (AB-350, Conrad Electronics) and the plants were kept at 22° C. (16 h light/8 h dark). The experiment was evaluated on day 15. A. water control B. DT-CE-C4-345-08T C. DT-CE-C4-345-10T.

1. A combination comprising (1) an amount of azole fungicide and (2) an amount of additive (I).

2. The combination of claim 1, wherein additive (I) is selected from group consisting of thiourea-based compound, sodium thiosulfate, alkyl amine, thioamide-based compound, and any combination thereof.

3. The composition of claim 2, wherein the combination comprises a thiourea-based compound and the thiourea-based compound has a structure defined by the following formula:
R¹NH—C(═S)—NHR²
wherein,
(i) R¹, R², are both H;
(ii) R¹ is H and R² is alkyl or alkenyl or alkynyl or aryl or heterocyclic;
(iii) R¹, R² are each, independently, alkyl, alkenyl or alkynyl;
(iv) R¹, R² are each, independently, aryl, or heterocyclic;
(v) R¹ is alkyl or alkenyl or alkynyl and R² is aryl or heterocyclic, or
(vi) R¹ and R² can be taken together with the nitrogen atoms to which they are attached to form a ring containing 2 to 4 atoms of carbon and optionally one additional atom of nitrogen, sulfur or oxygen, said ring may be saturated or unsaturated and optionally substituted with 1 to 4 substituents selected from the group consisting of C₁-C₂ alkyl, halogen, CN, NO₂ and C₁-C₂ alkoxy.

4. The composition of claim 3, wherein the thiourea-based compound has the structure H₂N—C(═S)—NH₂ (thiourea).

5. The composition of any one of claims 1-4, wherein the combination comprises one or more alkylamines.

6. The composition of any one of claims 1-5, wherein the combination comprises sodium thiosulfate.

7. The combination of any one of claims 1-6, wherein the azole fungicide is selected from group consisting of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole and mefentrifluconazole.

8. The combination of claim 7, wherein the azole fungicide is prothioconazole, epoxiconazole, cyproconazole or difenoconazole.

9. The combination of claim 1, wherein the azole fungicide is prothioconazole and the additive (I) is thiourea.

10. The combination of any one of claims 1-9, wherein the weight ratio between the azole fungicide and the additive (I) is between about 0.2:1 to 600:1.

11. The combination of any one of claims 1-10, wherein the weight ratio between the azole fungicide and the additive (I) is between about 1:60 to 60:1.

12. The combination of any one of claims 1-11, wherein the weight ratio between the azole fungicide and the additive (I) is about 11.7:1 or 7.1:1.

13. The combination of any one of claims 1-12, wherein the combination further comprises one or more additional fungicide(s).

14. The combination of claim 13, wherein the combination comprises a strobilurin fungicide.

15. The combination of any one of claims 1-14, wherein the combination is a tank mix.

16. The combination of any one of claims 1-14, wherein the combination is a composition, a ready-mix composition, or a water diluted composition.

17. The combination of any one of claims 1-14, wherein the combination is a composition, a ready-mix composition, or a water diluted composition, and wherein the combination is devoid of copper-based fungicide.

18. A composition comprising the combination of any one of claims 1-17 and an agricultural acceptable carrier.

19. The composition of claim 18, wherein the composition is liquid.

20. The composition of claim 19, wherein the composition is water-based composition.

21. The composition of claim 20, wherein the water-based composition is suspension concentrate.

22. The composition of claim 20, wherein the water-based composition is a suspoemulsion.

23. The composition of claim 19, wherein the composition is non-aqueous based composition.

24. The composition of claim 23, wherein the non-aqueous based composition is emulsifiable concentrate composition.

25. The composition of claim 23, wherein the non-aqueous composition is oil dispersion.

26. The composition of claim 18, wherein the composition is a solid composition.

27. The composition of any one of claims 1-26, wherein the azole fungicide is in its solid form in the composition.

28. The composition of claim 27, wherein the azole fungicide is suspended in the agricultural acceptable carrier.

29. The composition of any one of claims 1-25, wherein the azole fungicide is dissolved in the agricultural acceptable carrier.

30. The composition of claim 29, wherein the agricultural acceptable carrier is water.

31. The composition of claim 29, wherein agricultural acceptable carrier is an organic carrier.

32. The composition of claim 31, wherein organic carrier is an oil or a water immiscible carrier

33. The composition of any one of claims 18-32, wherein the amount of the azole fungicide in the composition is between 0.1% to 70% by weight based on the total weight of the composition.

34. The composition of any one of claims 18-33, wherein the amount of the azole fungicide in the composition is between 1% to 50% by weight based on the total weight of the composition.

35. The composition of any one of claims 18-34, wherein the amount of the additive (I) in the composition is between 0.1% to 5% by weight based on the total weight of the composition.

36. The composition of any one of claims 18-35, wherein the composition comprises one or more additional fungicide(s) and the concentration of the additional fungicide(s) in the composition is between 1% to 45% by weight based on the total weight of the composition.

37. The composition of any one of claims 18-36, wherein the composition further comprises at least one agriculturally acceptable additive.

38. The composition of claim 18, wherein:
a. the composition comprises: (1) prothioconazole, (2) thiourea, and (3) a water-immiscible carrier, wherein the prothioconazole is dissolved in the water-immiscible carrier, or
b. the composition comprises: (1) prothioconazole, (2) thiourea, and (3) water, wherein the prothioconazole is suspended in the water.

39. A method of treating a plant or a locus thereof, against a pathogen, comprising contacting the plant, a part of the plant, or the locus with the combination or composition of any one of claims 1-38.

40. The method of claim 39, wherein the pathogen is phytopathogenic fungi.

41. The method of claim 39 or 40, wherein treating comprises:
a. controlling diseases caused by the pathogen,
b. controlling diseases caused by phytopathogenic fungi in plants or on propagation material thereof,
c. preventing, reducing and/or eliminating the presence of the pathogen on the plant, or part of the plant, and/or
d. protecting the plant, or a part of a plant, against the pathogen.

42. The method of any one of claims 39-41, wherein the additive (I) and the azole fungicide are applied simultaneously as tank mix.

43. The method of any one of claims 39-41, wherein the additive (I) and the azole fungicide are applied in contemporaneous applications.

44. A method for increasing the rate of application of an azole fungicide to a plant or plant part and/or increasing the frequency of application of an azole fungicide to a plant or plant part without causing increased phytotoxicity to the plant, wherein the method comprises applying the azole fungicide to the plant or plant part in combination with an additive (I) selected from the group consisting of thiourea-based compounds, sodium thiosulfate, alkyl amine, thioamide-based compounds and any combination thereof.

45. The method of claim 44, wherein the method improves pest control without causing increased phytotoxicity to the plant.

46. A method of improving pest control using an azole fungicide without increased phytotoxicity, wherein the method comprises applying the combination or composition of any one of claims 1-38 to a locus where pest control is desired.

47. A method of reducing and/or eliminating phytotoxicity to a plant or plant part caused by an azole fungicide applied to the plant or plant part, wherein the method comprises applying the azole fungicide in combination with an additive (I) selected from the group consisting of thiourea-based compounds, sodium thiosulfate, alkyl amine, thioamide-based compounds and any combination thereof.

48. A method of improving a plant's tolerance to an amount of an azole fungicide comprising applying the amount of the azole fungicide in combination with an additive (I) selected from the group consisting of thiourea-based compounds, sodium thiosulfate, alkyl amine, thioamide-based compounds and any combination thereof.

49. A method of treating a plant or a locus heavily infected by fungal disease or susceptible to heavy infection of fungal disease comprising applying to the plant, plant part, or the locus an amount of azole fungicide in combination with an additive (I) selected from the group consisting of thiourea-based compounds, sodium thiosulfate, alkyl amine, thioamide-based compounds and any combination thereof.

50. Use of an additive (I) selected from group consisting of thiourea-based compounds, sodium thiosulfate, alkyl amine, thioamide-based compounds and any combination thereof for reducing phytotoxicity associated with application of an azole fungicide.

51. Use of an additive (I) selected from group consisting of thiourea-based compounds, sodium thiosulfate, alkyl amine, thioamide-based compounds and any combination thereof for increasing the plant health of plant when is treated with an azole fungicide, wherein the plant health of a plant which is treated with the azole fungicide in presence of additive (I) is increased compared to the plant health of the plant which is treated with the same amount of the same azole fungicide in absence of the additive (I).

52. Use of an additive (I) selected from group consisting of thiourea-based compounds, sodium thiosulfate, alkyl amine, thioamide-based compounds and any combination thereof for reducing or eliminating the phytotoxicity associated with application of an azole fungicide, wherein the phytotoxic effects on a plant which is treated with the azole fungicide in presence of additive (I) is lower as compared to the phytotoxic effect on the plant which is treated with the same amount of the same azole fungicide in absence of the additive (I).

53. Use of an additive (I) selected from group consisting of thiourea-based compounds, sodium thiosulfate, alkyl amine, thioamide-based compounds and any combination thereof for reducing or eliminating the phytotoxicity of an azole fungicide, wherein the rate and/or extent of phytotoxic effects when the azole fungicide is applied in presence of an additive (I) is reduced as compared to the rate and/or extent of phytotoxic effects when the azole fungicide is applied in absence of an additive (I).

54. The method or use of any one of claims 44-53, wherein the azole fungicide is selected from group consisting of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole and mefentrifluconazole.

55. The method of claim 54, wherein the azole fungicide is epoxiconazole, cyproconazole, difenoconazole, or prothioconazole.

56. The method of claim 54, wherein the azole fungicide is prothioconazole.

57. A diluted composition comprises azole fungicide, thiourea and water.

58. A process for producing the composition of claim 18, the process comprising the following steps: (a) preparing an aqueous composition of the azole fungicide and (b) adding the additive (I) to the aqueous composition to obtain the composition of azole fungicide and additive (I).

59. The process of claim 58, wherein additive (I) is a thiourea-based compound.

60. The process of claim 59, wherein additive (I) is thiourea.
